(19) United States
(12) Patent Application Publication
(10) Pub. No.: US 2025/0347843 A1
(43) Pub. Date: Nov. 13, 2025

(54) WAVEGUIDE, GLASS COMPOSITIONS, AND METHODS OF MAKING THE SAME

(71) Applicant: CORNING INCORPORATED, CORNING, NY (US)

(72) Inventors: Douglas Clippinger Allan, Corning, NY (US); Matthew John Dejneka, Corning, NY (US); Joseph Paul Elliott, Beaverdams, NY (US); William John Furnas, Elmira, NY (US); David John McEnroe, Wellsville, NY (US); Michael Lesley Sorensen, Waverly, NY (US); Charisse Marye Spier, Horseheads, NY (US); Jonathan Earl Walter, Woodhull, NY (US)

(21) Appl. No.: 19/198,808

(22) Filed: May 5, 2025

Related U.S. Application Data
(60) Provisional application No. 63/646,210, filed on May 13, 2024.

(51) Int. Cl. G02B 6/02; C03C 3/097; C03C 25/105

(52) U.S. Cl. CPC G02B 6/02038; C03C 3/097; C03C 25/105

(57) ABSTRACT

Waveguide have a cladding material attached to and circumferentially surrounding a core material. The cladding material can be a polymer-containing material or a glass-based material that is fused to the core material. Both the cladding material and core material can be chemically strengthened to have a central tension of at least 30 MPa. An absolute value of a difference in refractive index between the cladding material and the core material is from 0.10 to 0.30. The cladding material can be a boroaluminosilicate composition having from 0.03 mol % to 5.0 mol % Fe₂O₃. The core material can have from 59 mol % to 80 mol % SiO₂ and from 1.5 mol % to 30 mol % Ta₂O₅. In aspects, the core material can have at least 0.1 mol % Li₂O and at least 0.2 mol % Na₂O. Methods include redrawing and thermally conditioning an assembly comprising a core material inserted in a preform to form a fused waveguide.

### CROSS-REFERENCE TO RELATED APPLICATIONS

This application claims the benefit of priority of U.S. Provisional Application Ser. No. 63/646,210, filed on May 13, 2024, the content of which is relied upon and incorporated herein by reference in its entirety.

### BACKGROUND

### Field

The present specification generally relates to waveguides, glass compositions, and methods of making the same. More specifically, the present specification is directed to waveguides having a high refractive index core, glass compositions including iron oxide or tantalum oxide, and methods of making the same by redrawing.

### Technical Background

It is known to form optical fibers using glass. Also, it is known to use glasses in consumer electronic devices, where scratch resistance and/or damage resistance is desired. The fracture resistance and scratch resistance of ion-exchangeable glasses can be improved through chemical strengthening. Optical sensors have been used in optical fiber applications as well as in consumer electronic devices. Optical sensors need to be able to collect light and reliably detect signals from the light. Accordingly, there is a need to provide scratch resistant materials that can be used in a waveguide to collect and transmit light for optical sensors. Also, there is a need more generally for glass with improved optical properties that can be used in consumer electronic devices and/or optical sensors.

### SUMMARY

There are set forth herein glass compositions that can be used in a waveguide (e.g., as part of an optical sensor). As discussed herein, the compositions are referred to as “core composition” and “cladding composition” for clarity without restricting the compositions to a particular function or application. The core composition can comprise one or more of: from greater than or equal to 1.5 mol % to less than or equal to 30 mol % Ta₂O₅ (e.g., in combination with from greater than or equal to 59 mol % to less than or equal to 80 mol % SiO₂, and/or non-zero amounts of Li₂O and/or Na₂O); a refractive index greater than or equal to 1.60; and/or a density greater than or equal to 3.0 g/cm³. The inventors of the present disclosure have unexpectedly found that Ta₂O₅ can be substituted for Al₂O₃ (e.g., relative to conventional ion-exchangeable glass-based compositions) while providing an increased refractive index (e.g., relative to using Al₂O₃). Unlike components typically used to increase refractive index (e.g., TiO₂, Nb₂O₅, ZrO₂), Ta₂O₅ can be included in relatively high amounts (e.g., greater than or equal to 1.5 mol %, greater than or equal to 7.0 mol %, or greater than or equal to 11.0 mol %) without destabilizing the glass-based composition (e.g., becoming prone to devitrification or phase separation). Further, compared to Al₂O₃, Ta₂O₅ can stabilize other high refractive index components. Ta₂O₅ can also enhance ion exchange. Also, Ta₂O₅ can increase a fracture toughness of the core composition. Providing a high transmittance (e.g., from 70% to 96%, from 80% to 96%, from 82% to 87%) core material (e.g., material having the core composition) can enable the transmission of signals therethrough, for example, when used a core of a waveguide. The cladding composition can comprise one or more of: from greater than or equal to 0.03 mol % to less than or equal to 5.0 mol % Fe₂O₃ (e.g., in combination with from greater than or equal to 4.5 mol % to less than or equal to 10 mol % Li₂O, and/or non-zero amounts of Li₂O and Na₂O); a refractive index less than or equal to 1.60; and/or a transmittance averaged over optical wavelength from 400 nm to 700 nm of less than or equal to 5%. Providing a low transmittance (e.g., 5% or less, less than 0.5%, less than 0.2%, less than 0.1%) of a cladding material (e.g., material formed from the cladding composition) can inhibit the transmission of signals therethrough, which can function to prevent cross-talk between signals in adjacent sections of core material separated by the cladding material (e.g., in a waveguide).

Waveguides in accordance with the present disclosure have a cladding material surrounding and attached to a core material, where the core material can be ion-exchangeable (e.g., chemically strengthened to have a central tension greater than or equal to 30 MPa, from greater than or equal to 50 MPa to less than or equal to 300 MPa, from greater than or equal to 70 MPa to less than or equal to 230 MPa, or from greater than or equal to 130 MPa to less than or equal to 180 MPa. The waveguide can have a high numerical aperture (e.g., greater than or equal to 0.5, from greater than or equal to 0.50 to less than or equal to 0.9, from greater than or equal to 0.60 to less than or equal to 0.85, or from greater than or equal to 0.65 to less than or equal to 0.80) with the core material having a higher refractive index than the cladding material and can enable the waveguide to receive (e.g., couple into an end) and transmit light due to the high acceptance angle, which can allow an end (e.g., major surface) of the waveguide to act as a lens refracting light to travel at a lower angle (e.g., relative to a longitudinal axis of the core)—thereby enabling the waveguide to collect more light and therefore more signal. Providing a sufficient distance (e.g., from 0.1 mm to 20 mm, from 0.2 mm to 15 mm, from 0.5 mm to 8 mm) between adjacent sections of the core material, cross-talk between signals traveling through the corresponding sections can be minimized, especially when the cladding material has low average transmittance (e.g., 5.0% or less, 0.5% or less). Additionally or alternatively, providing sufficient distance (e.g., from 0.1 mm to 20 mm, from 0.2 mm to 15 mm or more, from 1.0 mm to 8 mm) between adjacent sections of the core material can enable the different core sections to convey significantly different information that may be collected through an end (e.g., major surface of the waveguide). In aspects, the cladding material can comprise a polymer-containing material that can in further aspects be antimicrobial and/or contain copper-containing glass-based material. Alternatively, in aspects, the cladding material can be a glass-based material that is ion-exchangeable (e.g., chemically strengthened to have a central tension greater than or equal to 30 MPa to less than or equal to 300 MPa, from greater than or equal to 50 MPa to less than or equal to 230 MPa, or from greater than or equal to 70 MPa to less than or equal to 180 MPa. In further aspects, both the core material and the cladding material can be chemically strengthened with respective central tensions greater than or equal to 30 MPa, from greater than or equal to 50 MPa to less than or equal to 300 MPa, from greater than or equal to 60 MPa to less than or equal to 230 MPa, or from greater than or equal to 70 MPa to less than or equal to 180 MPa. Providing a chemically strengthened cladding material can increase a scratch-resistance and/or other damage resistance of the waveguide.

Additionally, as discussed herein, the core composition and the cladding composition can have compatible viscosity profiles that allow both compositions to be redrawn together in a single assembly to form a consolidated assembly and/or a waveguide, where the cladding composition can circumferentially surround and be fused to the core composition, which can be formed as a rod. Unexpectedly, inventors of the present disclosure discovered that a close viscosity match (e.g., within a factor from 0.01 to 100 or from 0.1 to 10) in a range from 10⁵ Pascal-seconds to 10⁷ Pascal-seconds (e.g., when the clad composition has a viscosity of 10⁶ Pascal-seconds) is sufficient for the compositions to be redrawn and subsequently cooled together (regardless of a ratio between the viscosities at other points). Thermally conditioning the consolidated assembly can minimize a difference in thermally-induced stress in the consolidated assembly between the core material and the cladding material. Providing a low difference between coefficients of thermal expansion between the core material and the cladding material (e.g., an absolute value of the difference from 0×10⁻⁷° C.⁻¹ to 5×10⁻⁷° C.⁻¹, from 0×10⁻⁷° C.⁻¹ to 3×10⁻⁷° C.⁻¹, or from 1×10⁻⁷° C.⁻¹ to 2×10⁻⁷° C.⁻¹) can minimize an amount of thermal-induced stress in the waveguide, which can enable the waveguide to be reliably formed by redrawing, especially when the cladding material is a glass-based material and the maximum cross-sectional dimension of the waveguide is large (e.g., greater than or equal to 10.0 mm).

Aspect 1. A waveguide comprising:
a core material comprising a glass-based material and a core refractive index; and
a cladding material comprising a glass-based material having a clad refractive index, the cladding material fused to and circumferentially surrounding the core material,
wherein the core refractive index is greater than the clad refractive index by from greater than or equal to 0.10 to less than or equal to 0.30, the core material is chemically strengthened and has a core compressive stress and a core central tension, the cladding material is chemically strengthened and has a clad compressive stress and a clad central tension, and the core central tension and the clad central tension are both from greater than or equal to 30 MPa to less than or equal to 300 MPa.

Aspect 2. The waveguide of aspect 1, wherein a transmittance of the cladding material averaged over optical wavelength from 400 nm to 700 nm is less than or equal to 5.0% for a thickness of 0.7 mm.

Aspect 3. A waveguide comprising:
a core material comprising a glass-based material and a core refractive index; and
a cladding material comprising a clad refractive index, the cladding material is a polymer-containing material or a glass-based material, the cladding material attached to and circumferentially surrounding the core material, a transmittance of the cladding material averaged over optical wavelength from 400 nm to 700 nm is less than or equal to 5.0% for a thickness of 0.7 mm,
wherein the core refractive index is greater than the clad refractive index by from greater than or equal to 0.10 to less than or equal to 0.30, and the core material is ion-exchangeable.

Aspect 4. The waveguide of aspect 3, wherein the core material is chemically strengthened and has a core compressive stress and a core central tension from greater than or equal to 30 MPa to less than or equal to 300 MPa.

Aspect 5. The waveguide of any one of claims 3-4, wherein the cladding material comprises a polymer-containing material including an epoxy or an acrylic.

Aspect 6. The waveguide of any one of aspects 3-4, wherein the cladding material comprises a glass-based material, and the cladding material is fused to the core material.

Aspect 7. The waveguide of aspect 6, wherein the clad material is chemically strengthened and has a clad compressive stress and a clad central tension, and the core central tension and the clad central tension are both from greater than or equal to 30 MPa to less than or equal to 300 MPa.

Aspect 8. The waveguide of any one of aspects 3-7, wherein the transmittance is less than or equal to 0.5%.

Aspect 9. The waveguide of any one of aspects 1-8, wherein the core refractive index is from greater than or equal to 1.60 and less than or equal to 1.80, and the clad refractive index is from greater than or equal to 1.45 to less than or equal to 1.55.

Aspect 10. The waveguide of any one of aspects 1-9, wherein the waveguide exhibits a numerical aperture from greater than or equal to 0.55 to less than or equal to 0.90.

Aspect 11. The waveguide of any one of aspects 1-10, wherein the core material and the cladding material are both free of arsenic, antimony, cadmium, mercury, selenium, and lead.

Aspect 12. The waveguide of any one of aspects 1-11, wherein the core material has a core coefficient of thermal expansion, the cladding has a clad coefficient of thermal expansion, and an absolute value of a difference between the core coefficient of thermal expansion and the clad coefficient of thermal expansion is from greater than or equal to 0.0×10⁻⁷° C.⁻¹ to less than or equal to 5×10⁻⁷° C.⁻¹.

Aspect 13. The waveguide of aspect 12, wherein the clad coefficient of thermal expansion is
from greater than or equal to 50×10⁻⁷° C.⁻¹ to less than or equal to 85×10⁻⁷° C.⁻¹.

Aspect 14. The waveguide of any one of aspects 1-13, wherein the core material is formed as a rod, and a maximum cross-sectional dimension of the rod of the core material is from greater than or equal to 1.0 mm to less than or equal to 20 mm.

Aspect 15. The waveguide of any one of aspects 1-13, wherein the core material is formed a plurality of rods separated from one another by the cladding material.

Aspect 16. The waveguide of aspect 15, wherein a minimum distance between an adjacent pair of rods of the plurality of rods is from greater than or equal to 1.0 mm to less than or equal to 20 mm.

Aspect 17. The waveguide of any one of aspects 1-16, wherein a maximum cross-sectional dimension of the waveguide is from greater than or equal to 10.0 mm to less than or equal to 100.0 mm.

Aspect 18. The waveguide of any one of aspects 1-17, wherein the core material has a core density at 20° C., the cladding material has a clad density at 20° C., and the core density is greater than the clad density by from greater than or equal to 0.5 g/cm³ to less than or equal to 2.25 g/cm³.

Aspect 19. The waveguide of any one of aspects 1-18, wherein at the clad material has a viscosity of 10⁵ Pascal-seconds at a predetermined temperature, and a viscosity of the core material at the predetermined temperature is from 10³ Pascal-seconds to 10⁷ Pascal-seconds.

Aspect 20. The waveguide of any one of aspects 1-19, wherein the cladding material exhibits CIE color coordinates of:
a* from greater than or equal to −0.2 to less than or equal to 0.2; and
b* from greater than or equal to −0.3 to less than or equal to 0.1.

Aspect 21. The waveguide of any one of aspects 1-20, wherein the cladding material is a boroaluminosilicate composition comprising from greater than or equal to 0.03 mol % to less than or equal to 5.0 mol % Fe₂O₃ based on 100 mol % of the boroaluminosilicate composition.

Aspect 22. A waveguide of any one of aspects 1-21, wherein the cladding material, based on 100 mol % of the cladding material, comprises:
from greater than or equal to 55 mol % to less than or equal to 80 mol % SiO₂;
from greater than or equal to 8.75 mol % to less than or equal to 18.0 mol % Al₂O₃;
from greater than or equal to 4.5 mol % to less than or equal to 10.0 mol % Li₂O;
from greater than or equal to 2.0 mol % to less than or equal to 14.0 mol % Na₂O; and
from greater than or equal to 0.5 mol % to less than or equal to 15.0 mol % B₂O₃.

Aspect 23. The waveguide of aspect 22, wherein the cladding material further comprises:
from greater than or equal to 58.0 mol % to less than or equal to 69.5 mol % SiO₂;
from greater than or equal to 10.5 mol % to less than or equal to 17.5 mol % Al₂O₃;
from greater than or equal to 5.5 mol % to less than or equal to 8.5 mol % Li₂O;
from greater than or equal to 4.0 mol % to less than or equal to 9.5 mol % Na₂O;
from greater than or equal to 2.5 mol % to less than or equal to 9.5 mol % B₂O₃.

Aspect 24. The waveguide of any one of aspects 22-23, wherein the cladding material further comprises:
from greater than or equal to 59.0 mol % to less than or equal to 65.0 mol % SiO₂;
from greater than or equal to 11.5 mol % to less than or equal to 15.5 mol % Al₂O₃;
from greater than or equal to 6.0 mol % to less than or equal to 9.0 mol % Na₂O; and
from greater than or equal to 5.5 mol % to less than or equal to 8.5 mol % B₂O.

Aspect 25. The waveguide of any one of aspects 22-24, wherein the cladding material comprises from greater than or equal 11.0 mol % to less than or equal to 17.0 mol % R₂O, where R₂O is a total amount of Li₂O, Na₂O, K₂O, Cs₂O, and Rb₂O.

Aspect 26. The waveguide of any one of aspects 22-25, wherein the cladding material comprises from greater than or equal to 0.0 mol % to less than or equal to 4.0 mol % RO, where RO is a total amount of MgO, CaO, SrO, and BaO.

Aspect 27. The waveguide of any one of aspects 22-25, wherein the cladding material comprises from greater than or equal to 0.03 to less than or equal to 3.0 mol % Fe₂O₃.

Aspect 28. The waveguide of any one of aspects 1-27, wherein the core material is a silicate glass comprising, based on 100 mol % of the core material:
from greater than or equal to 59 mol % to less than or equal to 80 mol % SiO₂; and
from greater than or equal to 1.5 mol % to less than or equal to 30 mol % Ta₂O₅.

Aspect 29. The waveguide of any one of aspects 1-28, wherein the core material comprises:
from greater than or equal to 59 mol % to less than or equal to 80 mol % SiO₂;
from greater than or equal to 1.5 mol % to less than or equal to 30 mol % Ta₂O₅;
from greater than or equal to 0.1 mol % to less than or equal to 30 mol % Li₂O;
from greater than or equal to 0.2 mol % to less than or equal to 30 mol % Na₂O;
from greater than or equal to 0 mol % to less than or equal to 3.75 mol % MgO;
from greater than or equal to 0.0 mol % to less than or equal to 0.13 mol % Ag₂O;
from greater than or equal to 0 mol % to less than or equal to 4.5 mol % ZrO₂; and
from greater than or equal to 0 mol % to less than or equal to 10 mol % Nb₂O₅.

Aspect 30. The waveguide of any one of aspects 28-29, wherein the core material further comprises:
from greater than or equal to 0 mol % to less than or equal to 6.0 mol % B₂O₃; and
from greater than or equal 0.3 mol % to less than or equal to 24 mol % R₂O, where R₂O is a total amount of Li₂O, Na₂O, K₂O, Cs₂O, and Rb₂O.

Aspect 31. The waveguide of any one of aspects 28-30, wherein the core material comprises from greater than or equal 15.0 mol % to less than or equal to 23.5 mol % R₂O.

Aspect 32. The waveguide of any one of aspects 28-31, wherein the core material further comprises:
from greater than or equal to 7.0 mol % to less than or equal to 18.0 mol % Ta₂O₅; and
from greater than or equal to 0.0 mol % to less than or equal to 0.09 mol % CuO.

Aspect 33. The waveguide of any one of aspects 28-32, wherein the core material comprises from greater than or equal to 0.0 mol % to less than or equal to 8.0 mol % Al₂O₃, and the glass composition is free of TiO₂.

Aspect 34. The waveguide of any one of aspects 28-33, wherein the core material comprises from greater than or equal to 0.0 mol % to less than or equal to 0.3 mol % RO, where RO is a total amount of MgO, CaO, SrO, and BaO.

Aspect 35. The waveguide of any one of aspects 28-34, wherein the core material further comprising:
from greater than or equal to 59.0 mol % to less than or equal to 74.0 mol % SiO₂;
from greater than or equal to 7.0 mol % to less than or equal to 19.0 mol % Ta₂O₅;
from greater than or equal to 0.1 mol % to less than or equal to 21 mol % Li₂O;
from greater than or equal to 0.2 mol % to less than or equal to 21 mol % Na₂O;
from greater than or equal to 0 mol % to less than or equal to 0.5 mol % MgO; and
from greater than or equal to 0.0 mol % to less than or equal to 0.08 mol % Ag₂O.

Aspect 36. The waveguide of any one of aspects 28-35, wherein the core material further comprises:
from greater than or equal to 59.5 mol % to less than or equal to 64 mol % SiO₂;
from greater than or equal to 11.0 mol % to less than or equal to 18.0 mol % Ta₂O₅;
from greater than or equal to 5.5 mol % to less than or equal to 19.0 mol % Li₂O;
from greater than or equal to 3.0 mol % to less than or equal to 13.0 mol % Na₂O;
from greater than or equal to 0.0 mol % to less than or equal to 4.0 mol % Al₂O₃;
from greater than or equal to 0.0 mol % to less than or equal to 4.0 mol % B₂O₃;
from greater than or equal to 0 mol % to less than or equal to 4.0 mol % ZrO₂; and
from greater than or equal to 0 mol % to less than or equal to 6.0 mol % Nb₂O₅.

Aspect 37. An optical sensor comprising:
the waveguide of any one of aspects 1-36; and
a detector in optical communication with the core material of the waveguide,
wherein the core material of the waveguide is configured to couple light from one end of the waveguide to the detector at the other end of the waveguide.

Aspect 38. An glass composition comprising, based on 100 mol % of the glass composition:
from greater than or equal to 59 mol % to less than or equal to 80 mol % SiO₂;
from greater than or equal to 1.5 mol % to less than or equal to 30 mol % Ta₂O₅;
from greater than or equal to 0.1 mol % to less than or equal to 30 mol % Li₂O;
from greater than or equal to 0.2 mol % to less than or equal to 30 mol % Na₂O;
from greater than or equal to 0 mol % to less than or equal to 3.75 mol % MgO;
from greater than or equal to 0.0 mol % to less than or equal to 0.13 mol % Ag₂O;
from greater than or equal to 0 mol % to less than or equal to 4.5 mol % ZrO₂; and
from greater than or equal to 0 mol % to less than or equal to 10 mol % Nb₂O₅.

Aspect 39. The glass composition aspect 38, further comprising:
from greater than or equal to 0 mol % to less than or equal to 6.0 mol % B₂O₃; and
from greater than or equal 0.3 mol % to less than or equal to 24 mol % R₂O, where R₂O is a total amount of Li₂O, Na₂O, K₂O, Cs₂O, and Rb₂O.

Aspect 40. The glass composition of aspect 39, wherein the glass composition comprises from greater than or equal 15.0 mol % to less than or equal to 23.5 mol % R₂O.

Aspect 41. The glass composition of any one of aspects 38-40, further comprising: from greater than or equal to 7.0 mol % to less than or equal to 18.0 mol % Ta₂O₅; and
from greater than or equal to 0.0 mol % to less than or equal to 0.09 mol % CuO.

Aspect 42. The glass composition of any one of aspects 38-41, wherein the glass composition comprises from greater than or equal to 0.0 mol % to less than or equal to 8.0 mol % Al₂O₃, and the glass composition is free of TiO₂.

Aspect 43. The glass composition of any one of aspects 38-42, wherein the glass composition comprises from greater than or equal to 0.0 mol % to less than or equal to 4.5 mol % K₂O, and the glass composition is free of arsenic, antimony, cadmium, mercury, selenium, and lead.

Aspect 44. The glass composition of any one of aspects 38-43, wherein the glass composition comprises from greater than or equal to 0.0 mol % to less than or equal to 0.3 mol % RO, where RO is a total amount of MgO, CaO, SrO, and BaO.

Aspect 45. The glass composition of any one of aspects 38-44, wherein the glass composition comprises a refractive index from greater than or equal to 1.60 to less than or equal to 1.80.

Aspect 46. The glass composition of aspect 45, wherein the refractive index is from greater than or equal to 1.65 to less than or equal to 1.75.

Aspect 47. The glass composition of any one of aspects 38-46, wherein the glass composition comprises a coefficient of thermal expansion from greater than or equal to 50×10⁻⁷° C.⁻¹ to less than or equal to 85×10⁻⁷° C.⁻¹.

Aspect 48. The glass composition of any one of aspects 38-47, wherein the glass composition comprises a density at 20° C. is from greater than or equal to 3.0 g/cm³ to less than or equal to 4.25 g/cm³.

Aspect 49. The glass composition of any one of aspects 38-48, further comprising:
from greater than or equal to 59.0 mol % to less than or equal to 74.0 mol % SiO₂;
from greater than or equal to 7.0 mol % to less than or equal to 19.0 mol % Ta₂O₅;
from greater than or equal to 0.1 mol % to less than or equal to 21 mol % Li₂O;
from greater than or equal to 0.2 mol % to less than or equal to 21 mol % Na₂O;
from greater than or equal to 0 mol % to less than or equal to 0.5 mol % MgO; and
from greater than or equal to 0.0 mol % to less than or equal to 0.08 mol % Ag₂O.

Aspect 50. The glass composition of any one of aspects 38-49, further comprising: from greater than or equal to 59.5 mol % to less than or equal to 64 mol % SiO₂;
from greater than or equal to 11.0 mol % to less than or equal to 18.0 mol % Ta₂O₅;
from greater than or equal to 5.5 mol % to less than or equal to 19.0 mol % Li₂O;
from greater than or equal to 3.0 mol % to less than or equal to 13.0 mol % Na₂O;
from greater than or equal to 0.0 mol % to less than or equal to 4.0 mol % Al₂O₃;
from greater than or equal to 0.0 mol % to less than or equal to 4.0 mol % B₂O₃;
from greater than or equal to 0 mol % to less than or equal to 4.0 mol % ZrO₂; and
from greater than or equal to 0 mol % to less than or equal to 6.0 mol % Nb₂O₅.

Aspect 51. A glass-based article comprising:
the glass composition of any one of aspects 38-50;
a compressive stress region extending from a first major surface of the glass-based article to a depth of compression; and
a central tension of a tensile region from greater than or equal to 50 MPa to less than or equal to 300 MPa.

Aspect 52. The glass-based article of aspect 51, wherein the central tension is from greater than or equal to 70 MPa to less than or equal to 230 MPa.

Aspect 53. A glass composition comprising:
from greater than or equal to 55 mol % to less than or equal to 80 mol % SiO₂;
from greater than or equal to 8.75 mol % to less than or equal to 18.0 mol % Al₂O₃;
from greater than or equal to 4.5 mol % to less than or equal to 10.0 mol % Li₂O;
from greater than or equal to 2.0 mol % to less than or equal to 14.0 mol % Na₂O;
from greater than or equal to 0.5 mol % to less than or equal to 15.0 mol % B₂O₃; and
from greater than or equal to 0.03 to less than or equal to 5.0 mol % Fe₂O₃.

Aspect 54. The glass composition of aspect 53, further comprising:
from greater than or equal to 58.0 mol % to less than or equal to 69.5 mol % SiO₂;
from greater than or equal to 10.5 mol % to less than or equal to 17.5 mol % Al₂O₃;
from greater than or equal to 5.5 mol % to less than or equal to 8.5 mol % Li₂O;
from greater than or equal to 4.0 mol % to less than or equal to 9.5 mol % Na₂O;
from greater than or equal to 2.5 mol % to less than or equal to 9.5 mol % B₂O₃; and
from greater than or equal to 0.03 to less than or equal to 3.0 mol % Fe₂O₃.

Aspect 55. The glass composition of any one of aspects 53-54, further comprising:
from greater than or equal to 59.0 mol % to less than or equal to 65.0 mol % SiO₂;
from greater than or equal to 11.5 mol % to less than or equal to 15.5 mol % Al₂O₃;
from greater than or equal to 6.0 mol % to less than or equal to 9.0 mol % Na₂O; and
from greater than or equal to 5.5 mol % to less than or equal to 8.5 mol % B₂O.

Aspect 56. The glass composition of any one of aspects 53-55, wherein the glass composition comprises from greater than or equal 11.0 mol % to less than or equal to 17.0 mol % R₂O, where R₂O is a total amount of Li₂O, Na₂O, K₂O, Cs₂O, and Rb₂O.

Aspect 57. The glass composition of any one of aspects 53-56, wherein the glass composition comprises from greater than or equal to 0.0 mol % to less than or equal to 4.0 mol % RO, where RO is a total amount of MgO, CaO, SrO, and BaO.

Aspect 58. The glass composition of any one of aspects 53-57, wherein the glass composition comprises from greater than or equal to 0.0 mol % to less than or equal to 4.5 mol % K₂O, and the glass composition is free of arsenic, antimony, cadmium, mercury, selenium, and lead.

Aspect 59. The glass composition of any one of aspects 53-58, wherein the glass composition comprises a coefficient of thermal expansion from greater than or equal to 50×10⁻⁷° C.⁻¹ to less than or equal to 85×10⁻⁷° C.⁻¹.

Aspect 60. The glass composition of any one of aspects 53-59, wherein the glass composition comprises a density at 20° C. is from greater than or equal to 2.0 g/cm³ to less than or equal to 3.0 g/cm³.

Aspect 61. The glass composition of any one of aspects 53-60, wherein the glass composition exhibits CIE color coordinates of:
a* from greater than or equal to −0.2 to less than or equal to 0.2; and
b* from greater than or equal to −0.3 to less than or equal to 0.1.

Aspect 62. The glass composition of any one of aspects 53-61, wherein the glass composition comprises a refractive index from greater than or equal to 1.45 to less than or equal to 1.55.

Aspect 63. A glass-based article comprising:
the glass composition of any one of aspects 53-62; and
a compressive stress region extending from a first major surface of the glass-based article to a depth of compression;
a central tension of a tensile region from greater than or equal to 30 MPa to less than or equal to 300 MPa.

Aspect 64. The glass-based article of aspect 63, wherein the central tension is from greater than or equal to 70 MPa to less than or equal to 230 MPa.

Aspect 65. The glass article of any one of aspects 63-64, wherein a transmittance averaged over optical wavelength from 400 nm to 700 nm is less than or equal to 5.0% for a thickness of 0.7 mm.

Aspect 66. The glass article of aspect 65, wherein the transmittance is less than or equal to 0.5%.

Aspect 67. A method of making a fused waveguide comprising:
inserting a rod comprising a core material in a hole in a preform comprising a cladding material to form an assembly;
redrawing the assembly to reduce a diameter of the assembly at a first temperature; and thermally conditioning the redrawn assembly to form the fused waveguide.

Aspect 68. The method of aspect 67, wherein the redrawing the assembly comprises heating the assembly to the first temperature where a clad viscosity of the cladding material and a core viscosity of core material is from 10⁴ Pascal-seconds to 10¹ Pascal-seconds.

Aspect 69. The method of aspect 68, wherein the thermally conditioning increases the clad viscosity of the cladding material and the core viscosity of the core material to from 10¹¹ Pascal-seconds to 10¹⁴ Pascal-seconds.

Aspect 70. The method of any one of aspects 67-69, wherein at the clad material has a viscosity of 10⁵ Pascal-seconds at a predetermined temperature, and a viscosity of the core material at the predetermined temperature is from 10³ Pascal-seconds to 10⁷ Pascal-seconds.

Aspect 71. The method of any one of aspects 67-70, further comprising chemically strengthening the fused waveguide after the thermally conditioning, wherein the chemically strengthening forms a clad compressive stress and a clad central tension in the cladding material and a core compressive stress and a core central tension in the core material.

Aspect 72. The method of aspect 71, wherein the core central tension and the clad central tension are both from greater than or equal to 30 MPa to less than or equal to 300 MPa.

Aspect 73. The method of any one of aspects 67-70, wherein the inserting the rod comprises inserting a plurality of rods in a corresponding plurality of holes in the perform.

Aspect 74. The method of any one of aspects 67-71, wherein the fused waveguide is free of air gaps.

Aspect 75. The method of any one of aspects 67-74, wherein the fused waveguide is the fused waveguide of any one of aspects 1-37.

Aspect 76. The method of any one of aspects 67-75, wherein the core material comprises the glass composition of any one of aspects 38-50.

Aspect 77. The method of any one of aspects 67-76, wherein the cladding material comprises the glass composition of any one of aspects 53-62.

Aspect 78. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover substrate disposed over the display,
wherein at least a portion of the housing comprises the waveguide of any one of aspects 1-37.

Additional features and advantages will be set forth in the detailed description which follows, and in part will be readily apparent to those skilled in the art from that description or recognized by practicing the aspects and/or embodiments described herein, including the detailed description which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects and are incorporated into and constitute a part of this specification. The drawings illustrate the various aspects described herein, and together with the description serve to explain the principles and operations of the claimed subject matter.

### BRIEF DESCRIPTION OF THE DRAWINGS

FIG. 1 schematically depicts an end view of a fused waveguide with a plurality of cores having a core material fused to and surrounded by a cladding material in accordance with aspects of the present disclosure;

FIG. 2 is a perspective view of a rod of a core material comprising a core composition in accordance with aspects of the present disclosure;

FIG. 3 is a schematic view of an optical sensor including a processor detecting signals transmitted through a waveguide (e.g., fused waveguide, polymer-glass waveguide) in accordance with aspects of the present disclosure;

FIG. 4 schematically shows viscosity curves (the logarithm of viscosity in poise on the vertical axis (y-axis) as a function of temperature in ° C. on the horizontal axis (x-axis)) for exemplary pairs of glass compositions;

FIG. 5 schematically shows CIE color coordinates (CIE a* values on the horizontal axis (x-axis) and CIE b* values on the vertical axis (y-axis)) for example cladding composition;

FIG. 6 schematically shows transmittance in % on the vertical axis (y-axis) as a function of optical wavelength in nanometer (nm) on the horizontal axis (x-axis) for an example cladding composition;

FIG. 7 schematically shows stress profiles (stress in MegaPascals (MPa) on the vertical axis (y-axis) versus position along a thickness (e.g., diameter) in millimeters (mm) of the sample on the horizontal axis (x-axis)) for samples of example core compositions;

FIG. 8 schematically illustrates example steps in methods of making a fused waveguide in accordance with aspects of the present disclosure;

FIG. 9 schematically illustrates a step of chemically strengthening the fused waveguide in accordance with aspects of the present disclosure;

FIG. 10 shows a flow chart illustrating example methods of making a waveguide (e.g., fused waveguide) in accordance with aspects of the present disclosure; and

FIG. 11 schematically depicts an end view of a waveguide with a plurality of cores having a cladding material surrounding and attached to a core material, where the cladding material is a polymer-containing material in accordance with aspects of the present disclosure.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate, as discussed below. However, other strengthening methods, for example, thermal tempering, or utilizing a mismatch of the coefficient of thermal expansion between portions of the substrate to create compressive stress and central tension regions, may be utilized to form strengthened substrates.

Throughout the disclosure, “glass-based material” generally refers to a material made from a glass-based composition that may or may not be chemically strengthened (e.g., ion-exchanged). As used herein, a “glass-based substrate” refers to a glass-based piece that has not been ion exchanged. Similarly, a “glass-based article” refers to a glass-based piece that has been ion exchanged and is formed by subjecting a glass-based substrate to an ion-exchange process. A “glass-based substrate” and a “glass-based article” are defined accordingly and include glass-based substrates and glass-based articles as well as substrates and articles that are made wholly or partly of a glass-based material, such as glass-based substrates that include a surface coating. While glass-based substrates and glass-based articles may generally be referred to herein for the sake of convenience, the descriptions of glass-based substrates and glass-based articles should be understood to apply equally to glass-based substrates and glass-based articles. Likewise, the claims are not necessarily limited to either an ion-exchanged glass-based article or a glass-based substrate that has not been ion exchanged unless otherwise indicated.

In aspects of glass-based compositions described herein, the concentration of constituent components (e.g., SiO₂, Al₂O₃, Ta₂O₅, Li₂O, and the like) are given in mole percent (mol %) on an oxide basis, unless otherwise specified. Components of the alkali aluminosilicate glass-based composition according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits. Throughout the disclosure, the composition of glass-based articles and/or glass-based substrates refers to the composition of the formed article or substrate as determined in wt % by: X-ray fluorescence and comparison with standard samples for alumina, phosphorous, alkaline earth metals, transition metals (e.g., ZnO, TiO₂, Fe₂O₃, SnO₂), sodium oxide, potassium oxide, and tantalum oxide (Ta₂O₅); an amount of B₂O₃ is measured using inductively coupled plasma (ICP) methods; an amount of lithium oxide (Li₂O) is measured using flame emission spectroscopy; and an amount of SiO₂ is taken as the balance of material (i.e., 100%—materials measured using X-ray fluorescence, ICP, and flame emission spectroscopy), and then the composition is converted from wt % to mol %, as reported herein. The composition refers to the composition of the formed article or substrate—not the raw materials added to form the glass-based article and/or glass-based substrate.

### Core Glass Composition

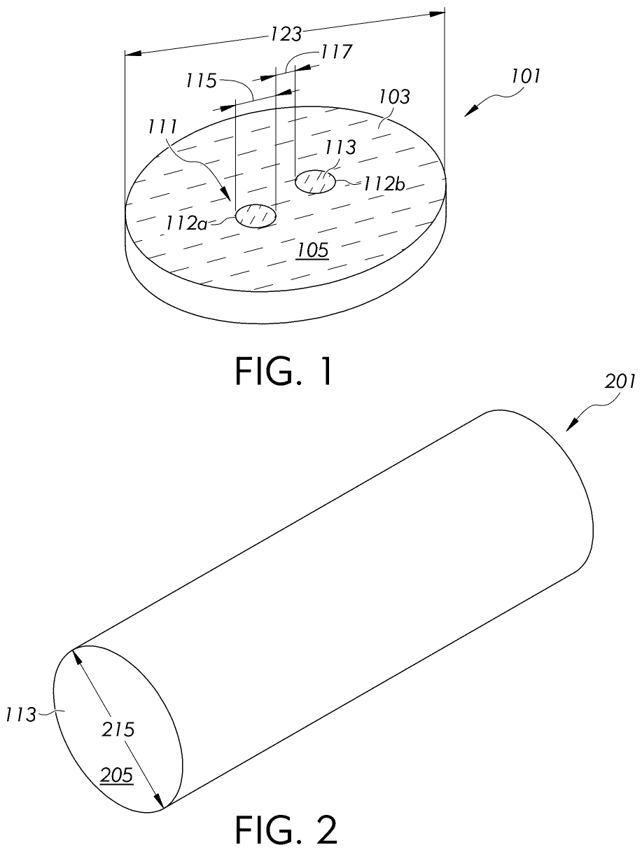

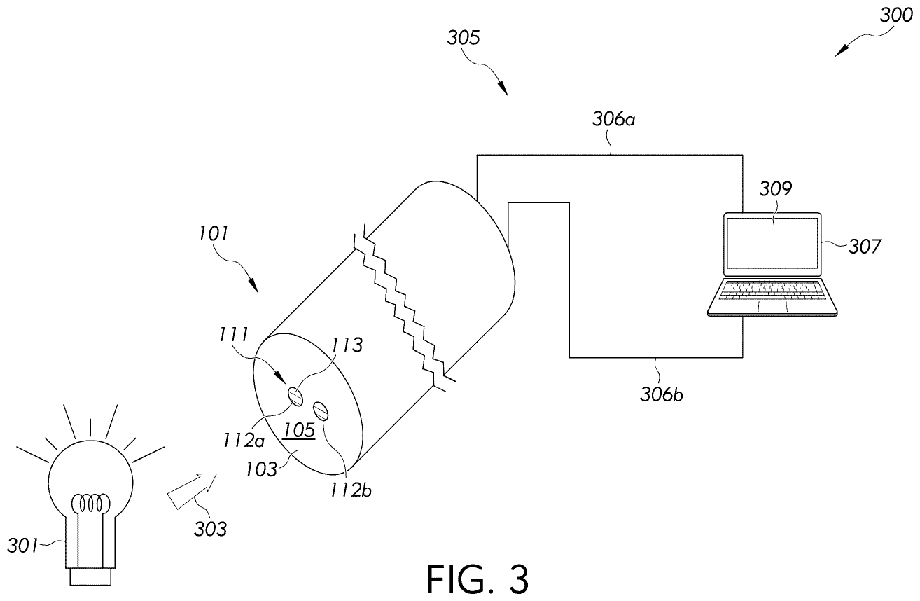

Embodiments of the present disclosure include a glass-based material that can have one or more of: from greater than or equal to 1.5 mol % to less than or equal to 30 mol % Ta₂O₅ (e.g., in combination with from greater than or equal to 59 mol % to less than or equal to 80 mol % SiO₂, and/or non-zero amounts of Li₂O and/or Na₂O); a refractive index greater than or equal to 1.60; and/or a density greater than or equal to 3.0 g/cm³ that can be used as a core material in a waveguide in accordance with aspects of the present disclosure (see core material 113 in FIG. 1). Consequently, this glass-based material will be referred to as the “core material” for clarity to distinguish it from other glass-based materials (e.g., cladding material) with the understanding that the “core material” is not limited to such applications (e.g., waveguides, laminate, or other composites). The core material 113 can form a glass-based substrate 201 and/or glass-based article on its own, as shown in FIG. 2.

In the glass-based compositions described herein, SiO₂ is the largest constituent and, as such, SiO₂ is the primary constituent of the glass network formed from the glass-based composition. Pure SiO₂ has a relatively low coefficient of thermal expansion (CTE). However, pure SiO₂ has a high melting point. Accordingly, if the concentration of SiO₂ in the glass-based composition is too high, the formability of the glass-based composition may be diminished as higher concentrations of SiO₂ increase the difficulty of melting the glass, which, in turn, adversely impacts the formability of the composition. If the concentration of SiO₂ in the glass-based composition is too low the chemical durability of the glass-based material may be diminished, and the glass-based material may be susceptible to surface damage during post-forming treatments. In aspects, the core composition comprises SiO₂ in an amount greater than or equal to 59 mol % (e.g., 59.0 mol %), greater than or equal to 59.2 mol %, greater than or equal to 59.5 mol %, greater than or equal to 59.7 mol %, greater than or equal to 60 mol % (e.g., 60.0 mol %), greater than or equal to 60.5 mol %, greater than or equal to 61 mol % (e.g., 61.0 mol %), greater than or equal to 61.5 mol %, greater than or equal to 62 mol % (62.0 mol %), greater than or equal to 62.5 mol %, greater than or equal to 63.0 mol %, less than or equal to 80 mol % (e.g., 80.0 mol %), less than or equal to 74 mol % (e.g., 74.0 mol %), less than or equal to 72.0 mol %, less than or equal to 70.0 mol %, less than or equal to 68.0 mol %, less than or equal to 66.0 mol %, less than or equal to 64 mol % (e.g., 64.0 mol %), less than or equal to 63.5 mol %, less than or equal to 63.0 mol %, less than or equal to 62.5 mol %, less than or equal to 62.0 mol %, less than or equal to 61.5 mol %, less than or equal to 61.0 mol %, or less than or equal to 60.5 mol %. In aspects, the core composition can comprise SiO₂ from greater than or equal to 59.0 mol % to less than or equal to 80.0 mol %, from greater than or equal to 59 mol % to less than or equal to 74.0 mol %, from greater than or equal to 59.0 mol % to less than or equal to 72.0 mol %, from greater than or equal to 59.2 mol % to less than or equal to 70.0 mol %, from greater than or equal to 59.2 mol % to less than or equal to 68.0 mol %, from greater than or equal to 59.5 mol % to less than or equal to 66.0 mol %, from greater than or equal to 59.5 mol % to less than or equal to 65.0 mol %, from greater than or equal to 59.5 mol % to less than or equal to 64.0 mol %, from greater than or equal to 59.7 mol % to less than or equal to 63.5 mol %, from greater than or equal to 60.0 mol % to less than or equal to 63.0 mol %, from greater than or equal to 60.5 mol % to less than or equal to 62.5 mol %, from greater than or equal to 61.0 mol % to less than or equal to 62.0 mol %, from greater than or equal to 61.5 mol % to less than or equal to 62.0 mol %, or any range or subrange therebetween. In preferred aspects, the core composition can comprise SiO₂ in an amount from greater than or equal to 59 mol % to less than or equal to 80.0 mol %, from greater than or equal to 59.0 mol % to less than or equal to 74 mol %, or from greater than or equal to 59.5 mol % to less than or equal to 64 mol %.

The core composition includes Ta₂O₅. The inventors of the present disclosure have unexpectedly found that Ta₂O₅ can be substituted for Al₂O₃ (e.g., from conventional glass-based compositions) while providing an increased refractive index (e.g., relative to using Al₂O₃). Unlike components typically used to increase refractive index (e.g., TiO₂, Nb₂O₅, ZrO₂), Ta₂O₅ can be included in relatively high amounts (e.g., greater than or equal to 1.5 mol %, greater than or equal to 7.0 mol %, or greater than or equal to 11.0 mol %) without destabilizing the glass-based composition (e.g., becoming prone to devitrification or phase separation). Further, compared to Al₂O₃, Ta₂O₅ can stabilize other high refractive index components. Ta₂O₅ may serve as a glass network former, similar to SiO₂. Ta₂O₅ may increase the viscosity of the glass-based composition due to its tetrahedral coordination in a glass melt formed from a glass-based composition, decreasing the formability of the glass-based composition when the amount of Al₂O₃ is too high. However, when the concentration of Ta₂O₅ is balanced against the concentration of SiO₂ and the concentration of alkali oxides in the glass-based composition, Ta₂O₅ can reduce the liquidus temperature of the glass melt, thereby enhancing the liquidus viscosity and improving the compatibility of the glass-based composition with certain forming processes. Also, Ta₂O₅ can increase a fracture toughness of the core composition. In aspects, the core composition comprises Ta₂O₅ in a concentration greater than or equal to 1.5 mol %, greater than or equal to 3.0 mol %, greater than or equal to 5.0 mol %, greater than or equal to 7 mol % (e.g., 7.0 mol %), greater than or equal to 8.0 mol %, greater than or equal to 9.0 mol %, greater than or equal to 10.0 mol %, greater than or equal to 11 mol % (e.g., 11.0 mol %), greater than or equal to 11.5 mol %, greater than or equal to 12.0 mol %, greater than or equal to 12.5 mol %, greater than or equal to 13.0 mol %, greater than or equal to 13.5 mol %, greater than or equal to 14.0 mol %, greater than or equal to 14.5 mol %, greater than or equal to 15.0 mol %, greater than or equal to 16.0 mol %, less than or equal to 30 mol % (e.g., 30.0 mol %), less than or equal to 25 mol %, less than or equal to 22 mol %, less than or equal to 20 mol % (e.g., 20.0 mol %), less than or equal to 19.0 mol %, less than or equal to 18.5 mol %, less than or equal to 18.0 mol %, less than or equal to 17.5 mol %, less than or equal to 17.0 mol %, less than or equal to 16.5 mol %, less than or equal to 16.0 mol %, less than or equal to 15.5 mol %, less than or equal to 15.0 mol %, less than or equal to 14.5 mol %, less than or equal to 14.0 mol %, less than or equal to 13.5 mol %, less than or equal to 13.0 mol %, less than or equal or equal to 12.0 mol %, or less than or equal to 11.0 mol %. In aspects, the core composition can comprise an amount of Ta₂O₅ from greater than or equal to 1.5 mol % to less than or equal to 30 mol %, from greater than or equal to 3.0 mol % to less than or equal to 25 mol %, from greater than or equal to 5 mol % to less than or equal to 22 mol %, from greater than or equal to 7 mol % to less than or equal to 20.0 mol %, from greater than or equal to 8.0 mol % to less than or equal to 19.0 mol %, from greater than or equal to 9.0 mol % to less than or equal to 18.5 mol %, from greater than or equal to 10.0 mol % to less than or equal to 18.0 mol %, from greater than or equal to 14.5 mol % to less than or equal to 17.5 mol %, from greater than or equal to 15.0 mol % to less than or equal to 17.0 mol %, from greater than or equal to 15.5 mol % to less than or equal to 16.5 mol %, from greater than or equal to 15.5 mol % to less than or equal to 16.0 mol %, or any range or subrange therebetween. In preferred aspects, the core composition can comprise Ta₂O₅ in an amount from greater than or equal to 1.5 mol % to less than or equal to 19.0 mol %, from greater than or equal to 7.0 mol % to less than or equal to 19.0 mol %, or from greater than or equal to 11.0 mol % to less than or equal to 18.0 mol %.

Glass-based compositions can optionally include Al₂O₃ (e.g., in addition to Ta₂O₅ for the core composition). In the core composition, a predetermined refractive index can be achieved by tuning an amount of Ta₂O₅ while Al₂O₃ can be used to achieve a predetermined balance between Ta₂O₅+Al₂O₃ versus SiO₂. In aspects, an amount of Al₂O₃ in the core composition can be present in an amount greater than or equal to 0.0 mol %, greater than or equal to 0.2 mol %, greater than or equal to 0.5 mol %, greater than or equal to 1.0 mol %, greater than or equal to 2.0 mol %, greater than or equal to 3.0 mol %, less than or equal to 8.0 mol %, less than or equal to 6.0 mol %, less than or equal to 4.0 mol %, less than or equal to 3.0 mol %, less than or equal to 2.0 mol %, less than or equal to 1.0 mol %, less than or equal to 0.5 mol %, or less than or equal to 0.2 mol %. In aspects, an amount of Al₂O₃ in the core composition can be from greater than or equal to 0.0 mol % to less than or equal to 8.0 mol %, from greater than or equal to 0.2 mol % to less than or equal to 6.0 mol %, from greater than or equal to 0.5 mol % to less than or equal to 4.0 mol %, from greater than or equal to 1.0 mol % to less than or equal to 3.0 mol %, from greater than or equal to 1.0 mol % to less than or equal to 2.0 mol %, or any range or subrange therebetween. Unless otherwise indicated, as used herein, the term “free” does not require absolute precision nor atomic-scale accuracy, but rather “free” means that the component may be present in the final glass-based composition in very small amounts (e.g., as a contaminant, such as less than 0.1 mol %) that could be practically obtained by a reasonable practitioner, which does include 0.0 mol % in some aspects. In aspects, an amount of Al₂O₃ in the core composition can be from greater than or equal to 0.0 mol % to less than or equal to 2.0 mol %, from greater than or equal to 0.0 mol %, from greater than or equal to 1.0 mol %, from greater than or equal to 0.2 mol % to less than or equal to 0.5 mol %, or the core composition can be free of Al₂O₃.

The glass-based compositions (e.g., the core composition and the cladding composition) include Li₂O. The inclusion of Li₂O in the glass-based composition allows for control of an ion-exchange process and reduces the softening point of the composition, thereby increasing the manufacturability of the composition. The presence of Li₂O in the glass-based compositions (e.g., the core composition and the cladding composition) also allows the formation of a stress profile with a parabolic shape. In aspects, the core composition comprises Li₂O in an amount greater than or equal to 0.1 mol %, greater than or equal to 0.2 mol %, greater than or equal to 0.5 mol %, greater than or equal to 1.0 mol %, greater than or equal to 2.0 mol %, greater than or equal to 3.0 mol %, greater than or equal to 4.0 mol %, greater than or equal to 5.0 mol %, greater than or equal to 5.5 mol %, greater than or equal to 6.0 mol %, greater than or equal to 6.5 mol %, greater than or equal to 7.0 mol %, greater than or equal to 7.5 mol %, greater than or equal to 8.0 mol %, greater than or equal to 8.5 mol %, greater than or equal to 9.0 mol %, greater than or equal to 9.5 mol %, greater than or equal to 10.0 mol %, greater than or equal to 11.0 mol %, greater than or equal to 12.0 mol %, greater than or equal to 13.0 mol %, greater than or equal to 14.0 mol %, greater than or equal to 15.0 mol %, less than or equal to 30 mol %, less than or equal to 26 mol %, less than or equal to 23 mol %, less than or equal to 21 mol % (e.g., 21.0 mol %), less than or equal to 20.5 mol %, less than or equal to 20.0 mol %, less than or equal to 19.5 mol %, less than or equal to 19.0 mol %, less than or equal to 18.5 mol %, less than or equal to 18.0 mol %, less than or equal to 17.5 mol %, less than or equal to 17.0 mol %, less than or equal to 16.5 mol %, less than or equal to 16.0 mol %, less than or equal to 15.0 mol %, less than or equal to 14.0 mol %, less than or equal to 13.0 mol %, less than or equal to 12.0 mol %, less than or equal to 11.0 mol %, less than or equal to 10.0 mol %, less than or equal to 9.0 mol %, less than or equal to 8.0 mol %, or less than or equal to 7.0 mol %. In aspects, the core composition comprises an amount of Li₂O from greater than or equal to 0.1 mol % to less than or equal to 30 mol %, from greater than or equal to 0.2 mol % to less than or equal to 26 mol %, from greater than or equal to 0.5 mol % to less than or equal to 23 mol %, from greater than or equal to 1.0 mol % to less than or equal to 21.0 mol %, from greater than or equal to 2.0 mol % to less than or equal to 20.5 mol %, from greater than or equal to 3.0 mol % to less than or equal to 20.0 mol %, from greater than or equal to 4.0 mol % to less than or equal to 19.5 mol %, from greater than or equal to 5.0 mol % to less than or equal to 19.0 mol %, from greater than or equal to 5.5 mol % to less than or equal to 19.0 mol %, from greater than or equal to 6.0 mol % to less than or equal to 18.5 mol %, from greater than or equal to 6.5 mol % to less than or equal to 18.0 mol %, from greater than or equal to 7.0 mol % to less than or equal to 18.5 mol %, from greater than or equal to 7.5 mol % to less than or equal to 18.0 mol %, from greater than or equal to 8.0 mol % to less than or equal to 17.5 mol %, from greater than or equal to 8.5 mol % to less than or equal to 17.0 mol %, from greater than or equal to 9.0 mol % to less than or equal to 16.5 mol %, from greater than or equal to 9.5 mol % to less than or equal to 16.0 mol %, from greater than or equal to 10.0 mol % to less than or equal to 15.0 mol %, from greater than or equal to 11.0 mol % to less than or equal to 14.0 mol %, from greater than or equal to 12.0 mol % to less than or equal to 13.0 mol %, or any range or subrange therebetween. In preferred aspects, the core composition comprises LiO in an amount from greater than or equal to 0.1 mol % to less than or equal to 30 mol %, from greater than or equal to 1.0 mol % to less than or equal to 21 mol %, or from than or equal to 5.5 mol % to less than or equal to 19.0 mol %.

The glass-based compositions (e.g., the core composition and the cladding composition) described herein include Na₂O. Na₂O may aid in the ion-exchangeability of the glass-based composition, and improve the formability, and thereby manufacturability, of the glass-based composition. However, if too much Na₂O is added to the glass-based composition, the CTE may be too low, and the melting point may be too high. Additionally, if too much Na₂O is included in the composition relative to the amount of Li₂O the ability of the glass-based substrate to achieve a deep depth of compression when ion exchanged may be reduced. In aspects, the core composition comprises Na₂O in an amount greater than or equal to 0.2 mol %, greater than or equal to 0.5 mol %, greater than or equal to 1.0 mol %, greater than or equal to 1.5 mol %, greater than or equal to 2.0 mol %, greater than or equal to 2.5 mol %, greater than or equal to 3.0 mol %, greater than or equal to 3.5 mol %, greater than or equal to 4.0 mol %, greater than or equal to 4.5 mol %, greater than or equal to 5.0 mol %, greater than or equal to 5.5 mol %, greater than or equal to 6.0 mol %, greater than or equal to 6.5 mol %, greater than or equal to 7.0 mol %, greater than or equal to 8.0 mol %, greater than or equal to 9.0 mol %, greater than or equal to 10.0 mol %, greater than or equal to 11.0 mol %, less than or equal to 30 mol %, less than or equal to 26 mol %, less than or equal to 23 mol %, less than or equal to 21 mol % (e.g., 21.0 mol %), less than or equal to 19.0 mol %, less than or equal to 17.0 mol %, less than or equal to 15.0 mol %, less than or equal to 14.0 mol %, less than or equal to 13.0 mol %, less than or equal to 12.5 mol %, less than or equal to 12.0 mol %, less than or equal to 11.5 mol %, less than or equal to 11.0 mol %, less than or equal to 10.5 mol %, less than or equal to 10.0 mol %, less than or equal to 9.5 mol %, less than or equal to 9.0 mol %, less than or equal to 8.5 mol %, less than or equal to 7.0 mol %, less than or equal to 6.5 mol %, less than or equal to 6.0 mol %, less than or equal to 5.0 mol %, or less than or equal to 4.0 mol %. In aspects, the core composition comprises an amount of Na₂O from greater than or equal to 0.2 mol % to less than or equal to 30 mol %, from greater than or equal to 0.5 mol % to less than or equal to 26 mol %, from greater than or equal to 1.0 mol % to less than or equal to 23 mol %, from greater than or equal to 2.0 mol % to less than or equal to 21 mol %, from greater than or equal to 2.5 mol % to less than or equal to 19.0 mol %, from greater than or equal to 3.0 mol % to less than or equal to 17.0 mol %, from greater than or equal to 3.5 mol % to less than or equal to 15.0 mol %, from greater than or equal to 4.0 mol % to less than or equal to 14.0 mol %, from greater than or equal to 4.5 mol % to less than or equal to 13.0 mol %, from greater than or equal to 5.0 mol % to less than or equal to 12.5 mol %, from greater than or equal to 5.5 mol % to less than or equal to 12.0 mol %, from greater than or equal to 6.0 mol % to less than or equal to 11.5 mol %, from greater than or equal to 6.5 mol % to less than or equal to 11.0 mol %, from greater than or equal to 7.0 mol % to less than or equal to 10.5 mol %, from greater than or equal to 7.5 mol % to less than or equal to 10.0 mol %, from greater than or equal to 8.0 mol % to less than or equal to 9.5 mol %, from greater than or equal to 8.5 mol % to less than or equal to 9.0 mol %, or any range or subrange therebetween. In preferred aspects, the core composition comprises Na₂O in an amount from greater than or equal to 0.2 mol % to less than or equal to 30 mol % Na₂O, greater than or equal to 1.0 mol % to less than or equal to 21 mol %, or from greater than or equal to 3.0 mol % to less than or equal to 13.0 mol %.

The glass-based compositions can optionally include K₂O. The inclusion of K₂O in the glass-based composition increases the potassium diffusivity in the glass-based material, enabling a deeper depth of a compressive stress spike (DOL_{SP}) to be achieved in a shorter amount of ion-exchange time. If too much K₂O is included in the composition the amount of compressive stress imparted during an ion-exchange process may be reduced. In aspects, the core composition can comprise K₂O in an amount greater than or equal to 0.0 mol %, greater than or equal to 0.25 mol %, greater than or equal to 0.5 mol %, greater than or equal to 0.75 mol % or more, greater than or equal to 1.0 mol %, greater than or equal to 1.5 mol %, greater than or equal to 2.0 mol %, less than or equal to 4.5 mol %, less than or equal to 4.0 mol %, less than or equal to 3.5 mol %, less than or equal to 3.0 mol %, less than or equal to 2.5 mol %, less than or equal to 2.0 mol %, less than or equal to 1.5 mol %, less than or equal to 1.0 mol %, less than or equal to 0.5 mol %, or less than or equal to 0.25 mol %. In aspects, the core composition can comprise an amount of K₂O from greater than or equal to 0 mol % to less than or equal to 4.5 mol %, from greater than or equal to 0.25 mol % to less than or equal to 4.0 mol %, from greater than or equal to 0.5 mol % to less than or equal to 3.5 mol %, from greater than or equal to 1.0 mol % to less than or equal to 3.0 mol %, from greater than or equal to 1.5 mol % to less than or equal to 2.5 mol %, from greater than or equal to 1.5 mol % to less than or equal to 2.0 mol %, or any range or subrange therebetween. In aspects, the core composition can be free of K₂O. In preferred aspects, the core composition can comprise an amount of K₂O from greater than or equal to 0 mol % to less than or equal to 4.5 mol %, from greater than or equal to 0.25 mol % to less than or equal to 3.0 mol %, or from greater than or equal to 1.0 mol % to less than or equal to 2.0 mol %.

Throughout the disclosure, “R₂O” refers to a total amount of alkali metal oxides. “R₂O” can refer to a total amount of Li₂O, Na₂O, K₂O, Cs₂O, and Rb₂O. In aspects, the core composition can be free of Cs₂O and/or Rb₂O. In aspects, the alkali metal oxides can enable and/or facilitate ion-exchangability of the corresponding glass composition. Also, the amount of alkali metal oxides can be adjusted to achieve a predetermined coefficient of thermal expansion (e.g., substantially match a coefficient of thermal expansion between the core composition and a cladding composition in a waveguide). Also, including alkali metal oxides can improve the formability and manufacturability of the glass-based composition. In aspects, an amount of R₂O in the core composition can be greater than or equal to 0.3 mol %, greater than or equal to 0.5 mol %, greater than or equal to 1.0 mol %, greater than or equal to 2.0 mol %, greater than or equal to 5.0 mol %, greater than or equal to 7.0 mol %, greater than or equal to 10.0 mol %, greater than or equal to 13.0 mol %, greater than or equal to 14.0 mol %, greater than or equal to 15.0 mol %, greater than or equal to 15.5 mol %, greater than or equal to 16.0 mol %, greater than or equal to 16.0 mol %, greater than or equal to 16.5 mol %, greater than or equal to 17.0 mol %, greater than or equal to 17.5 mol %, greater than or equal to 18.0 mol %, greater than or equal to 18.5 mol %, greater than or equal to 19.0 mol %, greater than or equal to 20.0 mol %, greater than or equal to 21.0 mol %, greater than or equal to 22.0 mol %, less than or equal to 24.0 mol %, less than or equal to 23.7 mol %, less than or equal to 23.5 mol %, less than or equal to 23.2 mol %, less than or equal to 23.0 mol %, less than or equal to 22.5 mol %, less than or equal to 22.0 mol %, less than or equal to 21.5 mol %, less than or equal to 21.0 mol %, less than or equal to 20.5 mol %, less than or equal to 20.0 mol %, less than or equal to 19.5 mol %, less than or equal to 19.0 mol %, less than or equal to 18.5 mol %, less than or equal to 18.0 mol %, less than or equal to 17.0 mol %, less than or equal to 16.0 mol %, less than or equal to 15.0 mol %, less than or equal to 14.0 mol %, or less than or equal to 12.0 mol %. In aspects, an amount of R₂O in the core composition can be from greater than or equal to 0.3 mol % to less than or equal to 24.0 mol %, from greater than or equal to 0.5 mol % to less than or equal to 23.7 mol %, from greater than or equal to 1.0 mol % to less than or equal to 23.5 mol %, from greater than or equal to 2.0 mol % to less than or equal to 23.2 mol %, from greater than or equal to 5.0 mol % to less than or equal to 23.0 mol %, from greater than or equal to 7.0 mol % to less than or equal to 22.5 mol %, from greater than or equal to 10.0 mol % to less than or equal to 22.0 mol %, from greater than or equal to 13.0 mol % to less than or equal to 21.5 mol %, from greater than or equal to 14.0 mol % to less than or equal to 21.0 mol %, from greater than or equal to 14.5 mol % to less than or equal to 20.5 mol %, from greater than or equal to 15.0 mol % to less than or equal to 20.0 mol %, from greater than or equal to 15.5 mol % to less than or equal to 19.5 mol %, from greater than or equal to 16.0 mol % to less than or equal to 19.0 mol %, from greater than or equal to 16.5 mol % to less than or equal to 18.5 mol %, from greater than or equal to 17.0 mol % to less than or equal to 18.0 mol %, or any range or subrange therebetween. In preferred aspects, an amount of R₂O in the core composition can be greater than or equal to 0.3 mol % to less than or equal to 24.0 mol %, from greater than or equal to 10.0 mol % to less than or equal to 23.5 mol %, or from greater than or equal to 15.0 mol % to less than or equal to 23.0 mol %.

The glass-based compositions (e.g., core composition, cladding composition) may optionally include MgO. MgO may lower the viscosity of a glass, which enhances the formability and manufacturability of the composition. The inclusion of MgO in a glass-based composition may also improve the strain point and the Young's modulus of the glass-based composition. However, if too much MgO is added to the glass-based composition, the liquidus viscosity may be too low for compatibility with desirable forming techniques. The addition of too much MgO may also increase the density and the CTE of the glass-based composition to undesirable levels. In aspects, the core composition can comprise MgO in an amount greater than or equal to 0.0 mol %, greater than or equal to 0.1 mol %, greater than or equal to 0.2 mol %, greater than or equal to 0.3 mol %, greater than or equal to 0.4 mol %, greater than or equal to 0.5 mol %, greater than or equal to 1.0 mol %, greater than or equal to 1.5 mol %, greater than or equal to 2.0 mol %, greater than or equal to 2.5 mol %, greater than or equal to 3.0 mol %, less than or equal to 3.75 mol %, less than or equal to 3.5 mol %, less than or equal to 3.0 mol %, less than or equal to 2.5 mol %, less than or equal to 2.0 mol %, less than or equal to 1.5 mol %, less than or equal to 1.0 mol %, less than or equal to 0.5 mol %, or less than or equal to 0.2 mol %. In aspects, the core composition can comprise an amount of MgO from greater than or equal to 0.0 mol % to less than or equal to 3.75 mol %, from greater than or equal to 0.1 mol % to less than or equal to 3.5 mol %, from greater than or equal to 0.2 mol % to less than or equal to 3.0 mol %, from greater than or equal to 0.3 mol % to less than or equal to 2.5 mol %, from greater than or equal to 0.4 mol % to less than or equal to 2.0 mol %, from greater than or equal to 0.5 mol % to less than or equal to 1.5 mol %, from greater than or equal to 1.0 mol % to less than or equal to 1.5 mol %, or any range or subrange therebetween. In aspects, the core composition can be free of MgO. In preferred aspects, the composition comprises MgO in an amount from greater than or equal to 0.0 mol % to less than or equal to 3.75 mol %, from greater than or equal to 0.2 mol % to less than or equal to 3.5 mol %, or from greater than or equal to 0.4 mol % to less than or equal to 3.0 mol %.

Throughout the disclosure, “RO” refers to a total amount of alkaline earth oxides. “RO” can refer to a total amount of MgO, CaO, SrO, and BaO. In aspects, the core composition can be free of CaO, SrO, and/or BaO. In aspects, the core composition can be free of ZnO. In aspects, divalent cation oxides (e.g., alkaline earth oxides) can improve the melting behavior of glass compositions. In aspects, divalent cation oxides can improve stress relaxation. In aspects, alkaline earth oxides can charge balance tetrahedral alumina and/or tantalum oxide. In aspects, the core composition can comprise RO within one or more of the ranges discussed above for the amount of MgO. In aspects, the core composition can comprise RO in an amount of less than or equal to 1.0 mol %, for example, from greater than or equal to 0.0 mol % to less than or equal to 1.0 mol %, from greater than or equal to 0.1 mol % to less than or equal to 0.5 mol %, or from greater than or equal to 0.2 mol % to less than or equal to 0.3 mol %.

In aspects, the glass-based compositions can optionally include ZrO₂. In aspects, an amount of ZrO₂ in the core composition can be within one or more of the ranges discussed above for K₂O. In aspects, an amount of ZrO₂ in the core composition can be from greater than or equal to 0.0 mol % to less than or equal to 4.5 mol %, from greater than or equal to 0.0 mol % to less than or equal to 4.0 mol %, or from greater than or equal to 0.0 mol % to less than or equal to 3.0 mol %. Alternatively, in aspects, the glass-based composition may be free of ZrO₂. The inclusion of ZrO₂ in the glass-based composition may result in the formation of undesirable zirconia inclusions in the glass-based material, due at least in part to the low solubility of ZrO₂ in the glass-based material. While the inclusion of ZrO₂ in the glass-based composition may increase the fracture toughness, there are cost and supply constraints as well as the previously described devitrification issues that may make using these components undesirable for commercial purposes.

The glass-based compositions (e.g., core composition, cladding composition) can optionally include B₂O₃. The inclusion of B₂O₃ increases the fracture toughness of the glass-based material. In particular, the glass-based compositions include boron in the trigonal configuration which increases the Knoop scratch threshold and fracture toughness of the glass-based article. If too much B₂O₃ is included in the composition the amount of compressive stress imparted in an ion-exchange process may be reduced and volatility at free surfaces during manufacturing may increase to undesirable levels. In aspects, the core composition can comprise B₂O₃ in an amount greater than or equal to 0.0 mol %, greater than or equal to 0.5 mol %, greater than or equal to 1.0 mol %, greater than or equal to 1.5 mol %, greater than or equal to 2.0 mol %, greater than or equal to 2.5 mol %, greater than or equal to 3.0 mol %, less than or equal to 6.0 mol %, less than or equal to 5.0 mol % or less, less than or equal to 4.0 mol %, less than or equal to 3.0 mol %, less than or equal to 2.0 mol %, or less than or equal to 1.0 mol %. In aspects, the core composition can comprise an amount of B₂O₃ from greater than or equal to 0.0 mol % to less than or equal to 6.0 mol %, from greater than or equal to 0.5 mol % to less than or equal to 5.0 mol %, from greater than or equal to 1.0 mol % to less than or equal to 4.0 mol %, from greater than or equal to 2.0 mol % to less than or equal to 3.0 mol %, or any range or subrange therebetween. Alternatively, in aspects, the core composition can be free of B₂O₃. In preferred aspects, the core composition can B₂O₃ in an amount from greater than or equal to 0.0 mol % to less than or equal to 6.0 mol %, from greater than or equal to 0.5 mol % to less than or equal to 4.0 mol %, or from greater than or equal to 1.0 mol % to less than or equal to 3.0 mol %.

The glass-based compositions can optionally include P₂O₅. The inclusion of P₂O₅ increases the diffusivity of ions in the glass-based, increasing the speed of the ion-exchange process. If too much P₂O₅ is included in the composition the amount of compressive stress imparted in an ion-exchange process may be reduced and volatility at free surfaces during manufacturing may increase to undesirable levels. In aspects, the core composition can comprise P₂O₅ within one or more of the ranges discussed above for K₂O. Alternatively, in aspects, the core composition can be free of P₂O₅. In preferred aspects, the core composition comprises P₂O₅ in an amount from greater than or equal to 0.0 mol % to less than or equal to 4.0 mol %, from greater than or equal to 0.5 mol % to less than or equal to 3.0 mol %, or from greater than or equal to 1.0 mol % to less than or equal to 2.0 mol %.

The glass-based compositions described herein can optionally include TiO₂. The inclusion of too much TiO₂ in the glass-based composition may result in the composition being susceptible to devitrification and/or exhibiting an undesirable coloration as well as undesirably changing the liquidus. TiO₂ can be used to increase the refractive index of the core composition. As discussed above, the high refractive index of core composition can be achieved without the use of TiO₂; however TiO₂ can be included in the core composition in some aspects. In aspects, the core composition can comprise TiO₂ within one or more of the ranges discussed above for K₂O. In preferred aspects, the core composition comprises TiO₂ in an amount from greater than or equal to 0.0 mol % to less than or equal to 4.0 mol %, from greater than or equal to 0.5 mol % to less than or equal to 3.0 mol %, or from greater than or equal to 1.0 mol % to less than or equal to 2.0 mol %. Alternatively, the core composition can be free of TiO₂.

The core composition can optionally include Nb₂O₅. Nb₂O₅ can be used to increase the refractive index of the core composition. In aspects, the core composition can comprise Nb₂O₅ in an amount greater than or equal to 0.0 mol %, greater than or equal to 0.5 mol %, greater than or equal to 1.0 mol %, greater than or equal to 2.0 mol %, greater than or equal to 4.0 mol %, less than or equal to 10.0 mol %, less than or equal to 8.0 mol %, less than or equal to 6.0 mol %, less than or equal to 3.0 mol %, or less than or equal to 1.0 mol %. In aspects, the core composition can comprise Nb₂O₅ in an amount from greater than or equal to 0.0 mol % to less than or equal to 10.0 mol %, from greater than or equal to 0.5 mol % to less than or equal to 8.0 mol %, from greater than or equal to 1.0 mol % to less or equal to 6.0 mol %, from greater than or equal to 2.0 mol % to less than or equal to 3.0 mol %, or any range or subrange therebetween. In preferred aspects, the core composition comprises Nb₂O₅ in an amount from greater than or equal to 0.0 mol % to less than or equal to 10.0 mol %, from greater than or equal to 0.5 mol % to less than or equal to 6.0 mol %, or from greater than or equal to 1.0 mol % to less than or equal to 3.0 mol %. Alternatively, the core composition can be free of Nb₂O₅.

The glass-based compositions can optionally include a colorant including one or more of Ag₂O, CuO, WO₃, NaF, Bi₂O₃, Fe₂O₃, MnO₂, Co₃O₄, and/or Cr₂O₃. In aspects, the core composition can comprise one or more colorant in an amount greater than or equal to 0.00 mol %, greater than or equal to 0.01 mol % or more, greater than or equal to 0.02 mol % or more, greater than or equal to 0.04 mol %, greater than or equal to 0.06 mol %, greater or equal to 0.08 mol %, less than or equal to 0.15 mol %, less than or equal to 0.13 mol %, less than or equal to 0.09 mol %, less than or equal to 0.07 mol %, less than or equal to 0.05 mol %, or less than or equal to 0.03 mol %. In aspects, the core composition can comprise one or more colorant in an amount of from greater than or equal to 0.00 mol % to less than or equal to 0.15 mol %, from greater than or equal to 0.01 mol % to less than or equal to 0.13 mol %, from greater than or equal to 0.02 mol % to less than or equal to 0.11 mol %, from greater than or equal to 0.04 mol % to less than or equal to 0.09 mol %, from greater than or equal to 0.06 mol % to less than or equal to 0.07 mol %, or any range or subrange therebetween. In aspects, a total amount of colorants in the core composition can be within one or more of the ranges discussed above in this paragraph. In aspects, an amount of Ag₂O can be from greater than or equal to 0.00 mol % to less than or equal to 0.13 mol %, from greater than or equal to 0.01 mol % to less than or equal to 0.09 mol %, or from greater than or equal to 0.03 mol % to less than or equal to 0.06 mol %. In aspects, an amount of CuO in the core composition can be from greater than or equal to 0.00 mol % to less than or equal to 0.09 mol %, from greater than or equal to 0.01 mol % to less than or equal to 0.07 mol %, or from 0.02 mol % to less than or equal to 0.05 mol %. Iron is often present in raw materials utilized to form glass-based compositions, and as a result may be detectable in the glass-based compositions described herein even when not actively added to the glass-based batch. In preferred aspects, the composition comprises Fe₂O₃ in an amount from greater than or equal to 0 mol % to less than or equal to 0.1 mol %, from 0.0001 mol % to 0.05 mol % or from 0.01 mol % to 0.03 mol %. Alternatively, in aspects, the core composition can be free of or more colorant (e.g., Ag₂O, CuO, WO₃, NaF, Bi₂O₃, Fe₂O₃, MnO₂, Co₃O₄, and/or Cr₂O₃). In further aspects, the core composition can be free of Ag₂O, CuO, WO₃, NaF, Bi₂O₃, Fe₂O₃, MnO₂, Co₃O₄, and Cr₂O₃.

The glass-based compositions may optionally include one or more fining agents. In aspects, the fining agent may include, for example, SnO₂. In aspects, SnO₂ may be present in the core composition in an amount less than or equal to 0.25 mol %, such as from greater than or equal to 0.0 mol % to less than or equal to 0.25 mol %, from greater than or equal to 0.05 mol % to less than or equal to 0.20 mol %, from greater than or equal to 0.10 mol % to less than or equal to 0.15 mol %, or any range or subrange therebetween. In some aspects, the glass-based composition may be free of SnO₂. In aspects, the core composition and/or the cladding composition may be free of one or more of arsenic, antimony, cadmium, mercury, selenium, and/or lead.

In aspects, the core composition may be formed primarily from (i.e., containing 0.5 mol % or more of each) SiO₂, Ta₂O₅, Li₂O, and Na₂O. In further aspects, the core composition can optionally include one or more of Al₂O₃, K₂O, MgO, ZrO₂, B₂O₃, Nb₂O₅, and/or SnO₂. In aspects, the core composition can be free of components other than SiO₂, Ta₂O₅, Li₂O, Na₂O, Al₂O₃, K₂O, MgO, ZrO₂, B₂O₃, Nb₂O₅, and/or SnO₂. In aspects, the glass-based composition (e.g., core composition, cladding composition) may be free of at least one of HfO₂, La₂O₃, and Y₂O₃. In aspects, the glass-based composition may be free of HfO₂, La₂O₃, and Y₂O₃. While these components may increase the fracture toughness of the glass-based when included, there are cost and supply constraints that make using these components undesirable for commercial purposes.

Throughout the disclosure, refractive index is measured in accordance with ASTM E1967-19, where the first wavelength comprises 589 nm. As used herein, a glass-based material formed from the core composition (core material) has a core refractive while a glass-based material formed from the cladding composition (cladding material) has a clad refractive index. In aspects, the core refractive index (of the core material) can be greater than or equal to 1.60, greater than or equal to 1.63, greater than or equal to 1.65, greater than or equal to 1.67, greater than or equal to 1.69, greater than or equal to 1.71, greater than or equal to 1.73, less than or equal to 1.80, less than or equal to 1.77, less than or equal to 1.75, less than or equal to 1.73, less than or equal to 1.71, less than or equal to 1.69, or less than or equal to 1.67. In aspects, the core refractive index can be from greater than or equal to 1.60 to less than or equal to 1.80, from greater than or equal to 1.63 to less than or equal to 1.77, from greater than or equal to 1.65 to less than or equal to 1.75, from greater than or equal to 1.67 to less than or equal to 1.73, or from greater than or equal to 1.69 to less than or equal to 1.71, or any range or subrange therebetween. In preferred aspects, the core refractive index can be from greater than or equal to 1.60 to less than or equal to 1.80, from greater than or equal to 1.65 to less than or equal to 1.75, or from greater than or equal to 1.67 to less than or equal to 1.71.

Throughout the disclosure, the linear coefficient of thermal expansion (CTE) is measured over the temperature range from 0° C. to 300° C. using a push-rod dilatometer in accordance with ASTM E228-11. Unless otherwise indicated, the “coefficient of thermal expansion” refers to the linear coefficient of thermal expansion and is expressed in terms of 10⁻⁷° C.⁻¹. In aspects, a CTE of the core material and/or the cladding material can be greater than or equal to 50×10⁻⁷° C.⁻¹, greater than or equal to 55×10⁻⁷° C.⁻¹, from greater than or equal to 57×10⁻⁷° C.⁻¹, from greater than or equal to 60×10⁻⁷° C.⁻¹, from greater than or equal to 63×10⁻⁷° C.⁻¹, from greater than or equal to 65×10⁻⁷° C.⁻¹, from greater than or equal to 67×10⁻⁷° C.⁻¹, greater than or equal to 70×10⁻⁷° C.⁻¹, less than or equal to 80×10⁻⁷° C.⁻¹, less than or equal to 75×10⁻⁷° C.⁻¹, less than or equal to 73×10⁻⁷° C.⁻¹, less than or equal to 70×10⁻⁷° C.⁻¹, less than or equal to 67×10⁻⁷° C.⁻¹, less than or equal to 65×10⁻⁷° C.⁻¹, less than or equal to 63×10⁻⁷° C.⁻¹, or less than or equal to 60×10⁻⁷° C.⁻¹. In aspects, a CTE of the core material and/or the cladding material can be from greater than or equal to 50×10⁻⁷° C.⁻¹ to less than or equal to 80×10⁻⁷° C.⁻¹, from greater than or equal to 55×10⁻⁷° C.⁻¹ to less than or equal to 75×10⁻⁷° C.⁻¹, from greater than or equal to 57×10⁻⁷° C.⁻¹ to less than or equal to 73×10⁻⁷° C.⁻¹, from greater than or equal to 60×10⁻⁷° C.⁻¹ to less than or equal to 70×10⁻⁷° C.⁻¹, from greater than or equal to 63×10⁻⁷° C.⁻¹ to less than or equal to 67×10⁻⁷° C.⁻¹, from greater than or equal to 65×10⁻⁷° C.⁻¹ to less than or equal to 67×10⁻⁷° C.⁻¹, or any range or subrange therebetween.

Throughout the disclosure, density of glass-based materials is determined using the buoyancy method of ASTM C693-93(2013). In aspects, a density of the core material can be greater than or equal to 3.0 g/cm³, greater than or equal to 3.3 g/cm³, greater than or equal to 3.4 g/cm³, greater than or equal to 3.5 g/cm³, greater than or equal to 3.7 g/cm³, greater than or equal to 4.0 g/cm³, less than or equal to 4.25 g/cm³, less than or equal to 4.0 g/cm³, less than or equal to 3.9 g/cm³, less than or equal to 3.7 g/cm³, or less than or equal to 3.6 g/cm³. In aspects, a density of the core material can be from greater than or equal to 3.0 g/cm³ to less than or equal to 4.25 g/cm³, from greater than or equal to 3.3 g/cm³ to less than or equal to 4.0 g/cm³, from greater than or equal to 3.4 g/cm³ to less than or equal to 4.0 g/cm³, from greater than or equal to 3.5 g/cm³ to less than or equal to 3.9 g/cm³, from greater than or equal to 3.7 g/cm³ to less than or equal to 3.8 g/cm³, or any range or subrange therebetween. In preferred aspects, the density of the clad material can be from greater than or equal to 3.0 g/cm³ to less than or equal to 4.25 g/cm³, from greater than or equal to 3.3 g/cm³ to less than or equal to 4.0 g/cm³ or from greater than or equal to 3.4 g/cm³ to less than or equal to 3.9 g/cm³.

The glass-based compositions (e.g., core composition, cladding composition) described herein have liquidus viscosities that are compatible with manufacturing processes that are especially suitable for forming thin glass sheets, glass rods, composites, laminates, and waveguides. For example, the glass compositions are compatible with down-draw processes such as fusion-draw processes or slot-draw processes. Embodiments of the glass-based compositions may be described as fusion-formable (i.e., formable using a fusion-draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass-based article. The fusion of the glass films produces a fusion line within the glass-based substrate, and this fusion line allows glass-based substrates that were fusion formed to be identified without additional knowledge of the manufacturing history. The fusion-draw method offers the advantage that, because the two glass films flowing over the channel fuse together, neither of the outside surfaces of the resulting glass-based article comes in contact with any part of the apparatus. Thus, the surface properties of the fusion-drawn glass-based article are not affected by such contact. The glass-based compositions described herein may be selected to have liquidus viscosities that are compatible with fusion-draw processes and/or slot-draw processes. Thus, the glass-based compositions described herein are compatible with existing forming methods, increasing the manufacturability of glass-based articles formed from the glass-based compositions. Additionally, the glass-based compositions can be redrawn one or more times to reduce a thickness (e.g., maximum cross-sectional dimension, diameter) of the glass-based substrate.

Additionally, as discussed below, the core composition and the cladding composition can have compatible viscosity profiles that allow both compositions to be redrawn together in a single assembly to form a waveguide, where the cladding composition can circumferentially surround and be fused to the core composition, which can be formed as a rod.

In aspects, the glass-based compositions described herein may form glass-based articles that exhibit an amorphous microstructure and may be free of crystals or crystallites. In other words, the glass-based articles formed from the glass compositions described herein may exclude glass-ceramic materials. Alternatively, in aspects, the glass-based articles can form glass-ceramics. In further aspects, the glass-ceramic can be found by heating an amorphous glass-based article to nucleate and/or grow crystallites.

Throughout the disclosure, “average transmittance” is determined over optical wavelengths from 400 nm to 700 nm and is calculated by measuring the transmittance through a thickness of sample with a thickness of 0.7 mm for whole number wavelengths from 400 nm to 700 nm and averaging the measurements. Unless otherwise indicated, “transmittance” refers to “average transmittance” (as defined above). “Total transmittance” compares the amount of light transmitted through the sample to the total amount of light incident light to the sample. In contrast, “internal transmittance” does not consider light reflected from the incident surface as part of the total light. In aspects, an average transmittance (for optical wavelengths from 400 nm to 700 nm) for a 0.7 mm thick sample of a glass-based material comprising the core composition can be greater than or equal to 60%, greater than or equal to 70%, greater than or equal to 80%, greater than or equal to 82%, greater than or equal to 85%, greater than or equal to 88%, greater than or equal to 90%, greater than or equal to 91%, greater than or equal to 92%, less than or equal to 100%, less than or equal to 98%, less than or equal to 96%, less than or equal to 94%, less than or equal to 93%, less than or equal to 92%, less than or equal to 91%, less than or equal to 90%, less than or equal to 87%, or less than or equal to 85%. In aspects, an average transmittance (for optical wavelengths from 400 nm to 700 nm) for a 0.7 mm thick sample of a glass-based material comprising the core composition can be from greater than or equal to 60% to less than or equal to 100%, from greater than or equal to 70% to less than or equal to 98%, from greater than or equal to 80% to less than or equal to 96%, from greater than or equal to 85% to less than or equal to 95%, from greater than or equal to 88% to less than or equal to 94%, from greater than or equal to 90% to less than or equal to 93%, from greater than or equal to 91% to less than or equal to 92%, or any range or subrange therebetween. In aspects, the average transmittance for a 0.7 mm thick sample of the glass-based material can be less than or equal to 87%, for example, from greater than or equal to 70% to less than or equal to 87%, from greater than or equal to 80% to less than or equal to 87%, from greater than or equal to 82% to less than or equal to 85%, or any range or subrange therebetween. In aspects, a total transmittance (e.g., average total transmittance) for a 0.7 mm thick sample of a glass-based material comprising the cladding composition can be within one or more of the ranges discussed above in this paragraph. Providing a high transmittance (e.g., from 70% to 96%, from 80% to 93%, from 82% to 87%) of a core material can enable the transmission of signals therethrough. Additionally or alternatively, a transmittance over a smaller range of optical wavelengths (e.g., a 50 nm range of optical wavelengths) can be within one or more of the ranges discussed above in this paragraph independent of a value of the average transmittance averages over optical wavelengths from 400 nm to 700 nm.

Throughout the disclosure, CIE color coordinates are with reference to the CIELAB 1976 color space established by the International Commission on Illumination (CIE). Unless otherwise indicated, CIE color coordinates are measured in transmission through the glass article using an F02 illuminant and an observer angle of 10°. The CIELAB 1976 color space expresses color as three values: L* for the lightness from black (0) to white (100), a* from green (−) to red (+), and b* from blue (−) to yellow (+). Without wishing to be bound by theory, CIE color coordinates with L* of 96.5 or more can appear as colorless.

In aspects, the core composition can exhibit a CIE L* value greater than or equal to 70, greater than or equal to 80, greater than or equal to 90, greater than or equal to 92, greater than or equal to 94, greater than or equal to 96, or greater than or equal to 96, less than or equal to 100, less than or equal to 99, less than or equal to 98, less than or equal 97, or less than or equal to 96.5 (e.g., from 70 to 100, from 80 to 99, from 90 to 98, from 92 to 97, from 94 to 96.5). In preferred aspects, the CIE L* value of the core composition can be from greater than or equal to 70 to less than or equal to 100, from greater than or equal to 90 to less than or equal to 99, or from greater than or equal to 96.5 to less than or equal to 98.

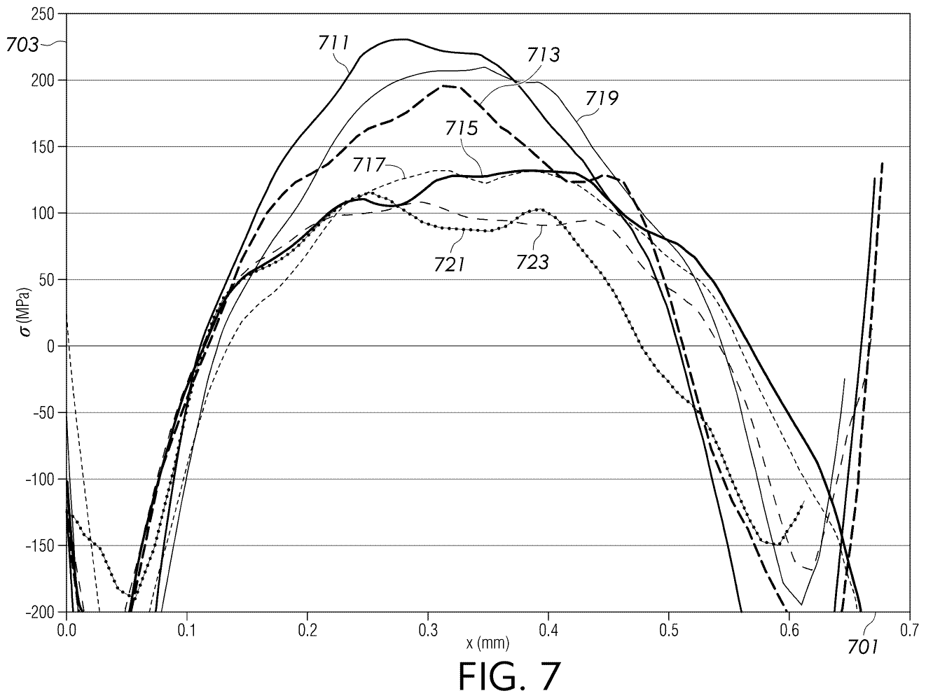

As mentioned above, in aspects, the materials comprising glass-based compositions (e.g., core material comprising the core composition, cladding material comprising the cladding composition) described herein can be strengthened, such as by ion exchange (i.e., chemically strengthened), making a glass-based article that is damage resistant for applications such as, but not limited to, display covers. In further aspects, glass-based materials (e.g., glass-based article) can have a compressive stress region have compressive stress extending from a major surface of the glass-based material to a depth of compression, and/or the glass-based material can have a central tension region under tensile stress (e.g., central tension (CT)), for example, with the compressive stress region positioned between the major surface and the central tension region. As used herein, “depth of compression” (DOC) refers to the depth at which the stress within the glass-based material (e.g., glass-based article) changes from compressive to tensile. At the DOC, the stress crosses from a positive (compressive) stress to a negative (tensile) stress and thus exhibits a stress value of zero. According to the convention normally used in the art and in FIG. 7, compression or compressive stress is expressed as a positive (>0) stress and tension or tensile stress is expressed as a negative (<0) stress. Throughout this description, however, CS and CT are both expressed as positive or absolute values—(i.e., CS=|CS|). The compressive stress (CS) can have a maximum at or near the surface of the glass-based article, and the CS varies as a function of a distance from the major surface.

In aspects, the compressive stress region(s) may be created by chemically strengthening a glass-based substrate to form the glass-based article. Chemically strengthening may comprise an ion-exchange process, where ions in a surface layer are replaced by—or exchanged with—larger ions having the same valence or oxidation state. Methods of chemically strengthening will be discussed later. Depth of compression (DOC) may be measured by a surface stress meter or a scattered light polariscope (SCALP, wherein values reported herein were made using SCALP-5 made by Glasstress Co., Estonia) depending on the ion-exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure a depth of compression. Unless specified otherwise, compressive stress (including surface CS) is measured by a surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 μm, SCALP is used to measure the depth of compression and central tension (CT). Where the stress in the substrate is generated by exchanging both potassium and sodium ions into the glass, and the article being measured is thicker than about 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 μm) the maximum central tension can be approximated by a product of a maximum compressive stress and a depth of compression divided by the difference between the thickness of the substrate and twice the depth of compression, wherein the compressive stress and depth of compression are measured by FSM.

The central tension region can comprise a maximum central tension (maximum CT). The measurement of a maximum CT value is an indicator of the total amount of stress stored in the strengthened articles. For this reason, the ability to achieve higher CT values correlates to the ability to achieve higher degrees of strengthening and increased performance. In aspects, the maximum CT of a glass-based article comprising the core glass composition and/or the cladding glass composition can be greater than or equal to 30 MPa, greater than or equal to 50 MPa, greater than or equal to 60 MPa, greater than or equal to 70 MPa, greater than or equal to 80 MPa, greater than or equal to 100 MPa, greater than or equal to 130 MPa, greater than or equal to 150 MPa, greater than or equal to 180 MPa, greater than or equal to 200 MPa, less than or equal to 300 MPa, less than or equal to 250 MPa, less than or equal to 230 MPa, less than or equal to 200 MPa, less than or equal to 180 MPa, less than or equal to 150 MPa, less than or equal to 130 MPa, less than or equal to 100 MPa, or less than or equal to 80 MPa. In aspects, the maximum CT of a glass-based article comprising the core glass composition and/or the cladding glass composition can be from greater than or equal to 30 MPa to less than or equal to 300 MPa, from greater than or equal to 50 MPa to less than or equal to 300 MPa, from greater than or equal to 60 MPa to less than or equal to 250 MPa, from greater than or equal to 80 MPa to less than or equal to 250 MPa, from greater than or equal to 100 MPa to less than or equal to 230 MPa, from greater than or equal to 130 MPa to less than or equal to 200 MPa, from greater than or equal to 150 MPa to less than or equal to 180 MPa. In aspects, the CT can be less than or equal to 200 MPa, for example, from greater than or equal to 50 MPa to less than or equal to 200 MPa, from greater than or equal to 60 MPa to less than or equal to 150 MPa, from greater than or equal to 70 MPa to less than or equal to 130 MPa, from greater than or equal to 80 MPa to less than or equal to 100 MPa, or any range or subrange therebetween. In preferred aspects, the maximum CT of the glass-based article comprising the core glass composition and/or the cladding glass composition can be from greater than or equal to 30 MPa to less than or equal to 300 MPa, from greater than or equal to 50 MPa to less than or equal to 230 MPa, or from greater than or equal to 70 MPa to less than or equal to 180 MPa.

### Cladding Glass Composition

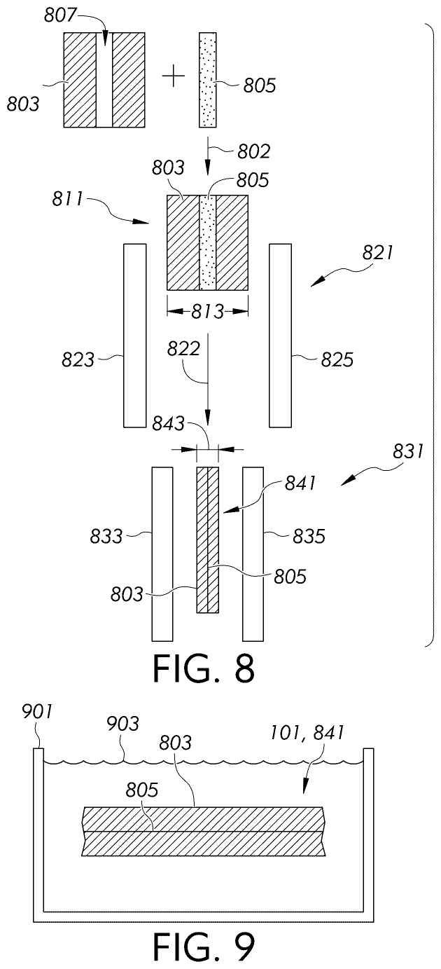

Embodiments of the present disclosure include a glass-based material that can have one or more of: from greater than or equal to 0.03 mol % to less than or equal to 5.0 mol % Fe₂O₃ (e.g., in combination with from greater than or equal to 4.5 mol % to less than or equal to 10 mol % Li₂O, and/or non-zero amounts of Li₂O and Na₂O); a refractive index less than or equal to 1.60; and/or a transmittance averaged over optical wavelength from 400 nm to 700 nm of less than or equal to 5% that can be used as a cladding material in a waveguide in accordance with aspects of the present disclosure (see cladding material 103 in FIG. 1). Consequently, this glass-based material will be referred to as the “cladding material” for clarity to distinguish it from other glass-based materials (e.g., core material) with the understanding that the “cladding material” is not limited to such applications (e.g., waveguides, laminates, or other composites). The cladding material 103 can form a glass-based substrate (e.g., preform 803) and/or glass-based article on its own, as shown in FIG. 8.

In aspects, the cladding composition comprises SiO₂ in an amount greater than or equal to 55 mol % (e.g., 55.0 mol %), greater than or equal to 57.0 mol %, greater than or equal to 58.0 mol %, greater than or equal to 58.5 mol %, greater than or equal to 59.0 mol %, greater than or equal to 59.5 mol %, greater than or equal to 60.0 mol %, greater than or equal to 61.0 mol %, greater than or equal to 62.0 mol %, greater than or equal to 63.0 mol %, greater than or equal to 64.0 mol %, less than or equal to 80 mol % (e.g., 80.0 mol %), less than or equal to 74 mol % (e.g., 74.0 mol %), less than or equal to 69.5 mol %, less than or equal to 69.0 mol %, less than or equal to 68.0 mol %, less than or equal to 67.0 mol %, less than or equal to 66.0 mol %, less than or equal to 65.0 mol %, less than or equal to 64.0 mol %, less than or equal to 63.0 mol %, less than or equal to 62.0 mol %, less than or equal to 61.0 mol %, or less than or equal to 60.0 mol %. In aspects, the cladding composition can comprise SiO₂ from greater than or equal to 55 mol % to less than or equal to 80.0 mol %, from greater than or equal to 55.0 mol % to less than or equal to 74.0 mol %, from greater than or equal to 57.0 mol % to less than or equal to 69.5 mol %, from greater than or equal to 58.0 mol % to less than or equal to 69.0 mol %, from greater than or equal to 58.5 mol % to less than or equal to 68.0 mol %, from greater than or equal to 59.0 mol % to less than or equal to 67.0 mol %, from greater than or equal to 59.5 mol % to less than or equal to 66.0 mol %, from greater than or equal to 60.0 mol % to less than or equal to 65.0 mol %, from greater than or equal to 61.0 mol % to less than or equal to 64.0 mol %, from greater than or equal to 62.0 mol % to less than or equal to 63.0 mol %, or any range or subrange therebetween. In preferred aspects, the cladding composition can comprise SiO₂ in an amount from greater than or equal to 55 mol % to less than or equal to 80 mol % (e.g., from greater than or equal to 55.0 mol % to less than or equal to 80.0 mol %), from greater than or equal to 58 mol % to less than or equal to 69.5 mol % (e.g., from greater than or equal to 58.0 to less than or equal to 69.5 mol %), or from greater than or equal to 59.0 mol % to less than or equal to 65.0 mol %.

In aspects, the cladding composition comprises Al₂O₃ in a concentration greater than or equal to 8.75 mol %, greater than or equal to 9.0 mol %, greater than or equal to 9.5 mol %, greater than or equal to 10 mol % (e.g., 10.0 mol %), greater than or equal to 10.5 mol %, greater than or equal to 11.0 mol %, greater than or equal to 11.5 mol %, greater than or equal to 12 mol % (e.g., 12.0 mol %), greater than or equal to 12.5 mol %, greater than or equal to 13.0 mol %, greater than or equal to 13.5 mol %, greater than or equal to 14.0 mol %, less than or equal to 18 mol % (e.g., 18.0 mol %), less than or equal to 17.5 mol %, less than or equal to 17.0 mol %, less than or equal to 16.5 mol %, less than or equal to 16.0 mol %, less than or equal to 15.5 mol %, less than or equal to 15.0 mol %, less than or equal to 14.5 mol %, less than or equal to 14.0 mol %, less than or equal to 13.5 mol %, less than or equal to 13.0 mol %, less than or equal to 12.5 mol %, less than or equal to 12.0 mol %, less than or equal to 11.5 mol %, less than or equal to 11.0 mol %, or less than or equal to 10.5 mol %. In aspects, the cladding composition can comprise an amount of Al₂O₃ from greater than or equal to 8.75 mol % to less than or equal to 18.0 mol %, from greater than or equal to 9.0 mol % to less than or equal to 17.5 mol %, from greater than or equal to 10.0 mol % to less than or equal to 17.0 mol %, from greater than or equal to 10.5 mol % to less than or equal to 16.5 mol %, from greater than or equal to 11.0 mol % to less than or equal to 16.0 mol %, from greater than or equal to 11.5 mol % to less than or equal to 15.5 mol %, from greater than or equal to 12.0 mol % to less than or equal to 15.0 mol %, from greater than or equal to 12.5 mol % to less than or equal to 14.5 mol %, from greater than or equal to 13.0 mol % to less than or equal to 14.0 mol %, from greater than or equal to 13.5 mol % to less than or equal to 14.0 mol %, or any range or subrange therebetween. In preferred aspects, the cladding composition can comprise Al₂O₃ in an amount from greater than or equal to 8.75 mol % to less than or equal to 18.0 mol %, from greater than or equal to 10.0 mol % to less than or equal to 17.5 mol %, or from greater than or equal to 11.5 mol % to less than or equal to 15.5 mol %.

In aspects, the cladding composition comprises Li₂O in an amount greater than or equal to 4.5 mol %, greater than or equal to 5.0 mol %, greater than or equal to 5.5 mol %, greater than or equal to 6.0 mol %, greater than or equal to 6.5 mol %, greater than or equal to 7.0 mol %, greater than or equal to 7.5 mol %, greater than or equal to 8.0 mol %, greater than or equal to 8.5 mol %, greater than or equal to 9.0 mol %, greater than or equal to 9.5 mol %, less than or equal to 10.0 mol %, less than or equal to 9.5 mol %, less than or equal to 9.0 mol %, less than or equal to 8.5 mol %, less than or equal to 8.0 mol %, less than or equal to 7.0 mol %, less than or equal to 6.5 mol %, less than or equal to 6.0 mol %, less than or equal to 5.5 mol %, or less than or equal to 5.0 mol %. In aspects, the cladding composition comprises an amount of Li₂O from greater than or equal to 4.5 mol % to less than or equal to 10.0 mol %, from greater than or equal to 5.0 mol % to less than or equal to 9.5 mol %, from greater than or equal to 5.5 mol % to less than or equal to 9.0 mol %, from greater than or equal to 6.0 mol % to less than or equal to 8.5 mol %, from greater than or equal to 6.5 mol % to less than or equal to 8.0 mol %, from greater than or equal to 7.0 mol % to less than or equal to 7.5 mol %, or any range or subrange therebetween. In preferred aspects, the cladding composition comprises Li₂O in an amount from greater than or equal to 4.5 mol % to less than or equal to 10.0 mol %, from greater than or equal to 5.0 mol % to less than or equal to 9.0 mol %, or from than or equal to 5.5 mol % to less than or equal to 8.5 mol %.

In aspects, the cladding composition comprises Na₂O in an amount greater than or equal to 2.0 mol %, greater than or equal to 2.5 mol %, greater than or equal to 3.0 mol %, greater than or equal to 3.5 mol %, greater than or equal to 4.0 mol %, greater than or equal to 4.5 mol %, greater than or equal to 5.0 mol %, greater than or equal to 5.5 mol %, greater than or equal to 6.0 mol %, greater than or equal to 6.5 mol %, greater than or equal to 7.0 mol %, greater than or equal to 7.5 mol %, greater than or equal to 8.0 mol %, less than or equal to 14.0 mol %, less than or equal to 13.0 mol %, less than or equal to 12.0 mol %, less than or equal to 11.0 mol %, less than or equal to 10.0 mol %, less than or equal to 9.5 mol %, less than or equal to 9.0 mol %, less than or equal to 8.5 mol %, less than or equal to 8.0 mol %, less than or equal to 7.5 mol %, less than or equal to 7.0 mol %, less than or equal to 6.5 mol %, less than or equal to 6.0 mol %, less than or equal to 5.5 mol %, less than or equal to 5.0 mol %, less than or equal to 4.5 mol %, or less than or equal to 4.0 mol %. In aspects, the cladding composition comprises an amount of Na₂O from greater than or equal to 2.0 mol % to less than or equal to 14.0 mol %, from greater than or equal to 2.5 mol % to less than or equal to 13.0 mol %, from greater than or equal to 3.0 mol % to less than or equal to 12.0 mol %, from greater than or equal to 3.5 mol % to less than or equal to 11.0 mol %, from greater than or equal to 4.0 mol % to less than or equal to 10.0 mol %, from greater than or equal to 4.5 mol % to less than or equal to 9.5 mol %, from greater than or equal to 5.0 mol % to less than or equal to 9.0 mol %, from greater than or equal to 5.5 mol % to less than or equal to 8.5 mol %, from greater than or equal to 6.0 mol % to less than or equal to 8.0 mol %, from greater than or equal to 6.5 mol % to less than or equal to 7.5 mol %, from greater than or equal to 7.0 mol % to less than or equal to 7.5 mol %. In preferred aspects, the cladding composition comprises Na₂O in an amount from greater than or equal to 2.0 mol % to less than or equal to 14.0 mol % Na₂O, greater than or equal to 4.0 mol % to less than or equal to 9.5 mol %, or from greater than or equal to 6.0 mol % to less than or equal to 9.0 mol %.

As discussed above, “R₂O” refers to a total amount of alkali metal oxides. “R₂O” can refer to a total amount of Li₂O, Na₂O, K₂O, Cs₂O, and Rb₂O. In aspects, the cladding composition can comprise an amount of K₂O within one or more of the ranges discussed above for K₂O in the core composition. In aspects, the cladding composition can be free of Cs₂O and/or Rb₂O. In aspects, an amount of R₂O in the cladding composition can be greater than or equal to 6.5 mol %, greater than or equal to 7.0 mol %, greater than or equal to 8.0 mol %, greater than or equal to 9.0 mol %, greater than or equal to 10.0 mol %, greater than or equal to 10.5 mol %, greater than or equal to 11.0 mol %, greater than or equal to 11.5 mol %, greater than or equal to 12.0 mol %, greater than or equal to 12.5 mol %, greater than or equal to 13.0 mol %, greater than or equal to 13.5 mol %, greater than or equal to 14.0 mol %, less than or equal to 24.0 mol %, less than or equal to 22.0 mol %, less than or equal to 20.0 mol %, less than or equal to 19.0 mol %, less than or equal to 18.0 mol %, less than or equal to 17.5 mol %, less than or equal to 17.0 mol %, less than or equal to 16.5 mol %, less than or equal to 16.0 mol %, less than or equal to 15.5 mol %, less than or equal to 15.0 mol %, less than or equal to 14.5 mol %, less than or equal to 14.0 mol %, less than or equal to 13.5 mol %, less than or equal to 13.0 mol %, less than or equal to 12.5 mol %, less than or equal to 12.0 mol %, less than or equal to 11.5 mol %, or less than or equal to 11.0 mol %. In aspects, an amount of R₂O in the cladding composition can be from greater than or equal to 6.5 mol % to less than or equal to 24.0 mol %, from greater than or equal to 7.0 mol % to less than or equal to 22.0 mol %, from greater than or equal to 7.5 mol % to less than or equal to 20.0 mol %, from greater than or equal to 8.0 mol % to less than or equal to 19.0 mol %, from greater than or equal to 8.5 mol % to less than or equal to 18.0 mol %, from greater than or equal to 9.0 mol % to less than or equal to 17.5 mol %, from greater than or equal to 9.5 mol % to less than or equal to 17.0 mol %, from greater than or equal to 10.0 mol % to less than or equal to 16.5 mol %, from greater than or equal to 10.5 mol % to less than or equal to 16.0 mol %, from greater than or equal to 11.0 mol % to less than or equal to 15.5 mol %, from greater than or equal to 11.5 mol % to less than or equal to 15.0 mol %, from greater than or equal to 12.0 mol % to less than or equal to 14.5 mol %, from greater than or equal to 12.5 mol % to less than or equal to 14.0 mol %, from greater than or equal to 13.0 mol % to less than or equal to 13.5 mol %, or any range or subrange therebetween. In preferred aspects, an amount of R₂O in the cladding composition can be greater than or equal to 6.5 mol % to less than or equal to 24.0 mol %, from greater than or equal to 10.0 mol % to less than or equal to 18.0 mol %, or from greater than or equal to 11.0 mol % to less than or equal to 17.0 mol %.

As discussed above, “RO” refers to a total amount of alkaline earth oxides. “RO” can refer to a total amount of MgO, CaO, SrO, and BaO. In aspects, the clad composition can be free of CaO, SrO, and/or BaO. In aspects, the clad composition can be free of ZnO. In aspects, the cladding composition can comprise MgO in an amount within one or more of the ranges discussed above for MgO in the core composition. In aspects, the cladding composition can comprise RO in an amount within one or more of the ranges discussed above for MgO and/or RO in the core composition. In aspects, an amount of RO in the cladding composition can be from greater than or equal to 0.0 mol % to less than or equal to 4.0 mol %, from greater than or equal to 0.2 mol % to less than or equal to 3.0 mol %, from greater than or equal to 0.5 mol % to less than or equal to 2.5 mol %, from greater than or equal to 1.0 mol % to less than or equal to 2.0 mol %, or any range or subrange therebetween.

In aspects, the cladding composition can comprise B₂O₃ in an amount greater than or equal to 0.5 mol %, greater than or equal to 1.0 mol %, greater than or equal to 1.5 mol %, greater than or equal to 2.0 mol %, greater than or equal to 2.5 mol %, greater than or equal to 3.0 mol %, greater than or equal to 3.5 mol %, greater than or equal to 4.0 mol %, greater than or equal to 4.5 mol %, greater than or equal to 5.0 mol %, greater than or equal to 5.5 mol %, greater than or equal to 6.0 mol %, greater than or equal to 6.5 mol %, greater than or equal to 7.0 mol %, greater than or equal to 7.5 mol %, greater than or equal to 8.0 mol %, less than or equal to 15.0 mol %, less than or equal to 14.0 mol % or less, less than or equal to 13.0 mol %, less than or equal to 12.0 mol %, less than or equal to 11.0 mol %, less than or equal to 10.0 mol %, less than or equal to 9.5 mol %, less than or equal to 9.0 mol %, less than or equal to 8.5 mol %, less than or equal to 8.0 mol %, less than or equal to 7.5 mol %, less than or equal to 7.0 mol %, less than or equal to 6.5 mol %, less than or equal to 6.0 mol %, less than or equal to 5.0 mol %, less than or equal to 4.0 mol %, or less than or equal to 3.0 mol %. In aspects, the cladding composition can comprise an amount of B₂O₃ from greater than or equal to 0.5 mol % to less than or equal to 15.0 mol %, from greater than or equal to 1.0 mol % to less than or equal to 14.0 mol %, from greater than or equal to 1.5 mol % to less than or equal to 13.0 mol %, from greater than or equal to 2.0 mol % to less than or equal to 12.0 mol %, from greater than or equal to 2.5 mol % to less than or equal to 11.0 mol %, from greater than or equal to 3.0 mol % to less than or equal to 10.0 mol %, from greater than or equal to 3.5 mol % to less than or equal to 9.5 mol %, from greater than or equal to 4.0 mol % to less than or equal to 9.0 mol %, from greater than or equal to 4.5 mol % to less than or equal to 8.5 mol %, from greater than or equal to 5.0 mol % to less than or equal to 8.0 mol %, from greater than or equal to 5.5 mol % to less than or equal to 7.5 mol %, from greater than or equal to 6.0 mol % to less than or equal to 7.0 mol %, from greater than or equal to 6.5 mol % to less than or equal to 7.0 mol %, or any range or subrange therebetween. In preferred aspects, the cladding composition can B₂O₃ in an amount from greater than or equal to 0.5 mol % to less than or equal to 15.0 mol %, from greater than or equal to 2.5 mol % to less than or equal to 9.5 mol %, or from greater than or equal to 5.5 mol % to less than or equal to 8.5 mol %.

In aspects, the cladding composition can comprise P₂O₅ within one or more of the ranges discussed above for K₂O and/or P₂O₅ in the core composition. In aspects, an amount of ZrO₂ in the cladding composition can be within one or more of the ranges discussed above for K₂O and/or ZrO₂ in the core composition. Alternatively, in aspects, the glass-based composition may be free of ZrO₂. In aspects, the cladding composition can comprise TiO₂ within one or more of the ranges discussed above for K₂O in the core composition. Alternatively, in aspects, the cladding composition can be free of TiO₂. In aspects, the cladding composition can be free of Nb₂O₅.

As used herein, “colorant” refers to one or more of Ag₂O, CuO, WO₃, NaF, Bi₂O₃, Fe₂O₃, MnO₂, Co₃O₄, and/or Cr₂O₃. In aspects, the cladding composition can comprise one or more colorant (excluding Fe₂O₃ discussed separately above) in an amount greater than or equal to 0.00 mol %, greater than or equal to 0.01 mol % or more, greater than or equal to 0.02 mol % or more, greater than or equal to 0.04 mol %, greater than or equal to 0.06 mol %, greater or equal to 0.08 mol %, greater than or equal to 0.10 mol %, greater than or equal to 0.20 mol %, greater than or equal to 0.5 mol %, greater than or equal to 0.7 mol %, greater than or equal to 1.0 mol %, less than or equal to 2.0 mol %, less than or equal to 1.5 mol %, less than or equal to 1.0 mol %, less than or equal to 0.5 mol %, less than or equal to 0.2 mol %, less than or equal to 0.15 mol %, less than or equal to 0.13 mol %, less than or equal to 0.09 mol %, less than or equal to 0.07 mol %, less than or equal to 0.05 mol %, or less than or equal to 0.03 mol %. In aspects, the cladding composition can comprise one or more colorant (excluding Fe₂O₃ discussed separately above) in an amount of less than 0.20 mol %, for example, from greater than or equal to 0.00 mol % to less than or equal to 0.15 mol %, from greater than or equal to 0.01 mol % to less than or equal to 0.13 mol %, from greater than or equal to 0.02 mol % to less than or equal to 0.11 mol %, from greater than or equal to 0.04 mol % to less than or equal to 0.09 mol %, from greater than or equal to 0.06 mol % to less than or equal to 0.07 mol %, or any range or subrange therebetween. aspects, the cladding composition can comprise one or more colorant (excluding Fe₂O₃ discussed separately above) in an amount greater than or equal to 0.20 mol %, for example, from greater than or equal to 0.20 mol % to less than or equal to 2.0 mol %, from greater than or equal to 0.5 mol % to less than or equal to 1.5 mol %, from greater than or equal to 0.7 mol % to less than or equal to 1.0 mol %, or any range or subrange therebetween. In aspects, a total amount of colorants (excluding Fe₂O₃ discussed separately above) in the cladding composition can be within one or more of the ranges discussed above in this paragraph.

In aspects, SnO₂ may be present in the cladding composition in an amount less than or equal to 0.25 mol %, such as from greater than or equal to 0.0 mol % to less than or equal to 0.25 mol %, from greater than or equal to 0.05 mol % to less than or equal to 0.20 mol %, from greater than or equal to 0.10 mol % to less than or equal to 0.15 mol %, or any range or subrange therebetween. In some aspects, the glass-based composition may be free of SnO₂. In aspects, the cladding composition may be free of one or more of arsenic, antimony, cadmium, mercury, selenium, and/or lead.

In aspects, the cladding composition may be formed primarily from (i.e., containing 0.5 mol % or more of each) SiO₂, Al₂O₃, Li₂O, Na₂O, B₂O₃, and MgO. In further aspects, cladding composition can comprise Fe₂O₃ and/or TiO₂. In further aspects, the cladding composition can optionally include one or more colorant and/or SnO₂. In aspects, the cladding composition can be free of components other than SiO₂, Al₂O₃, Li₂O, Na₂O, B₂O₃, MgO, K₂O, SnO₂, and one or more colorant (e.g., Fe₂O₃). In aspects, the cladding composition may be free of at least one of HfO₂, La₂O₃, and Y₂O₃. While these components may increase the fracture toughness of the glass-based when included, there are cost and supply constraints that make using these components undesirable for commercial purposes.

As discussed above, refractive index is measured in accordance with ASTM E1967-19, where the first wavelength comprises 589 nm. The “clad refractive index” references to the refractive index of a glass-based material formed from the cladding composition (cladding material). In aspects, the clad refractive index (of the cladding material) can be greater than or equal to 1.40, greater than or equal to 1.45, greater than or equal to 1.47, greater than or equal to 1.49, greater than or equal to 1.50, greater than or equal to 1.51, greater than or equal to 1.52, greater than or equal to 1.53, greater than or equal to 1.54, greater than or equal to 1.55, greater than or equal to 1.56, greater than or equal to 1.57, less than or equal to 1.60, less than or equal to 1.59, less than or equal to 1.58, less than or equal to 1.57, less than or equal to 1.56, less than or equal to 1.55, less than or equal to 1.54, less than or equal to 1.53, less than or equal to 1.52, less than or equal 1.51, less than or equal to 1.50, or less than or equal to 1.49. In aspects, the clad refractive index can be from greater than or equal to 1.40 to less than or equal to 1.60, from greater than or equal to 1.45 to less than or equal to 1.59, from greater than or equal to 1.47 to less than or equal to 1.58, from greater than or equal to 1.49 to less than or equal to 1.57, from greater than or equal to 1.50 to less than or equal to 1.56, from greater than or equal to 1.51 to less than or equal to 1.55, from greater than or equal to 1.52 to less than or equal to 1.54, from greater than or equal to 1.53 to less than or equal to 1.54, or any range or subrange therebetween. In preferred aspects, the clad refractive index can be from greater than or equal to 1.40 to less than or equal to 1.50, from greater than or equal to 1.47 to less than or equal to 1.58, or from greater than or equal to 1.52 to less than or equal to 1.55. In aspects, the CTE of the cladding material can be within one or more of the ranges discussed above for the CTE of the core material.

As discussed above, density of glass-based materials is determined using the buoyancy method of ASTM C693-93(2013). In aspects, a density of the cladding material can be greater than or equal to 2.0 g/cm³, greater than or equal to 2.1 g/cm³, greater than or equal to 2.2 g/cm³, greater than or equal to 2.3 g/cm³, greater than or equal to 2.4 g/cm³, less than or equal to 2.5 g/cm³, greater than or equal to 2.6 g/cm³, less than or equal to 3.0 g/cm³, less than or equal to 2.9 g/cm³, less than or equal to 2.8 g/cm³, less than or equal to 2.7 g/cm³, less than or equal to 2.6 g/cm³, less than or equal to 2.5 g/cm³, or less than or equal to 2.4 g/cm³. In aspects, a density of the cladding material can be from greater than or equal to 2.0 g/cm³ to less than or equal to 3.0 g/cm³, from greater than or equal to 2.1 g/cm³ to less than or equal to 2.9 g/cm³, from greater than or equal to 2.2 g/cm³ to less than or equal to 2.8 g/cm³, from greater than or equal to 2.3 g/cm³ to less than or equal to 2.7 g/cm³, from greater than or equal to 2.3 g/cm³ to less than or equal to 2.6 g/cm³, from greater than or equal to 2.4 g/cm³ to less than or equal to 2.5 g/cm³, or any range or subrange therebetween. In preferred aspects, the density of the clad material can be from greater than or equal to 2.0 g/cm³ to less than or equal to 3.0 g/cm³, from greater than or equal to 2.2 g/cm³ to less than or equal to 2.8 g/cm³, or from greater than or equal to 2.3 g/cm³ to less than or equal to 2.6 g/cm³.

As discussed above, “average transmittance” is determined over the wavelength range of 400 nm to 700 nm and is calculated by measuring the transmittance through a thickness of sample with a thickness of 0.7 mm for whole number wavelengths from 400 nm to 700 nm and averaging the measurements. Unless otherwise indicated, “average transmittance” refers to “internal transmittance.” In aspects, an average transmittance (for optical wavelengths from 400 nm to 700 nm) for a 0.7 mm thick sample of a glass-based material comprising the cladding composition can be greater than or equal to 0.0%, greater than or equal to 0.01%, greater than or equal to 0.05%, greater than or equal to 0.1%, greater than or equal to 0.2%, greater than or equal to 0.5%, less than or equal to 5.0%, less than or equal to 3.0%, less than or equal to 2.0%, less than or equal to 1.0%, less than or equal to 0.5%, less than or equal to 0.2%, or less than or equal to 0.1%. In aspects, an average transmittance (for optical wavelengths from 400 nm to 700 nm) for a 0.7 mm thick sample of a glass-based material comprising the cladding composition can be from greater than or equal to 0.0% to less than or equal to 5.0%, from greater than or equal to 0.01% to less than or equal to 3.0%, from greater than or equal to 0.05% to less than or equal to 2.0%, from greater than or equal to 0.1% to less than or equal to 1.0%, from greater than or equal to 0.2% to less than or equal to 0.5%, or any range or subrange therebetween. In preferred aspects, an average transmittance (for optical wavelengths from 400 nm to 700 nm) for a 0.7 mm thick sample of a glass-based material comprising the cladding composition can be from greater than or equal to 0.0% to less than or equal to 5%, from greater than or equal to 0.01% to less than or equal to 0.5%, or from greater than or equal to 0.05% to less than or equal to 0.1%. Providing a low transmittance (e.g., 5% or less, less than 0.5%, less than 0.2%, less than 0.1%) of a cladding material can inhibit the transmission of signals therethrough, which can function to prevent cross-talk between signals in adjacent sections of core material separated by the cladding material (e.g., in a waveguide).

In aspects, the cladding composition can exhibit a CIE L* value greater than or equal to 0, greater than or equal to 1, greater than or equal to 5, greater than or equal to 10, greater than or equal to 20, greater than or equal to 30, less than or equal to 50, less than or equal to 40, less than or equal to 30, less than or equal 20, less than or equal to 10, or less than or equal to 5 (e.g., from 0 to 50, from 1 to 40, from 5 to 30, from 10 to 20). In preferred aspects, the CIE L* value of the core composition can be from greater than or equal to 0 to less than or equal to 50, from greater than or equal to 1 to less than or equal to 20, or from greater than or equal to 5 to less than or equal to 10.

In aspects, the cladding composition can exhibit a CIE a* value greater than or equal to −0.5, greater than or equal to −0.3, greater than or equal to −0.2, greater than or equal to −0.1, greater than or equal to 0.0, greater than or equal to 0.1, less than or equal to 0.5, less than or equal to 0.3, less than or equal to 0.2, less than or equal to 0.1, less than or equal 0.0, or less than or equal to −0.1. In aspects, the cladding composition can exhibit a CIE a* value from greater than or equal to −0.5 to less than or equal to 0.5, from greater than or equal to −0.3 to less than or equal to 0.3, from greater than or equal to −0.2 to less than or equal to 0.2, from greater than or equal to −0.1 to less than or equal to 0.1, from greater than or equal to 0.0 to less than or equal to 0.1. In preferred aspects, the cladding composition can exhibit a CIE a* value from greater than or equal to −0.5 to less than or equal to 0.5, from greater than or equal to −0.2 to less than or equal to 0.3, or from greater than or equal to −0.1 to less than or equal to 0.2.

In aspects, the cladding composition can exhibit a CIE b* value greater than or equal to −0.5, greater than or equal to −0.3, greater than or equal to −0.2, greater than or equal to −0.1, greater than or equal to 0.0, greater than or equal to 0.1, less than or equal to 0.5, less than or equal to 0.3, less than or equal to 0.2, less than or equal to 0.1, less than or equal 0.0, or less than or equal to −0.1. In aspects, the cladding composition can exhibit a CIE b* value from greater than or equal to −0.5 to less than or equal to 0.5, from greater than or equal to −0.3 to less than or equal to 0.3, from greater than or equal to −0.2 to less than or equal to 0.2, from greater than or equal to −0.1 to less than or equal to 0.1, from greater than or equal to 0.0 to less than or equal to 0.1. In preferred aspects, the cladding composition can exhibit a CIE b* value from greater than or equal to −0.5 to less than or equal to 0.5, from greater than or equal to −0.3 to less than or equal to 0.2, or from greater than or equal to −0.2 to less than or equal to 0.1. In aspects, a sum of the CIE a* and CIE b* values (i.e., a*+b*) can be within one or more of the ranges discussed above in this paragraph. In aspects, a sum of the absolute values of the CIE a* and CIE b* values (i.e., |a*|+|b*|) can be within one or more of the ranges discussed above in this paragraph (e.g., from greater than or equal to 0.0 to less than or equal to 0.5, from greater than or equal to 0.1 to less than or equal to 0.3, from greater than or equal to 0.2 to less than or equal to 0.3, or any range or subrange therebetween).

As mentioned above, in aspects, the glass-based material comprising the cladding composition (e.g., cladding material) described herein can be strengthened (e.g., chemically strengthened). As discussed above, the cladding material can have a compressive stress region have compressive stress extending from a major surface of the glass-based material to a depth of compression, and/or the glass-based material can have a central tension region under tensile stress (e.g., central tension (CT)), for example, with the compressive stress region positioned between the major surface and the central tension region. In aspects, the maximum CT of a glass-based article comprising the cladding glass composition can be within one or more of the corresponding ranges for the maximum CT discussed above for the core composition.

### Waveguide

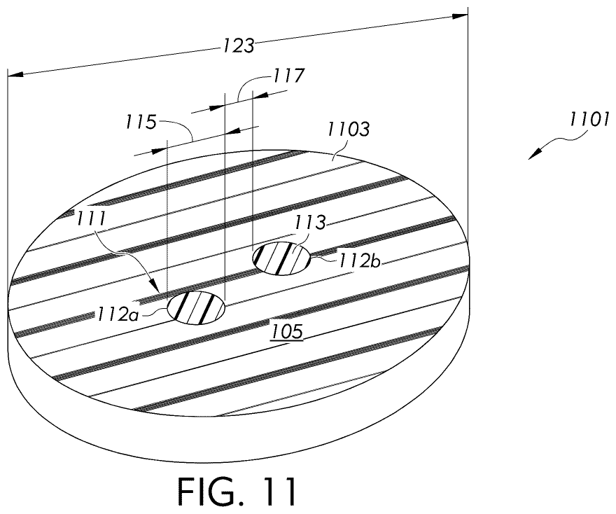

Embodiments of the disclosure also include a composite article (e.g., waveguide, laminate) comprising a core material that is a glass-based material having a core composition within one or more of the aspects (e.g., corresponding ranges) discussed above for the core composition. FIGS. 1 and 11 show exemplary aspects of composite articles, namely, waveguides 101 and 1101. As shown, a core material 113 is surrounded (e.g., circumferentially surrounded) by a cladding material 103 or 1103. The cladding material 103 or 1103 can be attached to (e.g., directly contact, bonded to, and/or fused to) the core material. The core material 113 comprises a glass-based material. In aspects, the core material 113 can comprise the core composition (e.g., within one or more of the aspects discussed above for the composition and properties of the core composition and associated glass-based material having the core composition). In further aspects, as shown in FIGS. 1, 2, and 11, the core material 113 can be formed as a rod, for example, having a high aspect ratio (e.g., greater than 10, greater than 100) of a length of the rod to a cross-sectional dimension of the rod (see FIG. 2), although a length of the rod may be shortened depending on the application (e.g., in other aspects) such that the aspect ratio is not necessarily limiting for the term “rod”. In even further aspects, as shown, a cross-sectional shape of the core material 113 (e.g., rod 112a or 112b) can be substantially elliptical, although circular shapes, polygonal shapes (e.g., quadrilateral, hexagonal, octagonal), or complex shapes can be provided in other aspects. In aspects, a portion or a major surface (e.g., corresponding to a location of one or more structures of the core material, or an entire major surface) can have an anti-reflective coating to reduce Fresnel reflections (or other reflection) that could otherwise reduce amount of light coupled into the core material.

Throughout the disclosure, a “maximum cross-sectional dimension” of a structure of the core material refers to a maximum length of a straight line segment that is from a first endpoint in the structure to a second endpoint that is in portion of the structure that is contiguous with the portion of the structure including the first endpoint. “Contiguous” means that the two portions of a structure both comprising the core material is connected by a path (not necessarily a straight path) entirely through the core material. For example, with reference to FIG. 1, the maximum cross-sectional dimension 115 of the rod 112a made of the core material 113 refers to the maximum distance (i.e. length) of a straight line segment between end points that are entirely within the rod, where the end points are contiguous through the core material of the rod. In further aspects, as shown, the core material can occupy a solid section of the cross-section of the waveguide (e.g., a rounded, convex shape with only core material within the rounded, convex shape). For example, the straight line segment for the maximum cross-sectional dimension can be entirely within the core material (rod 112a) (i.e., not extending into or through the cladding material 103—other than any incidental amount at the endpoints of the line segment that can be at an interface between the core material 113 and the cladding material 103) that is within the cross-section shown (e.g., end view) of the waveguide 101. When the cross-sectional shape of the rod 112a is circular, the maximum cross-sectional dimension 115 corresponds to a diameter of a circle defined by an outer periphery of the circular cross-section. As used herein, the “cross-sectional shape” and “cross-sectional dimension” refers to a cross-section taken either at an end (i.e., major surface 105) of the waveguide 101 or parallel to the end of the waveguide 101 where the core material is visible and surrounded (e.g., circumferentially surround) by the cladding material 103. Alternatively, although not shown, the cross-sectional shape of the core material can comprise an annular shape (e.g., ring), a crescent shape, or other non-convex shape. Also, the cross-sectional shape of the core material can comprise a polygonal shape (e.g., quadrilateral, hexagonal, octagonal), circular, elliptical, or a complex shape. In even further aspects, the maximum cross-sectional dimension 115 of a section (e.g., rod 112a) of the core material 113 can be 10 μm or more, 25 μm or more, 50 μm or more, 100 μm or more, 200 μm or more, 500 μm or more, 1.0 mm or more, 1.5 mm or more, 2.0 mm or more, 3.0 mm or more, 5.0 mm or more, 10 mm, 20 mm or less, 15 mm or less, 10 mm or less, 7 mm or less, 5.0 mm or less, 3.0 mm or less, 2.0 mm or less, 1.0 mm or less, 500 μm or less, 200 μm or less, or 100 μm or less. In even further aspects, the maximum cross-sectional dimension 115 of a section (e.g., rod 112a) of the core material 113 can be 1.0 mm or more, for example, from 1.0 mm to 20 mm, from 1.5 mm to 15 mm, from 1.5 mm to 10 mm, from 2.0 mm to 7 mm, from 3.0 mm to 5.0 mm, or any range or subrange therebetween. In preferred aspects, the maximum cross-sectional dimension 115 of a section (e.g., rod 112a) of the core material 113 can be from 1.0 mm to 20 mm, from 1.5 mm to 10 mm, or from 2.0 mm to 5.0 mm. Alternatively, in even further aspects, the maximum cross-sectional dimension 115 of a section (e.g., rod 112a) of the core material 113 can be 1.0 mm or less, for example, from 10 μm to 1.0 mm, from 25 μm to 500 μm, from 50 μm to 200 μm, from 100 μm to 200 μm, or any range or subrange therebetween. As discussed below, methods of forming the waveguide 101 or 1101 can redraw an assembly formed using a glass-based substrate 201 (e.g., initial rod) formed from the core composition that has a larger maximum cross-sectional dimension 215 (e.g., along a major surface 205 or parallel to the major surface 205 of the glass-based substrate 201 shown in FIG. 2) than the corresponding dimension in the resulting waveguide.

In further aspects, as shown in FIGS. 1 and 11, the waveguide 101 and 1101 can comprise one or more sections (e.g., plurality of rods 111, rods 112a-112b) of the core material 113 separated by (and surrounded by) the cladding material 103 or 1103. For example, as shown, the waveguide 101 and 1101 is shown with two sections of the core material, namely, the rods 112a and 112b. The rods 112a and 112b can extend parallel to each other (e.g., along a longitudinal axis, for the entire thickness of the waveguide perpendicular to the major surface 105). As used herein, a “minimum spacing” or “minimum distance” between adjacent pairs of section or rods of the core material refers to the shortest line segment extending between an outer periphery of one section and any outer periphery of the adjacent section of the core material. For example, as shown in FIG. 1, the minimum distance 117 between an adjacent pair of sections (e.g., rods 112a-112b of the one or more—plurality of rods 111) of the core material 113 is the length of the shortest line segment extending from an outer periphery of the first section (e.g., interface of the first rod 112a and the cladding material 103) and an outer periphery of the second section (in the adjacent pair of sections—e.g., interface of the second rod 112b and the cladding material 103). In even further aspects, the minimum distance 117 between an adjacent pair of sections (e.g., rods 112a-112b of the one or more—plurality of rods 111) of the core material 113 can be 10 μm or more, 25 μm or more, 50 μm or more, 100 μm or more, 200 μm or more, 500 μm or more, 1.0 mm or more, 1.5 mm or more, 2.0 mm or more, 3.0 mm or more, 5.0 mm or more, 10 mm, 20 mm or less, 15 mm or less, 10 mm or less, 8 mm or less, 5.0 mm or less, 3.0 mm or less, 2.0 mm or less, 1.0 mm or less, 500 μm or less, 200 μm or less, or 100 μm or less. In even further aspects, the minimum distance 117 between an adjacent pair of sections (e.g., rods 112a-112b of the one or more—plurality of rods 111) of the core material 113 can be 1.0 mm or more, for example, from 1.0 mm to 20 mm, from 1.5 mm to 15 mm, from 1.5 mm to 10 mm, from 2.0 mm to 8 mm, from 3.0 mm to 5.0 mm, or any range or subrange therebetween. Providing sufficient distance (e.g., 1.0 mm or more, from 1.0 mm to 20 mm, from 1.5 mm to 15 mm) between adjacent sections of the core material, cross-talk between signals traveling through the corresponding sections can be minimized, especially when the cladding material has low average transmittance (e.g., 5.0% or less, 0.5% or less). Additionally or alternatively, providing sufficient distance (e.g., 1.0 mm or more, from 1.0 mm to 20 mm, from 1.5 mm to 15 mm) between adjacent sections of the core material can enable the different core sections to convey significantly different information that may be collected through an end (e.g., major surface of the waveguide). Alternatively, in even further aspects, the minimum distance 117 between an adjacent pair of sections (e.g., rods 112a-112b of the one or more—plurality of rods 111) of the core material 113 can be 1.0 mm or less, for example, from 10 μm to 1.0 mm, from 25 μm to 500 μm, from 50 μm to 200 μm, from 100 μm to 200 μm, or any range or subrange therebetween.

In aspects, as shown in FIGS. 1 and 11, a cross-sectional shape can be oblong (e.g., ovular), although other cross-sectional shapes including polygonal (e.g., quadrilateral, hexagonal, octagonal), circular, or complex shapes are possible in other aspects. In further aspects, a maximum cross-sectional dimension 123 (see FIGS. 1 and 11—e.g., diameter, outer diameter of an outer periphery thereof) of the waveguide 101 or 1101 can be 10.0 mm or more, 15.0 mm or more, 20.0 mm or more, 25 mm or more, 30 mm or more, 40.0 mm or more, 50.0 mm or more, 100 mm or less, 80 mm or less, 60 mm or less, 40 mm or less, 30 mm or less, or 20 mm or less. In further aspects, a maximum cross-sectional dimension 123 (see FIGS. 1 and 11) of the waveguide 101 or 1101 can be from 10.0 mm to 100 mm, from 15.0 mm to 80 mm, from 20.0 mm to 60 mm, from 25 mm to 40 mm, from 30 mm to 40 mm, or any range or subrange therebetween.

In further aspects, as shown in FIG. 1, the cladding material 103 can be a glass-based material. In even further aspects, the cladding material 103 can comprise the cladding composition (e.g., within one or more of the aspects discussed above for the composition and properties of the cladding composition and associated glass-based material having the cladding composition). In even further aspects, the cladding material 103 can be fused to the core material 113 (e.g., one or more rods 112a-112b, plurality of rods 111). For example, the glass-based material of the cladding material 103 can be fused to the core material 113 by heating the materials while they are in contact with one another and applying a force to consolidate the materials, for example, as occurs in a redrawing process.

In further aspects, as shown in FIG. 1, the cladding material 103 can be a glass-based material. In even further aspects, the cladding material 103 can comprise the cladding composition (e.g., within one or more of the aspects discussed above for the composition and properties of the cladding composition and associated glass-based material having the cladding composition). In even further aspects, the cladding material 103 can be fused to the core material 113 (e.g., one or more rods 112a-112b, plurality of rods 111). For example, the glass-based material of the cladding material 103 can be fused to the core material 113 by heating the materials while they are in contact with one another and applying a force to consolidate the materials, for example, as occurs in a redrawing process. For example, forces can include one or more of a vacuum, applied pressure (e.g., air pressure), and/or surface tension.

In further aspects, as shown in FIG. 11, the cladding material 1103 can be a polymer-containing material. In even further aspects, the cladding material 1103 can be bonded to the core material 113 (e.g., one or more rods 112a-112b, plurality of rods 111). For example, the polymer-containing material can be cured or otherwise formed (e.g., molded) around and in contact with the core material, where the polymer-containing material of the cladding material 1103 can be in intimate contact (e.g., mechanically bonding by filling surface irregularities in the core material) and/or chemically bonding (e.g., forming hydrogen bonds, silane coupling) with the core material 113. In even further aspects, the polymer-containing portion of the cladding material 1103 can comprise an epoxy, a silicone, an acrylic, or derivatives or copolymers thereof. As used herein, “thermoplastic” means a polymeric material that can be reformed after an initial curing (e.g., polymerization) reaction by heating the material. A thermoplastic polymer is to be contrasted with a thermoset polymer, which cannot be reformed after an initial curing reaction. In even further aspects, the polymer-containing polymer can be a thermoplastic polymer (e.g., an acrylic polymer). Aspects of thermoplastic polymers include one or more of acrylic resins (e.g., polyacrylic acids or ester derivatives, polymethylmethacrylate (PMMA)), polyamides (e.g., Nylons, polyamide-6, polyamide-12, polyamide6.6, polyarylamides), thermoplastic polyurethanes (TPUs), polyolefins, styrenic resins (e.g., polystyrene (PS)), polycarbonate (PC), polyureas, polyimides (PIs) (e.g., polyetherimide (PEI)), polyesters (e.g., polybutylene terephthalate (PBT), polyethylene terephthalate (PET), polylactic acid (PLA)), fluoropolymers, chloroploymers (e.g., polyvinyl chloride (PVC)), silicone resins, polybenzimidazoles (PBI), polyoxymethylene (POM), polypropylene oxide, polyether ether ketone (PEEK), polyphenylenes (e.g., polyphenylene oxides (PPO), polyphenylene sulfides (PPS)), benzoxazines hybridized with epoxy and phenolic resins, vinyl ester resins, and blends or copolymers including terpolymers etc. thereof. Alternatively, the polymer-containing portion of the cladding material 1103 can comprise a thermoset polymer (e.g. epoxy). In even further aspects, a refractive index of the polymer-containing portion of the cladding material 1103 can be within one or more of the ranges discussed above with reference to the cladding composition. In even further aspects, the polymer-containing material can contain nanoparticles (e.g., silica, SiC), which can provide enhanced scratch-resistance, impact-resistance, and/or fracture toughness to the polymer-containing material and/or waveguide.

In even further aspects, the polymer-containing material can be filled with nanoparticles (e.g., silica nanoparticles, carbon nanotubes, SiC nanoparticles), glass-based particles, and/or ceramic-based particles. In even further aspects, the polymer-containing material of the cladding material 1103 can be antimicrobial and/or contain (e.g., be filled with or otherwise form a composite with) a copper-containing material (e.g., copper-containing glass-based material). As used herein, the term “antimicrobial” means a material or surface that kills or inhibits the growth of microbes including bacteria, viruses, mildew, mold, algae, and/or fungi. The term antimicrobial does not require the material or surface to kill or inhibit the growth of all of such families of microbes or all species of microbes within such families, but that the material or surface kills or inhibits the growth of one or more species of microbes from one or more of such families.

As used herein, the term “logarithmic reduction” means the negative value of log(Ca/Co), where Ca is the colony form unit (CFU) member of the antimicrobial surface and Co is the CFU number of the control surface that is not an antimicrobial surface. As an example, a 3 logarithmic reduction equals about 99.9% of the microbes killed and a 5 logarithmic reduction equals about 99.999% of microbes killed. The logarithmic reduction can be measured according to the procedures outlined in the U.S. Environmental Protection Agency Office of Pesticide Programs Protocol for the Evaluation of Bactericidal Activity of Hard, Non-porous Copper Containing Surface Products, dated 29 Jan. 2016. As used herein, the “EPA Test” refers to the method for evaluating the logarithmic reduction of a material described herein under one or more of the U.S. Environmental Protection Agency “Test Method of Efficacy of Copper Alloy as a Sanitizer” (2009) (also referred to herein as the “EPA Test”). For bacteria, the logarithmic reduction can be evaluated using the EPA Test or the Modified Japanese Industrial Standard (JIS) Z 2801 Test for Bacterial and/or the Modified JIS Z 2801 Test for Viruses, for example, measured for a period of one month or more, for a period of three months or more, for a period of six months or more, or for a period of one year or more, wherein the corresponding period may commence at or after the antimicrobial polymer composition or antimicrobial polymer article is manufactured. For viruses, the logarithmic reduction can be evaluated using the Modified JIS Z 2801 (2000) Test for Viruses described in International Patent Application Pub. No. 2021/055300 A1, COLOR STABILIZATION OF BIOCIDAL COATINGS, which is incorporated by reference herein in its entirety. In still further aspects, the polymer-containing material of the cladding material 1103 can be antimicrobial and exhibit a logarithmic reduction of 3.5 or more, 4.0 or more, 4.5 or more, 5.0 or more, 5.5 or more, 6.0 or more, or 6.5 or more. In still further aspects, the polymer-containing material (e.g., antimicrobial, copper-containing material) can exhibit at least a 4 logarithmic reduction, a 5 logarithmic reduction, or even a 6 logarithmic reduction in the concentration of at least one of Staphylococcus aureus, Enterobacter aerogenes, Pseudomonas aeruginosa bacteria, Methicillin-Resistant Staphylococcus aureus, and E. coli under the EPA test, or a 4 logarithmic reduction or greater (e.g., 5 logarithmic reduction or greater) under JIS Z 2801 (2000) testing conditions or under the Modified JIS Z 2801 Test for Bacteria. In still further aspects, the polymer-containing material (e.g., antimicrobial, copper-containing material) can exhibit a 2 logarithmic reduction or greater, a 3 logarithmic reduction or greater, a 4 logarithmic reduction or greater, or a 5 logarithmic reduction or greater in Murine norovirus under a Modified JIS Z 2801 for Viruses test.

In even further aspects, the copper-containing material in the polymer-containing material (or composited thereof) can be configured to provide a plurality of Cu¹⁺ ions. The copper-containing material comprises copper as one or more of Cu⁰, Cu¹⁺, Cu²⁺, or combinations thereof. In still further aspects, a percentage of all copper in the copper-containing material, 50% or more, about 60% or more, about 70% or more, about 80% or more, about 85% or more, or about 90% or more. The relative amounts of Cu¹⁺, Cu²⁺, and Cu⁰ may be determined using X-ray photoluminescence spectroscopy (XPS). As discussed below, an amount of Cu²⁺ may be reduced such that the copper-containing material is free of Cu²⁺. The copper of the copper-containing material may be non-complexed or may have a ligand bonded thereto to form a complex. The copper-containing material may include copper-containing glass, copper oxide, copper metal, and/or copper salt (e.g., copper halide, copper acetate, copper sulfate, or a combination thereof). In still further aspects, the copper-containing material comprises cuprous oxide and/or glass-ceramic particles. As used herein, “cuprous oxide” means an oxide containing Cu¹⁺ ions, which can be crystalline as cuprite (Cu₂O). In further aspects, the copper-containing material can consist of cuprous oxide. In aspects, the copper-containing material can comprise cuprite crystals, which can have an average major dimension of about 5 micrometers (μm) or less, for example, from about 0.1 μm to about 5 μm, from about 0.2 μm to about 4 μm, from about 0.3 μm to about 3 μm, from about 0.5 to about 2 μm, from about 1 μm to about 1.5 μm, or any range or subrange therebetween. As used herein, “average” in “average major dimension” refers to a mean value; and the “major dimension” is the greatest dimension of a cuprite crystal as measured by SEM. In yet further aspects, the copper-containing glass-ceramic particle can comprise, but is not limited to, in mol % on an oxide basis: SiO₂ from about 30 mol % to about 70 mol %, Al₂O₃ from 0 mol % to about 20 mol %, copper oxide from about 10 mol % to about 50 mol %, CaO from 0 mol % to about 15 mol %, MgO from 0 mol % to about 15 mol %, P₂O₅ from 0 mol % to 25 mol %, B₂O₃ from 0 mol % to about 25 mol %, K₂O from 0 mol % to about 20 mol %, ZnO from 0 mol % to about 5 mol %, Na₂O from 0 mol % to about 20 mol %, Fe₂O₃ from 0 mol % to about 5 mol %, and/or a mixture thereof.

In aspects, a core refractive index (of the core material 113) can be greater than a cladding refractive index (of the cladding material 103 or 1103), for example, by greater than or equal to 0.10, greater than or equal to 0.11, greater than or equal to 0.12, greater than or equal to 0.13, greater than or equal to 0.14, greater than or equal to 0.15, greater than or equal to 0.17, greater than or equal to 0.19, greater than or equal to 0.20, greater than or equal to 0.21, or greater than or equal to 0.22. In further aspects, an absolute value of a difference between the core refractive index (of the core material 113) and the cladding refractive index (of the cladding material 103 or 1103) (e.g., the core refractive index can be greater than the cladding refractive index) can be from greater than or equal to 0.10 to less than or equal to 0.30 (e.g., from greater than or equal to 0.1 to less than or equal to 0.3), from greater than or equal to 0.11 to less than or equal to 0.28, from greater than or equal to 0.12 to less than or equal to 0.27, from greater than or equal to 0.13 to less than or equal to 0.26, from greater than or equal to 0.14 to less than or equal to 0.25, from greater than or equal to 0.15 to less than or equal to 0.24, from greater than or equal to 0.17 to less than or equal to 0.23, from greater than or equal to 0.19, to less than or equal to 0.22, from greater than or equal to 0.20 to less than or equal to 0.21, or any range or subrange therebetween. In preferred aspects, an absolute value of a difference between the core refractive index (of the core material 113) and the cladding refractive index (of the cladding material 103 or 1103) (e.g., the core refractive index can be greater than the cladding refractive index) can be from greater than or equal to 0.10 to less than or equal to 0.30 (e.g., from greater than or equal to 0.1 to less than or equal to 0.3), from greater than or equal to 0.15 to less than or equal to 0.28, or from greater than or equal to 0.20 to less than or equal to 0.25.

Throughout the disclosure, “numerical aperture” (NA) is defined as NA=√[n_{core}²−n_{clad}²], wherein n_{core} refers to the core refractive index (of the core material 113) and n_{clad} refers to the clad refractive index (of the cladding material 103 or 1103). The numerical aperture corresponds to the sine an acceptance angle θ_{A} of light that can coupled into the core material and/or guided through the core material (i.e., NA=sin θ_{A}), wherein θ_{A} is measured relative to a longitudinal axis of the core material (e.g., corresponding to a direction normal to the major surface 105 of the waveguide 101 or 1101). In aspects, a numerical aperture of the waveguide 101 or 1101 can be greater than or equal to 0.50 (e.g., 0.5), greater than or equal to 0.55, greater than or equal to 0.58, greater than or equal to 0.60, greater than or equal to 0.62, greater than or equal to 0.65, greater than or equal to 0.68, greater than or equal to 0.70, greater than or equal to 0.72, greater than or equal to 0.75, greater than or equal to 0.80, less than or equal to 0.90, less than or equal to 0.88, less than or equal to 0.85, less than or equal to 0.82, less than or equal to 0.80, less than or equal to 0.78, less than or equal 0.75, less than or equal to 0.72, less than or equal 0.70, less than or equal to 0.68, less than or equal to 0.65, or less than or equal to 0.60. In aspects, a numerical aperture of the waveguide 101 or 1101 can be from greater than or equal to 0.50 to less than or equal to less than or equal to 0.90 (e.g., from greater than or equal to 0.5 to less than or equal to 0.9), from greater than or equal to 0.55 to less than or equal to 0.88, from greater than or equal to 0.58 to less than or equal to 0.85, from greater than or equal to 0.60 to less than or equal to 0.82, from greater than or equal to 0.62 to less than or equal to 0.80, from greater than or equal to 0.65 to less than or equal to 0.78, from greater than or equal to 0.68 to less than or equal to 0.75, from greater than or equal to 0.70 to less than or equal to 0.72. In preferred aspects, a numerical aperture of the waveguide 101 or 1101 can be from greater than or equal to 0.50 to less than or equal to 0.9, from greater than or equal to 0.60 to less than or equal to 0.85, or from greater than or equal to 0.65 to less than or equal to 0.80. Providing a high numerical aperture (e.g., greater than or equal to 0.5, from greater than or equal to 0.50 to less than or equal to 0.9, from greater than or equal to 0.60 to less than or equal to 0.85, or from greater than or equal to 0.65 to less than or equal to 0.80) can enable the optical waveguide to receive (e.g., couple into an end) and transmit light due to the high acceptance angle, which can allow an end (e.g., major surface) of the waveguide to act as a lens refracting light to travel at a lower angle (e.g., relative to a longitudinal axis of the core)—thereby enabling the waveguide to collect more light and therefore more signal.

Aspects of the disclosure can involve the waveguide as part of an optical sensor 300 as shown in FIG. 3. In aspects, as shown, the waveguide 101 can be positioned such that the major surface 105 include the one or more sections of the core material 113 (e.g., rods 112a-112b, plurality of rods 111) faces a signal to be detected (e.g., light source 301 emitting light 303). Also, as shown, the opposite end (e.g. opposite major surface 105) can be coupled (e.g., optically coupled) to one or more communication channels 305 (e.g., with each section of the core material coupled to corresponding communication channel). In further aspects, the communication channels 305 can be optical communication channels (e.g., optical fibers) that relay the signal to a processor (e.g., detector 307). Alternatively, although not shown, the communication channels 305 (e.g., wires 306a-306b) can communicate an electrical signal from a detector optically coupled to a corresponding section of the core material that converts the light (e.g., light 303 transmitted through the corresponding rod 112a-112b of the waveguide 101) to an electrical signal (e.g., digital, analog) that is sent to the processor. In even further aspects, as shown, the detector 307 (and/or processor) can be coupled to and/or include a display 309 that can display information related to the detected and/or processed signal to a user. While a single light source 301 is shown in FIG. 3, it is to be understood that the waveguide 101 and/or optical sensor 300 can couple, transmit, and/or detect a plurality of different signals, for example corresponding to a plurality of different light sources or otherwise corresponding to a spatially varying signal. Also, it is to be understood that the light source shown in FIG. 3 may correspond to light reflected from a target object, where the actual source of the light can be elsewhere (e.g., ambient light from part of the optical sensor) and the light reflected from the target object can contain additional material (relative to before reflecting) that can be detected by the optical sensor. In aspects, the waveguide allows light in and out of the rest of the optical sensor. In further aspects, when the optical sensor includes its own light source, the light source and detector would be inside the device with the light source coupled to one section of the core material (that takes the light out to the object to be sensed) and one or more adjacent sections of the core material configured to bring light back from the object to the one or more detectors inside the device. The spacing and location of the sections of core material can allow for temporal and special information to be collected.

Aspects of the disclosure can comprise a consumer electronic product including the waveguide and/or optical sensor. The consumer electronic product can comprise a front surface, a back surface, and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In aspects, at least one of a portion of the housing comprises the waveguide and/or optical sensor discussed throughout the disclosure. The display can comprise a liquid crystal display (LCD), an electrophoretic displays (EPD), an organic light-emitting diode (OLED) display, or a plasma display panel (PDP). In aspects, the consumer electronic product can be a portable electronic device, for example, a smartphone, a tablet, a wearable device, or a laptop.

In aspects, an absolute value of a difference between the CTE of the core material 113 and the CTE of cladding material 103 (e.g., especially when the cladding material is a glass-based material) can be less than or equal to 10×10⁻⁷° C.⁻¹, less than or equal to 7×10⁻⁷° C.⁻¹, less than or equal to 5×10⁻⁷° C.⁻¹, less than or equal to 4×10⁻⁷° C.⁻¹, less than or equal to 3×10⁻⁷° C.⁻¹, less than or equal to 2×10⁻⁷° C.⁻¹, less than or equal to 1×10⁻⁷° C.⁻¹, greater than or equal to 0×10⁻⁷° C.⁻¹, or greater than or equal to 1×10⁻⁷° C.⁻¹ (e.g., from greater than or equal to 0×10⁻⁷° C.⁻¹ to less than or equal to 10×10⁻⁷° C.⁻¹, from greater than or equal to 0×10⁻⁷° C.⁻¹ to less than or equal to 5×10⁻⁷° C.⁻¹, from greater than or equal to 0×10⁻⁷° C.⁻¹ to less than or equal to 3×10⁻⁷° C.⁻¹, from greater than or equal to 1×10⁻⁷° C.⁻¹ to less than or equal to 2×10⁻⁷° C.⁻¹, or any range or subrange therebetween. Providing a low difference between coefficients of thermal expansion between the core material and the cladding material (e.g., an absolute value of the difference from 0×10⁻⁷° C.⁻¹ to 5×10⁻⁷° C.⁻¹, from 0×10⁻⁷° C.⁻¹ to 3×10⁻⁷° C.⁻¹, or from 1×10⁷° C.⁻¹ to 2×10⁷° C.⁻¹) can minimize an amount of thermal-induced stress in the waveguide, which can enable the waveguide to be reliably formed by redrawing, especially when the cladding material is a glass-based material and the maximum cross-sectional dimension of the waveguide is large (e.g., greater than or equal to 10.0 mm).

In aspects, a density of the core material 113 can be greater than a density of the cladding material 103 or 1103, for example, by greater than or equal to 0.5 g/cm³, greater than or equal to 0.6 g/cm³, greater than or equal to 0.7 g/cm³, greater than or equal to 0.8 g/cm³, greater than or equal to 0.9 g/cm³, greater than or equal to 1.0 g/cm³, greater than or equal to 1.2 g/cm³, greater than or equal to 1.5 g/cm³, greater than or equal to 2.0 g/cm³, less than or equal to 2.25 g/cm³, less than or equal to 2.0 g/cm³, less than or equal to 1.8 g/cm³, less than or equal to 1.6 g/cm³, less than or equal to 1.4 g/cm³, less than or equal to 1.2 g/cm³, less than or equal to 1.0 g/cm³, less than or equal to 0.9 g/cm³, or less than or equal to 0.7 g/cm³. In aspects, a density of the core material 113 can be greater than a density of the cladding material 103 or 1103 by from greater than or equal to 0.5 g/cm³ to less than or equal to 2.25 g/cm³, from greater than or equal to 0.6 g/cm³ to less than or equal to 2.0 g/cm³, from greater than or equal to 0.7 g/cm³ to less than or equal to 1.8 g/cm³, from greater than or equal to 0.8 g/cm³ to less than or equal to 1.6 g/cm³, from greater than or equal to 0.9 g/cm³ to less than or equal to 1.4 g/cm³, from greater than or equal to 1.0 g/cm³ to less than or equal to 1.2 g/cm³, or any range or subrange therebetween. In preferred aspects, a density of the core material 113 can be greater than a density of the cladding material 103 or 1103 by from greater than or equal to 0.5 g/cm³ to less than or equal to 2.25 g/cm³, from greater than or equal to 0.7 g/cm³ to less than or equal to 2.0 g/cm³, or from greater than or equal to 1.0 g/cm³ to less than or equal to 1.6 g/cm³.

Throughout the disclosure, the liquidus temperature of a glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point”. Also, the Poisson's ratio (ν), the Young's modulus (E), and the shear modulus (G) of the glass-based compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.” In aspects, the core composition and the cladding composition can have compatible viscosity profiles that allow both compositions to be redrawn together in a single assembly to form a waveguide, where the cladding composition can circumferentially surround and be fused to the core composition, which can be formed as a rod. Alternatively, a tube of a glass-based material comprising the core composition can also be used to form an annular (e.g., ring-shaped) section of the core material. Unexpectedly, inventors of the present disclosure discovered that a close viscosity match (e.g., within a factor from 0.01 to 100 or from 0.1 to 10) in a range from 105 Pascal-seconds to 10⁷ Pascal-seconds (e.g., when the clad composition has a viscosity of 10⁶ Pascal-seconds) is sufficient for the compositions to be redrawn and subsequently cooled together (regardless of a ratio between the viscosities at other points). For example, the pairs of viscosity curves (e.g., pair 411 and 415 or pair 413 and 417) for example compositions for exemplary core compositions with exemplary clad compositions can be successfully formed into the waveguide of the present disclosure even though the difference along the vertical axis 403 (e.g., y-axis) corresponding to a logarithm of the viscosity (I) in Poise is greater than 1 (e.g., 1 order of magnitude) above 1150° C. and below 750° C. (e.g., corresponding to a clad viscosity outside of 10³ Pascal-seconds to 10^{7.5} Pascal seconds) or is greater than 2 (e.g., 2 orders of magnitude) below about 680° C. (e.g., clad viscosity greater than 10^{8.8} Pascal-seconds). In aspects, at a predetermined temperature where the cladding material has a clad viscosity of 10⁵ Pascal-seconds (or 10⁶ Pascal-seconds), a ratio of a core viscosity of the core material to the cladding viscosity can be from 0.01 to 100, from 0.02 to 50, from 0.05 to 20, from 0.1 to 10, from 0.2 to 5, from 0.5 to 2, or any range or subrange therebetween. For example, the ratio of the core viscosity of the cladding viscosity can be from 0.1 to 100, from 0.2 to 50, from 0.3 to 20, from 0.5 to 10, from 0.7 to 5, from 1.0 to 2.0, or any range or subrange therebetween. In aspects, at a predetermined temperature where the cladding material has a clad viscosity of 10⁵ Pascal-seconds, a core viscosity of the core material can be from 103 Pascal-seconds to 10⁷ Pascal-seconds, from 103-5 Pascal-seconds to 10^{6.5} Pascal-seconds, from 10⁴ Pascal-seconds to 10⁶ Pascal-seconds, from 10^{4.5} Pascal-seconds to 10^{5.5} Pascal-seconds, from 10⁵ Pascal-seconds to 10^{5.3} Pascal-seconds, or any range or subrange therebetween. For example, at the predetermined temperature, the core viscosity can be from 10⁴ Pascal-seconds to 10⁷ Pascal-seconds, from 10^{4.2} Pascal-seconds to 10^{6.5} Pascal-seconds, from 10^{4.5} Pascal-seconds to 10⁶ Pascal-seconds, from 10^{4.7} Pascal-seconds to 10^{5.5} Pascal-seconds, from 10⁵ Pascal-seconds to 10^{5.3} Pascal-seconds, or any range or subrange therebetween.

In further aspects, the viscosities may be substantially different at viscosities outside of 10⁵ Pascal-seconds to 10⁷ Pascal-seconds, for example when the cladding material has a viscosity of 10¹¹ Pascal-seconds or even 10^{13.5} Pascal-seconds (while still being formable into the waveguide using redraw or similar methods). In even further aspects, at a strain point temperature for the cladding material (i.e., the temperature where the cladding material has a viscosity of 10^{13.5} Pascal-seconds), a viscosity of the core material can be less than or equal to 10¹¹ Pascal-seconds, less than or equal to 10¹¹ Pascal-seconds, or greater than or equal to 10^{15.5} Pascal-seconds. For example, a ratio of the viscosity of core material to the viscosity of the cladding material at the strain point temperature for the cladding material can be greater than or equal to 100 or less than or equal to 0.01. In even further aspects, at a second temperature where the cladding material has a viscosity of 10¹¹ Pascal-seconds, a viscosity of the core material can be less than or equal to 10⁹ Pascal-seconds, less than or equal to 10⁸ Pascal-seconds, greater than or equal to 10¹³ Pascal-seconds, or greater than or equal to 10^{13.5} Pascal-seconds. For example, a ratio of the viscosity of core material to the viscosity of the cladding material at the second temperature where the cladding material has a viscosity of 10¹² Pascal-seconds can be greater than or equal to 100 or less than or equal to 0.01.

As used herein, “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed herein is determined by the following method. First, As used herein, the “Vogel-Fulcher-Tamman” (VFT) relation describes the temperature dependence of the viscosity and is represented by the following equation:

$$log η = A + \frac{B}{T - {T}_{o}}$$

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (e.g., 200 Poise (P) Temperature, 35,000 P Temperature, and 200,000 P Temperature) at any temperature above softening point may be calculated. Unless otherwise specified, the liquidus viscosity and temperature of a glass composition or article is measured before the composition or article is subjected to any ion-exchange process or any other strengthening process. In particular, the liquidus viscosity and temperature of a glass composition or article is measured before the composition or article is exposed to an ion-exchange solution, for example before being immersed in an ion-exchange solution. As reported in the Examples below, the “liquidus viscosity” discussed herein corresponds to the “internal” Liquidus Viscosity (kP) reported in Table I.

In aspects, a transmittance of the core material can be high (e.g., 70% or more, 80% or more, 90% or more) while the transmittance of the cladding material can be low (e.g., 5.0% or less, 1% or less, 0.5% or less), which can enable the waveguide to transmit signals through the core material while minimizing interference from signals in adjacent core materials and/or incident on a side of the waveguide (e.g., not the major surface). As discussed above, in aspects, the core material can be ion-exchangeable and/or chemically strengthened (e.g., having a central tension within one or more of the corresponding ranges discussed above. In further aspects, the cladding material can also be ion-exchangeable (e.g., when the cladding material comprises a glass-based material having the cladding composition discussed above). In even further aspects, the core material and the cladding material can be chemically strengthened, for example, both having a central tension within one or more of the corresponding ranges discussed above (e.g., from greater than or equal to 30 MPa to less than or equal to 300 MPa, from greater than or equal to 50 MPa to less than or equal to 250 MPa, or from greater than or equal to 70 MPa to less than or equal to 180 MPa). In aspects, the core material can be entirely amorphous (e.g., free of crystallites).

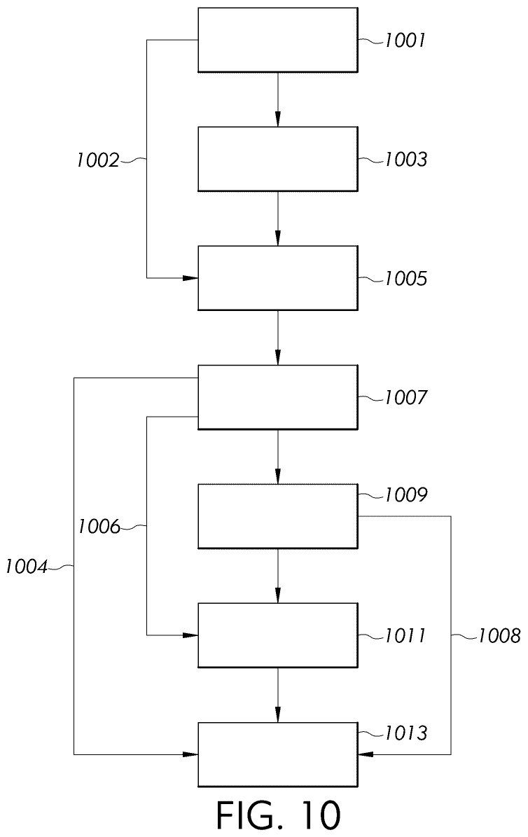

Methods of making a waveguide and/or glass-based article of the present disclosure will now be discussed with reference to the flow chart in FIG. 10 and example method steps illustrated in FIGS. 8-9. As discussed above, glass-based materials corresponding to core materials and/or cladding materials can comprise corresponding compositions within the aspects discussed above for the core composition and/or the cladding composition, respectively. Glass-based materials (e.g., glass-based substrates) can be obtained by forming them with a variety of ribbon forming processes, for example, slot-draw, down-draw, fusion down-draw, up-draw, press roll, redraw, or float. Alternatively, glass-based substrates comprising compositions in accordance with the present disclosure may be obtained by purchase. In aspects, the glass-based substrate can be an amorphous substrate or a glass-ceramic. In further aspects, a glass-ceramic can be formed by heating a glass-based substrate to nucleate and/or grow crystals.

Methods can start at step 1001 comprising obtaining a rod comprising a core material and a perform comprising a cladding material, where the core material and the cladding material are glass-based materials. In aspects, the core material can be entirely amorphous (e.g., free of crystallites). In aspects, the rod can be obtained by purchase or by forming using one or more of the glass forming methods discussed above, and/or the rod can comprise the core material having the core composition discussed above. In aspects, the preform can be obtained by purchase, modifying from a purchased glass-based substrate, or made and processed from materials corresponding to the cladding composition. In further aspects, the preform can be heat treated by the end of step 1001, for example, to develop a color. The cladding material of the preform can correspond to the cladding composition discussed above, which can be formed into a glass-based substrate (e.g., cylindrical glass-based substrate) using the glass forming methods discussed above. As shown in FIG. 8, the perform 803 comprise a hole 807 (e.g., one or more holes, plurality of holes). In further aspects, a glass-based substrate can be modified to form the preform 803 by forming a hole in the glass-based substrate using a laser, etching (e.g., chemical etching), or mechanical processing (e.g., grinding, drilling). The hole can be cleaned using air, a rinsing solution (e.g., deionized water, alkaline detergent solution, dilute acid), an etching solution, or combinations thereof to remove any debris and/or minimize irregularities in the surface of the perform defining the hole. In aspects, the rod can homogenously comprise the core composition. Alternatively, the rod can comprise the core composition for at least a portion of an outer periphery of the rode with at least portion of the rod also comprising the cladding composition. Alternatively, in aspects, a perform with a rod inserted in a hole of the preform can be provided by the end of step 1001(e.g., where methods can follow arrow 1002 to step 1005 rather than proceed to step 1003).

Alternatively, in aspects, a waveguide (e.g., corresponding to the consolidated assembly after thermal conditioning) can be formed using other methods, including a double-crucible method (or similar methods using multiple sources of molten material simultaneously, including using a stack-and-draw assembly), where the cladding material can be melted in a crucible with an orifice (e.g., one or more orifices) configured to receive molten material of the core composition that is melted in another crucible (e.g., one or more another crucibles) such that a predetermined cross-sectional profile (e.g., corresponding to the waveguide) is obtained. Such methods can be done in step 1001, the resulting product can be provided in step 1001, or in methods outside of the flow chart shown in FIG. 10 (with the understanding that the waveguide can be cut to a predetermined length, chemically strengthened, and/or assembled into an optical sensor—in any order—in further aspects).

After step 1001, as shown in FIG. 8, methods can proceed to step 1003 comprising inserting the rod 805 comprising the core material in the hole 807 of the preform 803 to form an assembly 811. In FIG. 8, the insertion is indicated by arrow 802. Although a single rod 805 is shown being inserted in a single hole 807 in the perform, it is to be understood that one or more rods (e.g., a plurality of rods) can be inserted into one or more holes 807 in the preform 803 (e.g., a plurality of rods being inserted into a hole along with spacers or a special geometry of the hole to maintain an arrangement of the plurality of rods, or a plurality of rods being inserted into a corresponding plurality of holes in the preform) in other aspects. The preform 803 and/or the assembly 811 can comprise an initial maximum cross-sectional dimension 813 that can be greater than a final maximum cross-sectional dimension 843 (e.g., diameter for an assembly with a circular cross-sectional shape) of the consolidated assembly 841 and/or the resulting waveguide, for example, by a multiple of 2 or more, 3 or more, or 4 or more.

After step 1001 or 1003, methods can proceed to step 1005 comprising redrawing the assembly 811 to reduce a maximum cross-sectional dimension (e.g., diameter for an assembly having a circular cross-sectional shape), as shown in FIG. 8. In aspects, as shown in FIG. 8, the assembly 811 can be heated by a furnace 821 represented by a pair of heaters 823 and 825 at a first temperature. In further aspects, the first temperature can correspond to a temperature where a viscosity of the core material and/or a viscosity of the cladding material is from 10⁴ Pascal-seconds to 10¹ Pascal-seconds. In even further aspects, the viscosity of the core material and the viscosity of the cladding material can be from 10⁴ Pascal-seconds to 10⁵ Pascal-seconds at the first temperature. For example, the first temperature can correspond to a working point temperature of one or more of the core material and/or the cladding material. In even further aspects, the first temperature can be greater than or equal to a working point temperature but less than or equal to a melting point temperature for both the core material and the cladding material. Alternatively, the first temperature can be greater than a softening point temperature and less than or equal to a working point temperature for both the core material and the cladding material. In further aspects, as shown in FIG. 8, the maximum cross-sectional dimension 813 (e.g., diameter for an assembly having a circular cross-sectional shape) of the assembly 811 decreases to a maximum cross-sectional dimension 843 of a consolidated assembly 841 after passing through the furnace 821 (as indicated by arrow 822). The maximum cross-sectional diameter of the assembly can decrease due to an applied pulling force and/or the force of gravity acting on the assembly (if arrow 822 correspond to a direction of gravity). The redrawing the assembly can consolidate the assembly such that the cladding material surrounding the core material fuses to the core material and/or air gaps that may exist in the assembly 811 initially are removed in forming the consolidated assembly 841.

After step 1005, methods can proceed to step 1007 comprising thermally conditioning the redrawn assembly (e.g., consolidated assembly 841) to form a waveguide (e.g., fused waveguide), as shown in FIG. 8. In aspects, thermally conditioning the redrawn assembly (e.g., consolidated assembly 841) can comprise decreasing the temperature at a predetermined rate and/or along a predetermined temperature profile. Thermally conditioning can minimize a difference in thermally-induced stress in the consolidated assembly between the core material and the cladding material. Decreasing the temperature is associated with increasing the viscosity of materials in the consolidated assembly. In aspects, thermal conditioning can occur until the viscosity of the cladding material and/or the viscosity of core material increases to be in a range from 10¹¹ Pascal-seconds to 10¹⁴ Pascal-seconds. In further aspects, the thermal conditioning can occur until the temperature decreases below a strain point temperature for both the core material and the cladding material. In aspects, the thermally conditioning can occur immediately after the redrawing (step 1005), although a relatively short gap in time (e.g., 10 minutes or less, 5 minutes or less, 2 minutes or less) can be provided in other aspects. In aspects, as shown in FIG. 8, the thermally conditioning the consolidated assembly 841 can comprise placing (e.g., translating) the consolidated assembly 841 in and/or through a second furnace 831 represented by a pair of heaters 833 and 835, where the second furnace can have a predetermined temperature profile (e.g., while the consolidated assembly 841 in therein or as the consolidated assembly 841 passes therethrough). Although not indicated in the flow chart, in aspects, the thermal conditioning can be omitted if the maximum cross-sectional dimension of the consolidated assembly is sufficiently small (e.g., less than 10 mm, less than 5 mm, less than 1 mm). In aspects, at the end of step 1007, the waveguide formed from the consolidated assembly can be cut into a plurality of waveguides (e.g., cutting at predetermined depths along the longitudinal axis of the rod, core material, and/or waveguide), although this can be done in step 1011 (discussed below) in other aspects or not be performed at all in yet other aspects.

After step 1007, as shown in FIG. 9, methods can proceed to step 1009 comprising chemically strengthening the waveguide. In aspects, as shown in FIG. 9, the waveguide 101 (and/or consolidated assembly 841) can be chemically strengthened by exposing it to one or more ion-exchange medium(s) (e.g., molten salt solution 903 contained in salt bath 901). The exchange medium(s) can include a molten nitrate salt (e.g., KNO₃, NaNO₃, or combinations thereof), for example, as a molten salt solution, although other sodium salts and/or potassium salts may be used in the ion-exchange medium, such as, for example sodium or potassium nitrites, phosphates, or sulfates. In aspects, the ion-exchange medium may include lithium salts, such as LiNO₃. The ion-exchange medium may additionally include additives commonly included when ion exchanging glass, such as silicic acid. In aspects, the ion-exchange medium may include a mixture of sodium and potassium (e.g., including both NaNO₃ and KNO₃). Alternatively, the ion-exchange medium can comprise potassium as the primary and/or only alkali metal ion. In further aspects, as shown in FIG. 9, the waveguide 101 (and/or consolidated assembly 841) can be exposed to a molten salt solution 903 (e.g., contained in a salt bath 901), for example, by immersing the waveguide 101 (and/or consolidated assembly 841) in the molten salt solution 903. Alternatively, although not shown, can comprise spraying the ion-exchange medium onto a glass substrate made from the glass composition or otherwise physically applying the ion-exchange medium to the glass-based to form the ion-exchanged glass-based article. In further aspects, the ion-exchange medium (e.g., molten salt solution 903) can be maintained at a predetermined temperature and/or the waveguide 101 (and/or consolidated assembly 841) can be in contact with the ion-exchange medium (e.g., molten salt solution 903) for a predetermined period of time. In further aspects, the predetermined temperature can be about 350° C. or more, about 360° C. or more, about 370° C. or more, about 380° C. or more, about 390° C. or more, about 400° C. or more, about 410° C. or more, about 420° C. or more, about 430° C. or more, about 440° C. or more, about 500° C. or less, about 480° C. or less, about 470° C. or less, about 460° C. or less, about 450° C. or less, about 440° C. or less, or about 430° C. or less. In further aspects, the predetermined temperature can be from greater than or equal to 350° C. to less than or equal to 500° C., from greater than or equal to 360° C. to less than or equal to 500° C., from greater than or equal to 370° C. to less than or equal to 490° C., from greater than or equal to 380° C. to less than or equal to 480° C., from greater than or equal to 390° C. to less than or equal to 470° C., from greater than or equal to 390° C. to less than or equal to 460° C., from greater than or equal to 400° C. to less than or equal to 450° C., from greater than or equal to 400° C. to less than or equal to 440° C., from greater than or equal to 410° C. to less than or equal to 440° C., or any range or subrange therebetween. In further aspects, the predetermined period of time can be about 5 minutes or more, 10 minutes or more, 0.25 hours or more, about 0.5 hours or more, about 1 hour or more, about 2 hours or more, about 4 hours or more, about 24 hours or less, about 8 hours or less, about 4 hours or less, about 3 hours or less, or about 2 hours or less. In aspects, the predetermined period of time can be from greater than or equal to 5 minutes to less than or equal to 24 hours, from greater than or equal to 10 minutes to less than or equal to 24 hours, from greater than or equal to 0.25 hours to less than or equal to 8 hours, from greater than or equal to 0.5 hours to less than or equal to 8 hours, from greater than or equal to 1 hour to less than or equal to 4 hours, or any range or subrange therebetween. Although a single molten salt solution is shown in FIG. 9, it is to be understood that several molten salt solutions (e.g., ion-exchange media) can be used in other aspects. The chemical strengthening the waveguide 101 (and/or consolidated assembly 841) can generate a central tension within one or more of the ranges discussed above (e.g., from greater than or equal to 30 MPa to less than or equal to 300 MPa, from greater than or equal to 50 MPa to less than or equal to 250 MPa, or from greater than or equal to 70 MPa to less than or equal to 180 MPa) in both the core material and the cladding material.

After step 1007 or 1009, methods can proceed to step 1011 comprising assembling an optical sensor and/or consumer electronic product using the waveguide. For example, the waveguide can be cut to a predetermined thickness (e.g., perpendicular to the cross-section or major surface shown in FIG. 1, distance along the longitudinal axis) and/or the waveguide can be placed in optical communication with (e.g., optically coupled to) other components in the optical sensor and/or consumer electronic product.

After step 1007, 1009, or 1011, methods can be complete upon reaching step 1013. In aspects, as discussed above with reference to the flow chart in FIG. 10, methods can start at step 1001 and then proceed sequentially through steps 1003, 1005, 1007, 1009, 1011, and 1013. In aspects, methods can follow arrow 1002 from step 1001 to step 1005, for example, if an assembly of the core material a preform of the cladding material is already present at the end of step 1001. In aspects, methods can follow arrow 1004 from step 1007 to step 1013, for example, if methods are complete after thermally conditioning the consolidated preform to form the waveguide. In aspects, methods can follow arrow 1006 from step 1007 to step 1011, for example, if the waveguide is not to be chemically strengthened but is to be incorporated into an optical sensor. In aspects, methods can follow arrow 1008 from step 1009 to step 1013, for example, if methods are complete after chemically strengthening the waveguide. Also, although not shown in the flow chart, in aspects, the thermal conditioning (step 1007) can be omitted if the maximum cross-sectional dimension of the consolidated assembly is sufficiently small (e.g., less than 10 mm, less than 5 mm, less than 1 mm). Any of the above options may be combined to make a composite (e.g., waveguide, laminate) in accordance with aspects of the disclosure.

Methods of forming a waveguide having a polymer-containing cladding material and a glass-based core material will now be discussed. Methods can start by obtaining a rod comprising a core material, which can be obtained by purchase or formed using one or more of the glass forming methods discussed above, wherein the core material can comprise the core composition discussed above. In aspects, the core material can be entirely amorphous (e.g., free of crystallites). In aspects, the core material can chemically strengthened, for example, before coating the core material with the polymer-containing material, for example, to achieve a central tension within one or more of the corresponding ranges discussed above. Then, a polymer-containing material can be attached to the core material (e.g., rod), for example, by curing a material (e.g., thermoset polymer-containing material) or reforming a thermoplastic polymer-containing material. In aspects, a precursor solution of a thermoset polymer-containing material can coat an outer periphery of the core material (e.g., rod), for example, by placing the core material in a mold containing the precursor solution or by transferring the precursor solution using coating methods (e.g., rolling, brushing, doctor blade coating); the precursor solution can then be cured (e.g., heated, irradiated with electromagnetic radiation having a predetermined optical wavelength that a photoinitiator in the precursor solution is sensitive to, and/or waiting a predetermined period of time). In aspects, a thermoplastic polymer-containing material can be remolded to coat the outer periphery of the core material (e.g., rod), for example, using extrusion or injection molding. In aspects, the polymer-containing material can comprise one or more of the aspects discussed above for the polymer-containing material. For example, the polymer-containing material can be antimicrobial and/or a copper-containing material (e.g., copper-containing glass-based material). In even further aspects, the polymer-containing material can contain nanoparticles (e.g., silica, SiC), which can provide enhanced scratch-resistance, impact-resistance, and/or fracture toughness to the polymer-containing material and/or waveguide.

### EXAMPLES

Embodiments will be further clarified by the following examples. It should be understood that these examples are not limiting to the aspects described above. Glass compositions were prepared and analyzed. The analyzed glass compositions included the components listed in Tables I-II below and were prepared by conventional glass forming methods. Table I presents example compositions and properties of glass-based materials in accordance with aspects of the core compositions, and Table II presents example composition and properties of glass-based materials in accordance with aspects of the cladding compositions. Tables III-IV present ion-exchange (i.e., chemical strengthening) conditions and resulting properties of glass-based articles. Table III includes compositions from Table I while Table IV includes composition from Table II.

As mentioned above, the compositions reported herein (including Tables I-II) refer to the composition of the resulting glass-based substrate. Unless otherwise indicated, the example compositions were formed into glass-based materials in a production-scale manufacturing process. In Tables I-II, all components are in mol % and the reported refractive index was measured at an optical wavelength of 589 nm. The density of the glass compositions was determined using the buoyancy method of ASTM C693-93(2013). The term “annealing point,” as used herein, refers to the temperature at which the viscosity of the glass composition is 10^{13.18} poise (10^{12.18} Pascal-seconds). The term “strain point,” as used herein, refers to the temperature at which the viscosity of the glass composition is 10^{14.68} poise (10^{13.68} Pascal-seconds). The strain point and annealing point of the glass compositions was determined using the fiber elongation method of ASTM C336-71(2015) or the beam bending viscosity (BBV) method of ASTM C598-93(2013). The term “softening point,” as used herein, refers to the temperature at which the viscosity of the glass composition is 10^{7.6} poise (10^{6.6} Pascal-seconds). The softening point of the glass compositions was determined using the fiber elongation method of ASTM C336-71(2015) or a parallel plate viscosity (PPV) method which measures the viscosity of inorganic glass from 10⁷ to 10⁹ poise (10⁶ to 10⁸ Pascal-seconds) as a function of temperature, similar to ASTM C1351M. Unless others indicated, the fiber elongation method was used to determine the softening point. The linear coefficient of thermal expansion (CTE) over the temperature range of 20° C. to 300° C. is expressed in terms of 10⁻⁷/° C. and was determined using a push-rod dilatometer in accordance with ASTM E228-11. If cells are left blank in Table I-II, the property was not measured for that composition.

TABLE I
Composition and Properties for Core Compositions

| Composition | 1 | 2 | 3 | 4 | 5 | 6 | 7 | 8 |
|---|---|---|---|---|---|---|---|---|
| SiO₂ | 61.34 | 60.01 | 61.4 | 67.94 | 63.94 | 59.92 | 65.94 | 65.95 |
| Al₂O₃ | 0.98 | 1.00 | 0.99 | 4.00 | 7.99 | 1.00 | 4.00 | 4.00 |
| B₂O₃ | 1.98 | 2.99 | 1.98 | 0 | 0 | 0 | 0 | 0 |
| Ta₂O₅ | 13.85 | 14.00 | 13.86 | 11.99 | 11.99 | 7.99 | 11.99 | 11.99 |
| Li₂O | 11.89 | 12.02 | 11.88 | 9.99 | 9.99 | 17.97 | 9.99 | 9.99 |
| Na₂O | 9.86 | 9.98 | 9.87 | 5.98 | 5.98 | 4.98 | 5.98 | 5.97 |
| K₂O | 0 | 0 | 0 | 0 | 0 | 0 | 0 | 0 |
| MgO | 0 | 0 | 0 | 0 | 0 | 0 | 0 | 0 |
| CaO | 0 | 0 | 0.02 | 0 | 0 | 0 | 0 | 0 |
| SnO₂ | 0.1 | 0 | 0 | 0.1 | 0.1 | 0.1 | 0.1 | 0.1 |
| Other | — | — | — | 0.01 Fe₂O₃ | 0.01 Fe₂O₃ | 8 La₂O₃ | 0.01 Fe₂O₃ | 2 Bi₂O₃ |
| | | | | | | 0.05 CeO₂ | | |
| RO | 0 | 0 | 0.02 | 0 | 0 | 0 | 0 | 0 |
| R₂O | 21.75 | 22.00 | 21.75 | 15.97 | 15.97 | 22.95 | 15.97 | 15.96 |
| CTE (10⁻⁷/° C.) | 67.2 | | 67.2 | 53.9 | 56.8 | | 56.1 | 56.7 |
| Refractive Index | 1.70 | | 1.70 | | | | | |
| Strain Point (° C.) | 610 | | 610 | 700 | 690 | 567 | 702 | 639 |
| Annealing Point | 654 | | 654 | 743 | 733 | 604 | 744 | 682 |
| (° C.) | | | | | | | | |
| Softening Point | 847 | | 847 | | | 757 | | |
| (° C.) | | | | | | | | |

| Composition | 9 | 10 | 11 | 12 | 13 | 14 | 15 |
|---|---|---|---|---|---|---|---|
| SiO₂ | 63.95 | 65.94 | 65.94 | 63.95 | 65.95 | 67.94 | 67.94 |
| Al₂O₃ | 4.00 | 4.00 | 4.00 | 4.00 | 4.00 | 4.00 | 4.00 |
| B₂O₃ | 0 | 0 | 0 | 0 | 0 | 0 | 0 |
| Ta₂O₅ | 11.99 | 11.99 | 13.99 | 15.99 | 12.99 | 9.99 | 7.99 |
| Li₂O | 13.98 | 11.99 | 9.99 | 9.99 | 9.99 | 9.99 | 9.99 |
| Na₂O | 5.98 | 5.98 | 5.98 | 5.98 | 6.97 | 5.98 | 5.98 |
| K₂O | 0 | 0 | 0 | 0 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0 | 0.1 | 0.1 | 0.1 | 0.1 | 0.1 |
| Other | 0.01 Fe₂O₃ | 0.01 Fe₂O₃ | — | 0.01 Fe₂O₃ | — | 2 ZrO₂ | 4 ZrO₂ |
| | | | | | | 0.01 Fe₂O₃ | 0.01 Fe₂O₃ |
| RO | 0 | 0 | 0 | 0 | 0 | 0 | 0 |
| R₂O | 19.96 | 17.97 | 15.97 | 15.97 | 16.96 | 15.97 | 15.97 |
| Density (g/cm³) | 3.746 | 3.696 | 3.885 | 4.073 | 3.795 | 3.573 | 3.426 |
| CTE (10⁻⁷/° C.) | 63.6 | 58.0 | 52.7 | 53.7 | 56.7 | 54.9 | 57.4 |
| Refractive Index | 1.676 | 1.665 | 1.690 | 1.715 | 1.675 | 1.665 | 1.664 |
| Strain Point (° C.) | 635 | 668 | 704 | 712 | 692 | 664 | 634 |
| Annealing Point | 679 | 714 | 747 | 754 | 735 | 707 | 675 |
| (° C.) | | | | | | | |
| Softening Point | 874 | 89 | | | 918 | 885 | |
| (° C.) | | | | | | | |

| Composition | 16 | 17 | 18 | 19 | 20 | 21 | 22 |
|---|---|---|---|---|---|---|---|
| SiO₂ | 65.34 | 62.74 | 61.95 | 63.95 | 63.95 | 63.95 | 63.95 |
| Al₂O₃ | 3.20 | 2.40 | 4.00 | 4.00 | 4.00 | 4.00 | 4.00 |
| B₂O₃ | 0 | 0 | 0 | 0 | 0 | 0 | 0 |
| Ta₂O₅ | 11.59 | 11.19 | 11.99 | 10.99 | 9.99 | 13.99 | 11.99 |
| Li₂O | 11.99 | 13.99 | 15.98 | 12.99 | 11.99 | 9.99 | 9.99 |
| Na₂O | 4.78 | 3.59 | 5.98 | 5.98 | 5.98 | 5.98 | 5.98 |
| K₂O | 0 | 0 | 0 | 0 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0.1 | 0.1 | 0.1 | 0.1 | 0.1 | 0.1 |
| Other | 3 La₂O₃ | 6 La₂O₃ | | 2 TiO₂ | 4 TiO₂ | 2 TiO₂ | 4 TiO₂ |
| | | 0.01 Fe₂O₃ | | | | | |
| RC | 0 | 0 | 0 | 0 | 0 | 0 | 0 |
| R2O | 16.77 | 17.58 | 21.96 | 18.97 | 17.97 | 15.97 | 15.97 |
| Density (g/cm³) | 3.903 | 4.105 | 3.798 | 3.673 | 3.576 | 3.912 | 3.725 |
| CTE (10⁻⁷/° C.) | 61.3 | 68.2 | 68.0 | 61.8 | 63.4 | 56.0 | 54.6 |
| Refractive Index | 1.684 | 1.708 | 1.676 | 1.680 | 1.684 | 1.715 | 1.715 |
| Strain Point (° C.) | 638 | 625 | 628 | 632 | 616 | 684 | 656 |
| Annealing Point | 684 | 667 | 671 | 675 | 659 | 725 | 698 |
| (° C.) | | | | | | | |
| Softening Point | | 843 | | | | | |
| (° C.) | | | | | | | |

| Composition | 23 | 24 | 25 | 26 | 27 | 28 | 29 |
|---|---|---|---|---|---|---|---|
| SiO₂ | 61.95 | 59.95 | 64.98 | 62.03 | 59.94 | 61.93 | 63.94 |
| Al₂O₃ | 4.00 | 4.00 | 3.66 | 3.32 | 4.00 | 4.00 | 4.00 |
| B₂O₃ | 2.00 | 4.00 | 0 | 0 | 4.00 | 2.00 | 0 |
| Ta₂O₅ | 11.99 | 11.99 | 9.59 | 7.19 | 11.99 | 11.99 | 11.99 |
| Li₂O | 13.99 | 13.99 | 11.07 | 12.15 | 13.99 | 13.99 | 11.99 |
| Na₂O | 5.98 | 5.98 | 6.77 | 7.57 | 5.98 | 5.98 | 7.97 |
| K₂O | 0 | 0 | 0 | 0 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0.1 | 0.1 | 0.1 | 0.1 | 0.1 | 0.1 |
| Other | — | | 0.8 La₂O₃ | 1.6 La₂O₃ | 0.01 TiO₂ | 0.01 TiO₂ | 0.01 TiO₂ |
| | | | 0.6 Nb₂O₅ | 1.2 Nb₂O₅ | | | 0.01 Fe₂O₃ |
| | | | 1.4TiO₂ | 2.8 4TiO₂ | | | |
| | | | 1 ZrO₂ | 2 ZrO₂ | | | |
| | | | | 0.01 CeO₂ | | | |
| RO | 0 | 0 | 0 | 0 | 0 | 0 | 0 |
| R₂O | 19.97 | 19.97 | 17.84 | 19.72 | 19.97 | 19.97 | 19.96 |
| Density (g/cm³) | 3.763 | 3.792 | 3.634 | 3.546 | 3.75 | 3.749 | 3.756 |
| CTE (10⁻⁷/° C.) | 64.0 | 66.5 | 64.4 | 71.7 | 65.6 | 63.6 | 66.4 |
| Refractive Index | 1.692 | 1.680 | 1.673 | 1.679 | | | |
| Strain Point (° C.) | 606 | 585 | 630 | 589 | 579 | 609 | 634 |
| Annealing Point | 651 | 629 | 673 | 631 | 623 | 654 | 678 |
| (° C.) | | | | | | | |
| Softening Point | | | | | 818 | 832 | 869 |
| (° C.) | | | | | | | |

| Composition | 30 | 31 | 32 | 33 | 34 | 35 | 36 |
|---|---|---|---|---|---|---|---|
| SiO₂ | 61.94 | 59.02 | 59.96 | 63.95 | 63.95 | 61.95 | 63.95 |
| Al₂O₃ | 4.00 | 0.03 | 4.00 | 4.00 | 4.00 | 4.00 | 2.00 |
| B₂O₃ | 0 | 0 | 4.00 | 0 | 0 | 0 | 0 |
| Ta₂O₅ | 13.99 | 9.08 | 11.99 | 11.99 | 11.99 | 13.99 | 11.99 |
| Li₂O | 11.99 | 13.62 | 9.99 | 9.99 | 8 | 9.99 | 9.99 |
| Na₂O | 7.97 | 4.53 | 9.96 | 9.96 | 11.96 | 9.96 | 9.97 |
| K₂O | 0 | 0 | 0 | 0 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0.1 | 0.1 | 0.1 | 0.1 | 0.1 | 0.1 |
| Other | — | 14 La₂O₃ | — | 0.01 Fe₂O₃ | — | — | — |
| | | 0.01 TiO₂ | | | | | |
| RO | 0 | 0 | 0 | 0 | 0 | 0 | 0 |
| R₂O | 19.96 | 18.15 | 19.95 | 19.95 | 19.96 | 19.95 | 19.96 |
| Density (g/cm³) | 3.954 | 4.499 | 3.74 | 3.756 | 3.755 | 3.946 | 3.927 |
| CTE (10⁻⁷/° C.) | 64.2 | 84.1 | 67.8 | 64.9 | 65.7 | 64.2 | 68.0 |
| Refractive Index | | | 1.674 | 1.670 | 1.669 | 1.697 | 1.688 |
| Strain Point (° C.) | 667 | 617 | 589 | 649 | 661 | 684 | 629 |
| Annealing Point | 712 | 653 | 634 | 695 | 708 | 728 | 674 |
| (° C.) | | | | | | | |
| Softening Point | 883 | 804 | 816 | 887 | 896 | 901 | 856 |
| (° C.) | | | | | | | |

| Composition | 37 | 38 | 39 | 40 | 41 | 42 | 43 |
|---|---|---|---|---|---|---|---|
| SiO₂ | 61.96 | 65.95 | 61.96 | 65.95 | 66.95 | 67.93 | 69.91 |
| Al₂O₃ | 5.99 | 2.00 | 4.00 | 2.00 | 1.00 | 0.03 | 0.03 |
| B₂O₃ | 0 | 0 | 0 | 0 | 0 | 0 | 0 |
| Ta₂O₅ | 11.99 | 11.99 | 11.99 | 11.99 | 11.99 | 11.99 | 11.99 |
| Li₂O | 9.99 | 9.99 | 10.99 | 10.99 | 10.99 | 10.98 | 9.99 |
| Na₂O | 9.96 | 9.96 | 10.96 | 8.97 | 8.97 | 8.96 | 7.97 |
| K₂O | 0 | 0 | 0 | 0 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0.1 | 0.1 | 0.1 | 0.1 | 0.1 | 0.1 |
| Other | — | 0.01 Fe₂O₃ | — | 0.01 Fe₂O₃ | 0.01 Fe₂O₃ | 0.01 Fe₂O₃ | 0.01 Fe₂O₃ |
| RO | 0 | 0 | 0 | 0 | 0 | 0 | 0 |
| R₂O | 19.95 | 19.95 | 21.95 | 19.96 | 19.96 | 19.94 | 17.96 |
| Density (g/cm³) | 3.739 | 3.776 | 3.78 | 3.798 | 3.804 | 3.783 | 3.765 |
| CTE (10⁻⁷/° C.) | 67.4 | 63.7 | 70.4 | 62.9 | 63.0 | 61.8 | 56.1 |
| Refractive Index | 1.668 | 1.672 | 1.674 | 1.677 | 1.677 | 1.674 | 1.671 |
| Strain Point (° C.) | 663 | 634 | 628 | 630 | 621 | 618 | 643 |
| Annealing Point | 707 | 681 | 674 | 677 | 668 | 664 | 690 |
| (° C.) | | | | | | | |
| Softening Point | 882 | 880 | 862 | 874 | 872 | 871 | 899 |
| (° C.) | | | | | | | |

| Composition | 44 | 45 | 46 | 47 | 48 | 49 | 50 |
|---|---|---|---|---|---|---|---|
| SiO₂ | 71.91 | 67.95 | 69.94 | 59.14 | 63.12 | 64.94 | 62.95 |
| Al₂O₃ | 0.03 | 2.00 | 2.00 | 0.03 | 0.03 | 1.00 | 1.00 |
| B₂O₃ | 0 | 0 | 0 | 0 | 0 | 2.00 | 4.00 |
| Ta₂O₅ | 11.99 | 10.99 | 9.99 | 8.99 | 8.19 | 11.99 | 11.99 |
| Li₂O | 8.99 | 10.49 | 9.99 | 12.18 | 10.89 | 10.99 | 10.99 |
| Na₂O | 6.97 | 8.47 | 7.97 | 5.98 | 5.28 | 8.97 | 8.97 |
| K₂O | 0 | 0 | 0 | 0 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0.1 | 0.1 | 0.1 | 0.1 | 0.1 | 0.1 |
| Other | 0.01 Fe₂O₃ | 0.01 Fe₂O₃ | 0.01 Fe₂O₃ | 14 La₂O₃ | 12 La₂O₃ | 0.01 TiO₂ | 0.01 TiO₂ |
| RO | 0 | 0 | 0 | 0 | 0 | 0 | 0 |
| R₂O | 15.96 | 18.96 | 17.96 | 18.16 | 16.17 | 19.96 | 19.96 |
| Density (g/cm³) | 3.65 | 3.738 | 3.543 | 4.479 | 4.308 | 3.784 | 3.782 |
| CTE (10⁻⁷/° C.) | 61.0 | 50.2 | 54.6 | 80.3 | 84.1 | 65.0 | 64.3 |
| Refractive Index | 1.659 | 1.671 | 1.643 | 1.755 | 1.739 | 1.675 | 1.682 |
| Strain Point (° C.) | 625 | 679 | 618 | 622 | 621 | 599 | 581 |
| Annealing Point | 673 | 727 | 665 | 659 | 660 | 645 | 624 |
| (° C.) | | | | | | | |
| Softening Point | 876 | 926 | 877 | 806 | 816 | 848 | 820 |
| (° C.) | | | | | | | |

| Composition | 51 | 52 | 53 | 54 | 55 | 56 | 57 |
|---|---|---|---|---|---|---|---|
| SiO₂ | 68.94 | 66.95 | 64.95 | 66.95 | 66.93 | 64.94 | 66.94 |
| Al₂O₃ | 1.00 | 1.00 | 1.00 | 1.00 | 1.00 | 1.00 | 1.00 |
| B₂O₃ | 0 | 0 | 0 | 0 | 0 | 0 | 0 |
| Ta₂O₅ | 11.99 | 11.99 | 11.99 | 10.99 | 11.99 | 11.99 | 10.99 |
| Li₂O | 9.99 | 9.99 | 10.99 | 10.49 | 9.99 | 10.99 | 10.49 |
| Na₂O | 7.97 | 7.97 | 8.97 | 8.47 | 7.97 | 8.96 | 8.47 |
| K₂O | 0 | 0 | 0 | 0 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0.1 | 0.1 | 0.1 | 0.1 | 0.1 | 0.1 |
| Other | 0.01 TiO₂ | 2 TiO₂ | 2 TiO₂ | 2 TiO | 0.01 TiO | 0.01 TiO | 0.01 TiO |
| | 0.01 Fe₂O₃ | 0.01 Fe₂O₃ | | 0.01 Fe₂O₃ | 2 ZrO₂ | 2 ZrO₂ | 2 ZrO₂ |
| | | | | | 0.01 Fe₂O₃ | 0.01 Fe₂O₃ | 0.01 Fe₂O₃ |
| RO | 0 | 0 | 0 | 0 | 0 | 0 | 0 |
| R₂O | 17.96 | 17.96 | 19.96 | 18.96 | 17.96 | 19.95 | 18.96 |
| Density (g/cm³) | 3.763 | 3.792 | 3.819 | 3.70 | 3.816 | 3.847 | 3.731 |
| CTE (10⁻⁷/° C.) | 58.2 | 58.0 | 63.7 | 63.1 | 58.3 | 63.3 | 61.2 |
| Refractive Index | 1.672 | 1.688 | 1.690 | 1.675 | 1.685 | 1.687 | 1.672 |
| Strain Point (° C.) | 651 | 643 | 622 | 615 | 682 | 655 | 651 |
| Annealing Point | 698 | 690 | 666 | 660 | 727 | 701 | 698 |
| (° C.) | | | | | | | |
| Softening Point | 898 | 883 | 859 | 856 | 911 | 890 | 889 |
| (° C.) | | | | | | | |

| Composition | 58 | 59 | 60 | 61 | 62 | 63 | 64 | 65 |
|---|---|---|---|---|---|---|---|---|
| SiO₂ | 62.95 | 61.34 | 60.95 | 58.96 | 60.95 | 62.95 | 60.96 | 62.95 |
| Al₂O₃ | 1.00 | 0.99 | 1.00 | 1.00 | 1.00 | 1.00 | 1.00 | 1.00 |
| B₂O₃ | 2.00 | 1.98 | 6.00 | 5.99 | 6.00 | 2.00 | 4.00 | 2.00 |
| Ta₂O₅ | 12.99 | 13.85 | 11.99 | 12.99 | 13.99 | 11.99 | 11.99 | 10.99 |
| Li₂O | 11.49 | 11.87 | 10.99 | 11.49 | 9.99 | 10.99 | 10.99 | 10.49 |
| Na₂O | 9.47 | 9.86 | 8.97 | 9.47 | 7.97 | 8.97 | 8.97 | 8.47 |
| K₂O | 0 | 0 | 0 | 0 | 0 | 0 | 0 | 0 |
| MgO | 0 | 0 | 0 | 0 | 0 | 0 | 0 | 0 |
| CaO | 0 | 0 | 0 | 0 | 0 | 0 | 0 | 0 |
| SnO₂ | 0.1 | 0.1 | 0.1 | 0.1 | 0.1 | 0.1 | 0.1 | 0.1 |
| Other | — | — | — | — | 2 La₂O₃ | 2 La₂O₃ | 2 La₂O₃ | 2 La₂O₃ |
| RO | 0 | 0 | 0 | 0 | 0 | 0 | 0 | 0 |
| R₂O | 20.96 | 21.73 | 19.96 | 20.96 | 17.96 | 19.96 | 19.96 | 18.96 |
| Density (g/cm³) | 3.898 | 3.989 | 3.797 | 3.897 | 3.925 | 3.944 | 3.945 | 3.837 |
| CTE (10⁻⁷/° C.) | 65.0 | 65.8 | 63.8 | 67.2 | 57.2 | 67.3 | 67.7 | 65.9 |
| Strain Point (° C.) | 608 | 612 | 569 | 572 | 617 | 600 | 581 | 582 |
| Annealing Point | 654 | 658 | 611 | 616 | 660 | 644 | 623 | 624 |
| (° C.) | | | | | | | | |
| Softening Point | 853 | 858 | 800 | 804 | 846 | 831 | 812 | 806 |
| (° C.) | | | | | | | | |

| Composition | 66 | 67 | 68 | 69 | 70 | 71 | 72 |
|---|---|---|---|---|---|---|---|
| SiO₂ | 60.95 | 59.77 | 59.76 | 59.76 | 60.35 | 59.76 | 61.34 |
| Al₂O₃ | 1.00 | 0.98 | 0.98 | 0.98 | 0.99 | 0.98 | 0.98 |
| B₂O₃ | 2.00 | 1.96 | 1.96 | 1.96 | 1.98 | 1.96 | 1.98 |
| Ta₂O₅ | 13.99 | 13.71 | 13.71 | 13.71 | 13.85 | 13.71 | 13.85 |
| Li₂O | 11.99 | 11.76 | 13.71 | 11.75 | 11.87 | 11.75 | 11.89 |
| Na₂O | 9.96 | 11.72 | 9.76 | 9.77 | 9.86 | 9.77 | 9.86 |
| K₂O | 0 | 0 | 0 | 1.96 | 0 | 0 | 0 |
| MgO | 0 | 0 | 0 | 0 | 0 | 0 | 0 |
| CaO | 0 | 0 | 0 | 0 | 0 | 0 | 0 |
| SnO₂ | 0.1 | 0.1 | 0.1 | 0.1 | 0.1 | 0.1 | 0.1 |
| Other | — | — | — | — | 1 La₂O₃ | 2 La₂O₃ | — |
| RO | 0 | 0 | 0 | 0 | 0 | 0 | 0 |
| R₂O | 21.95 | 23.48 | 23.47 | 24.48 | 21.73 | 21.52 | 21.75 |
| Density (g/cm³) | 4.002 | 3.971 | 3.995 | 3.988 | 4.058 | 4.111 | |

| Composition | 73 | 74 | 75 | 76 | 77 | 78 | 79 |
|---|---|---|---|---|---|---|---|
| SiO₂ | 61.01 | 60.85 | 61 | 60.85 | 60.55 | 59.67 | 60.85 |
| Al₂O₃ | 1.00 | 1.00 | 1.00 | 1.00 | 0.99 | 0.98 | 1.00 |
| B₂O₃ | 2.00 | 1.99 | 2.00 | 1.99 | 1.98 | 1.96 | 3.99 |
| Ta₂O₅ | 14.00 | 13.97 | 14.00 | 13.97 | 13.90 | 13.69 | 13.97 |
| Li₂O | 12.00 | 11.97 | 12.00 | 11.97 | 11.91 | 11.74 | 10.97 |
| Na₂O | 9.97 | 9.95 | 9.97 | 9.95 | 9.41 | 7.8 | 8.95 |
| K₂O | 0 | 0 | 0 | 0 | 0 | 0 | 0 |
| MgO | 0 | 0 | 0 | 0 | 0 | 0 | 0 |
| CaO | 0.02 | 0.02 | 0.03 | 0.03 | 0.02 | 0.02 | 0.02 |
| SnO₂ | 0 | 0.25 | 0 | 0.25 | 0.25 | 0.24 | 0.25 |
| Other | — | — | — | — | 1 NaF | 4 NaF | — |
| RO | 0.02 | 0.02 | 0.03 | 0.03 | 0.02 | 0.02 | 0.02 |
| R₂O | 21.97 | 21.92 | 21.97 | 21.92 | 21.32 | 19.54 | 19.92 |
| Density (g/cm³) | 3.999 | 4.01 | 4.001 | 3.958 | 4.006 | 4.001 | 3.989 |
| CTE (10⁻⁷/° C.) | | | | 65.7 | 65.7 | 66.4 | 59.6 |
| Refractive Index | | | | | | | |
| Strain Point (° C.) | | | | 615 | 604 | 589 | 620 |
| Annealing Point | | | | 659 | 650 | 635 | 665 |
| (° C.) | | | | | | | |
| Softening Point | | | | 849 | 856 | 839 | 850 |
| (° C.) | | | | | | | |
| Liquidus | | | 1255 | 1245 | 1255 | 1235 | 1230 |
| Temperature (° C.) | | | | | | | |

| Composition | 80 | 81 | 82 | 83 | 84 | 85 | 86 |
|---|---|---|---|---|---|---|---|
| SiO₂ | 60.85 | 62 | 62 | 62 | 62.01 | 62 | 62.01 |
| Al₂O₃ | 1.00 | 1.00 | 1.00 | 1.00 | 1.00 | 1.00 | 1.00 |
| B₂O₃ | 1.99 | 3.00 | 3.00 | 3.00 | 3.00 | 5.00 | 7.00 |
| Ta₂O₅ | 13.97 | 14.00 | 12.00 | 10.00 | 8.00 | 14.00 | 14.00 |
| Li₂O | 11.97 | 11.00 | 11.00 | 11.00 | 11.00 | 10.00 | 9.00 |
| Na₂O | 9.95 | 8.98 | 8.97 | 8.98 | 8.97 | 7.98 | 6.98 |
| K₂O | 0 | 0 | 0 | 0 | 0 | 0 | 0 |
| MgO | 0 | 0 | 0 | 0 | 0 | 0 | 0 |
| CaO | 0.02 | 0.02 | 0.02 | 0.02 | 0.02 | 0.02 | 0.01 |
| SnO₂ | 0.25 | 0 | 0 | 0 | 0 | 0 | 0 |
| Other | — | — | 2 Nb₂O₅ | 4 Nb₂O₅ | 6 Nb₂O₅ | — | — |
| RO | 0.02 | 0.02 | 0.02 | 0.02 | 0.02 | 0.02 | 0.01 |
| R₂O | 21.92 | 19.98 | 19.97 | 19.98 | 19.97 | 17.98 | 15.98 |
| Density (g/cm³) | 3.839 | 3.98 | 3.85 | 3.72 | 3.587 | 3.916 | 3.898 |
| CTE (10⁻⁷/° C.) | 63.2 | 61.3 | 63.4 | 65.0 | | 57.8 | 51.8 |
| Refractive Index | | 1.708 | 1.715 | 1.709 | 1.710 | 1.704 | 1.703 |
| Strain Point (° C.) | 616 | | | | | | |
| Annealing Point | 662 | | | | | | |
| (° C.) | | | | | | | |
| Softening Point | 861 | | | | | | |
| (° C.) | | | | | | | |

| Composition | 87 | 88 | 89 | 90 | 91 | 92 | 93 |
|---|---|---|---|---|---|---|---|
| SiO₂ | 64.00 | 66.01 | 62.01 | 61.00 | 63.00 | 65.00 | 67.00 |
| Al₂O₃ | 1.00 | 1.00 | 1.00 | 1.00 | 1.00 | 1.00 | 1.00 |
| B₂O₃ | 3.00 | 3.00 | 3.00 | 2.00 | 2.00 | 2.00 | 2.00 |
| Ta₂O₅ | 14.00 | 14.00 | 8.00 | 12.00 | 12.00 | 12.00 | 12.00 |
| Li₂O | 10.00 | 9.00 | 11.00 | 12.00 | 11.00 | 10.00 | 9.00 |
| Na₂O | 7.98 | 6.98 | 8.97 | 9.97 | 8.97 | 7.97 | 6.98 |
| K₂O | 0 | 0 | 0 | 0 | 0 | 0 | 0 |
| MgO | 0 | 0 | 0 | 0 | 0 | 0 | 0 |
| CaO | 0.02 | 0.01 | 0.02 | 0.02 | 0.02 | 0.02 | 0.02 |
| SnO₂ | 0 | 0 | 0 | 0 | 0 | 0 | 0 |
| Other | — | — | 6 Nb₂O₅ | 2 Nb₂O₅ | 2 Nb₂O₅ | 2 Nb₂O₅ | 2 Nb₂O₅ |
| RO | 0.02 | 0.01 | 0.02 | 0.02 | 0.02 | 0.02 | 0.02 |
| R₂O | 17.98 | 15.98 | 19.97 | 21.97 | 19.97 | 17.97 | 15.98 |
| Density (g/cm³) | 3.917 | 3.893 | 3.501 | 3.877 | 3.855 | 3.826 | 3.799 |
| CTE (10⁻⁷/° C.) | 56.6 | 51.6 | 64.0 | | | | |
| Refractive Index | 1.702 | 1.698 | 1.700 | | | | |

| Composition | 94 | 95 | 96 | 97 | 98 | 99 | 100 |
|---|---|---|---|---|---|---|---|
| SiO₂ | 64.36 | 63.99 | 62.00 | 63.00 | 61.01 | 61.00 | 61.00 |
| Al₂O₃ | 0.99 | 0.02 | 2.00 | 1.00 | 1.00 | 1.00 | 1.00 |
| B₂O₃ | 0 | 2.00 | 2.00 | 2.00 | 2.00 | 2.00 | 2.00 |
| Ta₂O₅ | 11.88 | 12.00 | 12.00 | 12.00 | 12.00 | 11.00 | 10.00 |
| Li₂O | 11.38 | 10.99 | 11.00 | 10.00 | 10.00 | 12.00 | 12.00 |
| Na₂O | 9.38 | 8.97 | 8.97 | 7.98 | 7.98 | 9.97 | 9.97 |
| K₂O | 0 | 0 | 0 | 0 | 0 | 0 | 0 |
| MgO | 0 | 0 | 0 | 0 | 0 | 0 | 0 |
| CaO | 0.02 | 0.02 | 0.02 | 0.01 | 0.01 | 0.02 | 0.02 |
| SnO₂ | 0 | 0 | 0 | 0 | 0 | 0 | 0 |
| Other | 2 Nb₂O₅ | 2 Nb₂O₅ | 2 Nb₂O₅ | 2 Nb₂O₅ | 2 Nb₂O₅ | 2 Nb₂O₅ | 2 Nb₂O₅ |
| | | | | 2 P₂O₅ | 4 P₂O₅ | 1 WO₃ | 2 WO₃ |
| RO | 0.02 | 0.02 | 0.02 | 0.01 | 0.01 | 0.02 | 0.02 |
| R₂O | 20.76 | 19.96 | 19.97 | 17.98 | 17.98 | 21.97 | 21.97 |
| Density (g/cm³) | 3.857 | 3.872 | 3.846 | 3.777 | 3.738 | 3.798 | 3.749 |
| Composition | 101 | 102 | 103 | 104 | 105 | 106 | 107 |
| SiO₂ | 61.00 | 61.00 | 60.99 | 61.00 | 61.00 | 61.00 | 65.00 |
| Al₂O₃ | 1.00 | 1.00 | 1.00 | 3.00 | 1.00 | 1.00 | 1.00 |
| B₂O₃ | 2.00 | 2.00 | 2.00 | 2.00 | 2.00 | 2.00 | 2.00 |
| Ta₂O₅ | 11.00 | 10.00 | 11.00 | 11.00 | 11.00 | 10.00 | 10.00 |
| Li₂O | 12.00 | 12.00 | 12.00 | 11.00 | 12.00 | 12.00 | 11.00 |
| Na₂O | 9.97 | 9.97 | 9.97 | 8.97 | 9.97 | 9.97 | 8.97 |
| K₂O | 0 | 0 | 0 | 0 | 0 | 0 | 0 |
| MgO | 0 | 0 | 0 | 0 | 0 | 0 | 0 |
| CaO | 0.02 | 0.02 | 0.03 | 0.02 | 0.02 | 0.02 | 0.02 |
| SnO₂ | 0 | 0 | 0 | 0 | 0 | 0 | 0 |
| Other | 1 Y₂O₃ | 2 Y₂O₃ | 1 La₂O₃ | 1 La₂O₃ | 2 Nb₂O₅ | 2 Nb₂O₅ | 2 Nb₂O₅ |
| | 2 Nb₂O₅ | 1 Nb₂O₅ | 2 Nb₂O₅ | 2 Nb₂O₅ | 1 ZrO₂ | 1 ZrO₂ | |
| | | | | | | 0.01 TiO₂ | |
| RO | 0.02 | 0.02 | 0.03 | 0.02 | 0.02 | 0.02 | 0.02 |
| R₂O | 21.97 | 21.97 | 21.97 | 19.97 | 21.97 | 21.97 | 19.97 |
| Density (g/cm³) | 3.809 | 3.745 | 3.847 | 3.803 | 3.798 | 3.712 | 3.651 |

| Composition | 108 | 109 | 110 | 111 | 112 | 113 | 114 |
|---|---|---|---|---|---|---|---|
| SiO₂ | 62.99 | 62.50 | 62.00 | 61.00 | 59.00 | 64.00 | 66.00 |
| Al₂O₃ | 0.02 | 0.50 | 1.00 | 2.00 | 4.00 | 1.00 | 1.00 |
| B₂O₃ | 3.00 | 3.00 | 3.00 | 3.00 | 3.00 | 3.00 | 3.00 |
| Ta₂O₅ | 14.00 | 14.00 | 14.00 | 14.00 | 14.00 | 13.00 | 12.00 |
| Li₂O | 11.00 | 11.00 | 11.00 | 11.00 | 11.00 | 10.50 | 10.00 |
| Na₂O | 8.97 | 8.97 | 8.97 | 8.97 | 8.97 | 8.47 | 7.97 |
| K₂O | 0 | 0 | 0 | 0 | 0 | 0 | 0 |
| MgO | 0 | 0 | 0 | 0 | 0 | 0 | 0 |
| CaO | 0.02 | 0.02 | 0.02 | 0.02 | 0.02 | 0.02 | 0.02 |
| SnO₂ | 0 | 0 | 0 | 0 | 0 | 0 | 0 |
| Other | — | — | — | — | — | — | |
| RO | 0.02 | 0.02 | 0.02 | 0.02 | 0.02 | 0.02 | 0.02 |
| R₂O | 19.97 | 19.97 | 19.97 | 19.97 | 19.97 | 18.97 | 17.97 |
| Density (g/cm³) | 3.975 | 3.969 | 3.969 | 3.946 | 3.926 | 3.839 | 3.717 |

| Composition | 115 | 116 | 117 | 118 | 119 | 120 | 121 |
|---|---|---|---|---|---|---|---|
| SiO₂ | 68.00 | 70.00 | 66.00 | 66.00 | 65.99 | 66.00 | 65.98 |
| Al₂O₃ | 1.00 | 1.00 | 1.00 | 1.00 | 0.02 | 1.00 | 0.02 |
| B₂O₃ | 3.00 | 3.00 | 3.00 | 3.00 | 3.00 | 1.00 | 0 |
| Ta₂O₅ | 11.00 | 10.00 | 10.00 | 8.00 | 8.00 | 8.00 | 8.00 |
| Li₂O | 9.50 | 9.00 | 10.00 | 10.00 | 10.50 | 11.00 | 12.00 |
| Na₂O | 7.48 | 6.98 | 7.98 | 7.98 | 8.47 | 8.97 | 9.97 |
| K₂O | 0 | 0 | 0 | 0 | 0 | 0 | 0 |
| MgO | 0 | 0 | 0 | 0 | 0 | 0 | 0 |
| CaO | 0.02 | 0.02 | 0.02 | 0.02 | 0.02 | 0.02 | 0.03 |
| SnO₂ | 0.0 | 0 | 0 | 0 | 0 | 0 | 0 |
| Other | — | — | 2 Nb₂O₅ | 4 Nb₂O₅ | 4 Nb₂O₅ | 4 Nb₂O₅ | 4 Nb₂O₅ |
| RC | 0.02 | 0.02 | 0.02 | 0.02 | 0.02 | 0.02 | 0.03 |
| R₂O | 16.98 | 15.98 | 17.98 | 17.98 | 18.97 | 19.97 | 21.97 |
| Density (g/cm³) | 3.627 | 6.509 | 3.623 | 3.482 | 3.511 | 3.509 | 3.544 |

| Composition | 122 | 123 | 124 | 125 |
|---|---|---|---|---|
| SiO₂ | 66 | 65.99 | 63.99 | 61.99 |
| Al₂O₃ | 1.00 | 0.02 | 0.02 | 0.02 |
| B₂O₃ | 1.00 | 2.00 | 2.00 | 0 |
| Ta₂O₅ | 8.00 | 8.00 | 8.00 | 8.00 |
| Li₂O | 10.00 | 9.99 | 11.00 | 11.99 |
| Na₂O | 7.98 | 7.98 | 8.97 | 9.97 |
| K₂O | 0 | 0 | 0 | 0 |
| MgO | 0 | 0 | 0 | 0 |
| CaO | 0.02 | 0.02 | 0.02 | 0.03 |
| SnO₂ | 0 | 0 | 0 | 0 |
| Other | 4 Nb₂O₅ | 4 Nb₂O₅ | 4 Nb₂O₅ | 4 Nb₂O₅ |
| | 2 ZrO₂ | 2 ZrO₂ | 2 ZrO₂ | 4 ZrO₂ |
| RO | 0.02 | 0.02 | 0.02 | 0.03 |
| R₂O | 17.98 | 17.97 | 19.97 | 21.96 |
| Density (g/cm³) | 3.539 | 3.543 | 3.581 | 3.649 |

Table I presents Compositions 1-125 as example core compositions. Example 1-13, 16-19, 21-24, 27-30, 32-45, 49-83, 84-88, and 90-117 have greater than or equal to 10.0 mol % Ta₂O₅. Compositions 1-15, 18-30, and 32-125 have greater than or equal to 5.0 mol % Na₂O. Example 69 contains K₂O while Compositions 1-68 and 70-125 are free of K₂O. Compositions 1-3, 23-24, 27-28, 32, 49-50, 58-93, 95-120, and 122-124 contain B₂O₃ while Compositions 4-22, 25-26,25-31, 33-49, 51-57, 94, 121, and 125 are free of B₂O₃. Compositions 73-125 contain RO (e.g., Ca) while Compositions 1-72 are free of RO. Compositions 4-10, 12, 14-17, 19-22, 25-30, 21, 33, 38, 40-57, 52-54, 70-71, 80-10⁷, and 117-125 contain one more of Fe₂O₃, CeO₂, ZrO₂, TiO₂, La₂O₃, Nb₂O₅, F⁻, WO₃, and/or Y₂O₃ that can color and/or increase the refractive index of the resulting glass-based material (e.g., in addition to Ta₂O₅). In particular, the high levels of Ta₂O₅ (and the relatively low levels of Al₂O₃ of generally less than or equal to 4.0 mol %) in these example compositions enable the resulting glass-based material to be stable with even relatively high amounts of such additives (e.g., greater than or equal to 4.0 mol % of one or more of TiO₂, Nb₂O₅, and/or La₂O₃).

TABLE II
Composition and Properties for Cladding Compositions

| Composition | 201 | 202 | 203 | 204 | 205 | 206 | 207 |
|---|---|---|---|---|---|---|---|
| SiO₂ | 60.76 | 63.76 | 58.75 | 60.75 | 62.75 | 65.05 | 67.05 |
| Al₂O₃ | 14.87 | 12.86 | 17.86 | 15.86 | 13.86 | 15.56 | 13.56 |
| B₂O₃ | 6.23 | 7.23 | 4.22 | 4.22 | 4.22 | 3.23 | 3.23 |
| Li₂O | 7.21 | 6.21 | 7.71 | 7.7 | 7.7 | 7.26 | 7.25 |
| Na₂O | 8.2 | 7.21 | 8.7 | 8.7 | 8.7 | 4.89 | 4.89 |
| P₂₀₅ | 1.47 | 1.47 | 1.47 | 1.47 | 1.47 | 0.9 | 0.9 |
| MgO | 1.2 | 1.2 | 1.2 | 1.2 | 1.2 | 0.55 | 0.55 |
| CaO | 0 | 0.02 | 0.04 | 0.04 | 0.03 | 2.5 | 2.5 |
| SnO₂ | 0.05 | 0.05 | 0.05 | 0.05 | 0.05 | 0.05 | 0.05 |
| Fe₂O₃ | 0.01 | 0 | 0.01 | 0.01 | 0.01 | 0.01 | 0.01 |
| Other | — | — | — | — | — | — | — |
| RO | 1.2 | 1.22 | 1.24 | 1.24 | 1.23 | 3.05 | 3.05 |
| R₂O | 15.41 | 13.42 | 16.41 | 16.4 | 16.4 | 12.15 | 12.14 |
| CTE (10⁻⁷/° C.) | 73.4 | 66.1 | 73.4 | 75.6 | 78.5 | 59.5 | 61.9 |
| Strain Point (° C.) | 511 | 504 | 553 | 526 | 519 | 591 | 561 |
| Annealing Point | 556 | 551 | 601 | 573 | 566 | 641 | 610 |
| (° C.) | | | | | | | |
| Composition | 208 | 209 | 210 | 211 | 212 | 213 | 214 |
| SiO₂ | 69.05 | 58.75 | 60.74 | 62.75 | 65.04 | 67.06 | 69.05 |
| Al₂O₃ | 11.56 | 17.86 | 15.86 | 13.86 | 15.57 | 13.56 | 11.56 |
| B₂O₃ | 3.23 | 5.69 | 5.70 | 5.69 | 4.13 | 4.13 | 4.13 |
| Li₂O | 7.25 | 7.70 | 7.71 | 7.71 | 7.25 | 7.25 | 7.26 |
| Na₂O | 4.89 | 8.70 | 8.70 | 8.70 | 4.89 | 4.89 | 4.89 |
| P₂₀₅ | 0.9 | 0 | 0 | 0 | 0 | 0 | 0 |
| MgO | 0.55 | 1.20 | 1.20 | 1.20 | 0.55 | 0.55 | 0.55 |
| CaO | 2.50 | 0.04 | 0.04 | 0.04 | 2.50 | 2.50 | 2.50 |
| SnO₂ | 0.05 | 0.05 | 0.05 | 0.05 | 0.05 | 0.05 | 0.05 |
| Fe₂O₃ | 0.01 | 0.01 | 0.01 | 0.01 | 0.01 | 0.01 | 0.01 |
| Other | — | | — | — | — | — | — |
| RO | 3.05 | 1.24 | 1.24 | 1.24 | 3.05 | 3.05 | 3.05 |
| R₂O | 12.14 | 16.4 | 16.41 | 16.41 | 12.14 | 12.14 | 12.15 |
| CTE (10⁻⁷/° C.) | 62.3 | 74.6 | 76.8 | 77.3 | 59.1 | 59.9 | 60.7 |
| Density (g/cm³) | | 2.402 | 2.399 | 2.399 | 2.399 | 2.389 | 2.387 |
| Strain Point (° C.) | 536 | 550 | 549 | 489 | 586 | 549 | 515 |
| Annealing Point | 586 | 597 | 597 | 530 | 636 | 597 | 560 |
| (° C.) | | | | | | | |
| Composition | 215 | 216 | 217 | 218 | 219 | 220 | 221 |
| SiO₂ | 62.74 | 64.75 | 64.22 | 61.79 | 63.79 | 62.74 | 64.75 |
| Al₂O₃ | 14.86 | 13.86 | 13.86 | 16.7 | 14.7 | 14.86 | 13.86 |
| B₂O₃ | 4.22 | 4.22 | 4.22 | 3.73 | 3.73 | 4.22 | 4.22 |
| Li₂O | 7.20 | 6.70 | 7.70 | 7.50 | 7.50 | 7.20 | 6.70 |
| Na₂O | 8.20 | 7.70 | 8.70 | 6.89 | 6.89 | 8.20 | 7.70 |
| P₂₀₅ | 1.47 | 1.47 | 0 | 1.16 | 1.16 | 1.47 | 1.47 |
| MgO | 1.20 | 1.2 | 1.20 | 2.12 | 2.12 | 1.20 | 1.20 |
| CaO | 0.03 | 0.03 | 0.04 | 0.04 | 0.04 | 0.03 | 0.03 |
| SnO₂ | 0.05 | 0.05 | 0.05 | 0.05 | 0.05 | 0.05 | 0.05 |
| Fe₂O₃ | 0.01 | 0.01 | 0.01 | 0.01 | 0.01 | 0.01 | 0.01 |
| Other | 0.01 | 0.01 | 0.01 | 0.01 | 0.01 | 0.01 | 0.01 |
| | NaCl | NaCl | NaCl | NaCl | NaCl | NaCl | NaCl |
| RO | 1.23 | 1.23 | 1.24 | 2.16 | 2.16 | 2.16 | 1.2 |
| R₂O | 15.4 | 14.4 | 16.4 | 14.39 | 14.39 | 14.39 | 15.41 |
| CTE (10−7/° C.) | 72.8 | 69.7 | 76.1 | 65.2 | 68.5 | 71.1 | 72.9 |
| Strain Point (° C.) | 526 | 529 | 497 | 569 | 544 | 528 | 492 |
| Annealing Point | 575 | 578 | 540 | 617 | 593 | 576 | 536 |
| (° C.) | | | | | | | |
| Composition | 222 | 223 | 224 | 225 | 226 | 227 | 228 |
| SiO₂ | 62.75 | 60.77 | 62.75 | 62.76 | 59.76 | 60.76 | 61.76 |
| Al₂O₃ | 14.86 | 14.87 | 14.86 | 14.87 | 14.87 | 14.36 | 13.86 |
| B₂O₃ | 5.42 | 4.22 | 4.22 | 4.22 | 7.23 | 7.23 | 7.23 |
| Li₂O | 7.21 | 7.21 | 7.2 | 6.71 | 7.21 | 6.96 | 6.71 |
| Na₂O | 8.20 | 8.20 | 8.20 | 8.70 | 8.20 | 7.95 | 7.70 |
| P₂₀₅ | 1.47 | 3.47 | 2.67 | 1.47 | 1.47 | 1.47 | 1.47 |
| MgO | 0.03 | 1.20 | 0.03 | 1.20 | 1.20 | 1.20 | 1.20 |
| CaO | 0 | 0 | 0 | 0 | 0 | 0 | 0 |
| SnO₂ | 0.05 | 0.05 | 0.05 | 0.05 | 0.05 | 0.05 | 0.05 |
| Fe₂O₃ | 0.01 | 0.01 | 0.01 | 0.01 | 0.01 | 0.01 | 0.01 |
| Other | | — | — | — | 0.01 | 0.01 | 0.01 |
| | | | | | NaCl | NaCl | NaCl |
| RO | 0.03 | 1.20 | 0.03 | 1.20 | 1.20 | 1.20 | 1.20 |
| R₂O | 15.41 | 15.41 | 15.4 | 15.41 | 15.41 | 14.91 | 14.41 |
| CTE (10⁻⁷/° C.) | 73.3 | 73.4 | 73.3 | 73.4 | 72.8 | 71.5 | 70.7 |
| Strain Point (° C.) | 522 | 518 | 527 | 528 | 499 | 503 | 499 |
| Annealing Point | 570 | 566 | 577 | 578 | 542 | 548 | 544 |
| (° C.) | | | | | | | |

| Composition | 229 | 230 | 231 | 232 | 233 | 234 | 235 |
|---|---|---|---|---|---|---|---|
| SiO₂ | 60.77 | 62.23 | 60.76 | 60.77 | 61.69 | 61.24 | 59.74 |
| Al₂O₃ | 14.86 | 14.87 | 14.87 | 14.87 | 14.61 | 14.5 | 14.61 |
| B₂O₃ | 7.23 | 7.23 | 8.7 | 6.23 | 4.15 | 4.12 | 6.12 |
| Li₂O | 6.71 | 6.71 | 6.71 | 7.22 | 7.13 | 7.08 | 7.08 |
| Na₂O | 7.7 | 7.7 | 7.7 | 8.2 | 8.06 | 8.01 | 8.06 |
| P₂O₅ | 1.47 | 0 | 0 | 1.47 | 1.45 | 1.44 | 1.45 |
| MgO | 1.2 | 1.2 | 1.2 | 1.19 | 1.18 | 1.17 | 1.18 |
| CaO | 0 | 0 | 0 | 0 | 0 | 0 | 0.03 |
| SnO₂ | 0.05 | 0.05 | 0.05 | 0.05 | 0 | 0 | 0 |
| Fe₂O₃ | 0.01 | 0.01 | 0.01 | 0 | 0.74 | 0.49 | 0.74 |
| TiO₂ | 0 | 0 | 0 | 0 | 0.98 | 1.95 | 0.98 |
| Other | — | — | — | — | — | — | — |
| RO | 1.20 | 1.20 | 1.20 | 1.19 | 1.18 | 1.17 | 1.21 |
| R₂O | 14.41 | 14.41 | 14.41 | 15.42 | 15.19 | 15.09 | 15.14 |
| CTE (10⁻⁷/° C.) | 69.2 | 68.3 | 68.5 | | | | |
| Strain Point (° C.) | 510 | 522 | 507 | | | | |
| Annealing Point | 556 | 569 | 553 | | | | |
| (° C.) | | | | | | | |

| Composition | 236 | 237 | 238 | 239 | 240 | 241 | 242 |
|---|---|---|---|---|---|---|---|
| SiO₂ | 59.59 | 59.29 | 59.00 | 58.72 | 58.44 | 59.44 | 59.30 |
| Al₂O₃ | 14.58 | 14.51 | 14.44 | 14.37 | 14.30 | 14.54 | 14.51 |
| B₂O₃ | 6.11 | 6.08 | 6.05 | 6.02 | 5.99 | 6.09 | 6.08 |
| Li₂O | 7.07 | 7.03 | 7.00 | 6.96 | 6.93 | 7.05 | 7.03 |
| Na₂O | 8.04 | 8.00 | 7.97 | 7.93 | 7.89 | 8.02 | 8.00 |
| P₂₀₅ | 1.44 | 1.44 | 1.43 | 1.42 | 1.42 | 1.44 | 1.44 |
| MgO | 1.18 | 1.17 | 1.17 | 1.16 | 1.16 | 1.18 | 1.17 |
| CaO | 0.03 | 0.03 | 0.03 | 0.03 | 0.03 | 0.03 | 0.03 |
| SnO₂ | 0 | 0 | 0 | 0 | 0 | 0 | 00 |
| Fe₂O₃ | 0.98 | 1.47 | 0.97 | 1.45 | 1.93 | 0.98 | 0.98 |
| TiO₂ | 0.98 | 0.98 | 1.94 | 1.93 | 1.93 | 0.98 | 0.98 |
| Other | 0.01 NaCl | 0.01 NaCl | 0.01 NaCl | 0.01 NaCl | 0.01 NaCl | 0.01 NaCl | 0.01 NaCl |
| | | | | | | 0.12 Co₃O₄ | 0.24 Co₃O₄ |
| RO | 1.21 | 1.20 | 1.20 | 1.19 | 1.19 | 1.21 | 1.20 |
| R₂O | 15.11 | 15.03 | 14.97 | 14.89 | 14.82 | 15.07 | 15.03 |
| CTE (10⁻⁷/° C.) | 72.8 | 69.7 | 76.1 | 65.2 | 68.5 | 71.1 | 72.9 |
| Strain Point (° C.) | 526 | 529 | 497 | 569 | 544 | 528 | 492 |
| Annealing Point | 575 | 578 | 540 | 617 | 593 | 576 | 536 |
| (° C.) | | | | | | | |

| Composition | 243 | 244 | 245 | 246 | 247 | 248 |
|---|---|---|---|---|---|---|
| SiO₂ | 59.01 | 59.3 | 59.01 | 59.3 | 59.59 | 59.01 |
| Al₂O₃ | 14.44 | 14.51 | 14.44 | 14.51 | 14.58 | 14.44 |
| B₂O₃ | 6.05 | 6.08 | 6.05 | 6.08 | 6.11 | 6.05 |
| Li₂O | 7 | 7.03 | 7 | 7.03 | 7.07 | 7 |
| Na₂O | 7.96 | 8.01 | 7.97 | 8.01 | 8.05 | 7.97 |
| P₂₀₅ | 1.43 | 1.44 | 1.43 | 1.44 | 1.44 | 1.43 |
| MgO | 1.17 | 1.17 | 1.17 | 1.17 | 1.18 | 1.17 |
| CaO | 0.03 | 0.02 | 0.02 | 0.02 | 0.02 | 0.02 |
| SnO₂ | 0 | 0 | 0 | 0 | 0 | 0 |
| Fe₂O₃ | 0.97 | 1.47 | 1.94 | 1.95 | 1.96 | 2.92 |
| TiO₂ | 0.97 | 0.98 | 0.97 | 0.49 | 0 | 0 |
| Other | 0.01 NaCl | — | — | — | — | — |
| | 0.49 Co₃O₄ | | | | | |
| RO | 1.2 | 1.19 | 1.19 | 1.19 | 1.2 | 1.19 |
| R₂O | 14.96 | 15.04 | 14.97 | 15.04 | 15.12 | 14.97 |
| CTE (10⁻⁷/° C.) | 71.7 | 72.8 | 71.5 | 72.1 | 70.6 | 72.5 |
| Strain Point (° C.) | 500 | 499 | 502 | 494 | 492 | 498 |
| Annealing Point | 540 | 540 | 546 | 537 | 533 | 540 |
| (° C.) | | | | | | |

| Composition | 249 | 250 | 251 | 252 |
|---|---|---|---|---|
| SiO₂ | 59.3 | 59.01 | 59.59 | 59.02 |
| Al₂O₃ | 14.51 | 14.44 | 14.58 | 14.44 |
| B₂O₃ | 6.08 | 6.05 | 6.11 | 6.05 |
| Li₂O | 7.03 | 7 | 7.07 | 7 |
| Na₂O | 8.01 | 7.97 | 8.05 | 7.97 |
| P₂O₅ | 1.44 | 1.43 | 1.44 | 1.43 |
| MgO | 1.17 | 1.17 | 1.18 | 1.17 |
| CaO | 0.02 | 0.02 | 0.02 | 0.02 |
| SnO₂ | 0 | 0 | 0 | 0 |
| Fe₂O₃ | 1.47 | 1.46 | 1.47 | 1.46 |
| TiO₂ | 0.49 | 0.49 | 0 | 0.49 |
| Other | 0.49 Co₃O₄ | 0.97 Co₃O₄ | 0.49 Co₃O₄ | 0.49 Co₃O₄ |
| RO | 1.19 | 1.19 | 1.2 | 1.19 |
| R₂O | 15.04 | 14.97 | 15.12 | 14.97 |
| CTE (10⁻⁷/° C.) | 70.1 | 70.4 | 71.1 | 70.8 |
| Strain Point (° C.) | 492 | 498 | 497 | 496 |
| Annealing Point | 533 | 539 | 539 | 539 |
| (° C.) | | | | |

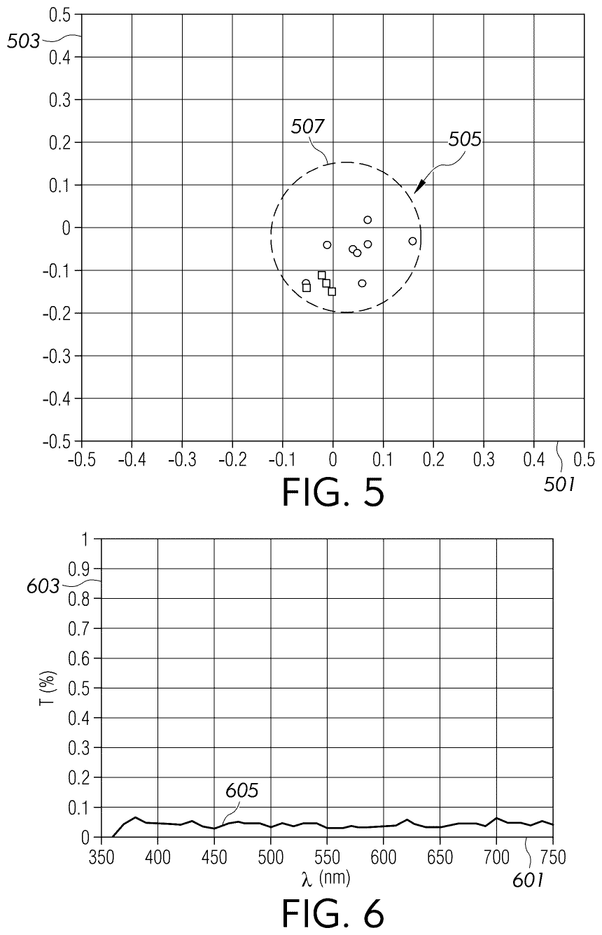

Table II presents Compositions 201-152 as example cladding compositions. Compositions 201-232 have less than 0.3 mol % Fe₂O₃ while Compositions 233-252 contain greater than or equal to 0.3 mol % Fe₂O₃. Also, Compositions 233-246, 249-250, and 252 contain TiO₂ (in combination with Fe₂O₃), and Compositions 241-243 and 249-252 contain Co₃O₄ (in combination with Fe₂O₃)—both of which function to decrease transmittance through scattering light, absorbing light, or both. It is expected that compositions 201-232 could be modified by adding 0.3 mol % Fe₂O₃ to achieve the color coordinates and/or transmittance described below with reference to FIGS. 5-6.

FIGS. 5-6 present optical properties for exemplary glass-based materials having compositions within the ranges discussed above for the cladding composition (e.g., Compositions 233-252 in Table II). FIG. 5 schematically shows CIE color coordinates with CIE a* values on the horizontal axis 501 (e.g., x-axis) and CIE b* values on the vertical axis 503 (e.g., y-axis) for example cladding compositions. Specifically, Compositions 235-243 were measured. The points 505 shown in squares were heat treated (1) at 620° C. for 4 hours followed by (2) at 675° C. for 4 hours, which developed a black color in the compositions, and then further heated (3) at 925° C. for 25 minutes, which mimics the conditions that may be encountered during redrawing (step 1005). The points 505 shown in circles were heat treated by first being (1) heating at 925° C. for 25 minutes, which mimics the conditions that may be encountered during redrawing (step 1005), and then (2) heated at 620° C. for 4 hours followed by (3) at 675° C. for 4 hours. As shown, the points shown in squares are in the third quadrant (i.e., negative a* and negative b*) but within 0.1 units of the origin (i.e., 0,0). Overall, the difference on the color coordinates is relatively small (e.g., less than 0.3 units on the a*, b* plane). As shown, the points 505 fall within the dashed circle 507 that is less than 0.2 CIE color units (a*, b*) from the origin (0, 0). Indeed, all of the points 505 are from −0.2 to 0.2 CIE a* and from −0.2 to 0.2 CIE b*. Indeed, the points 505 have a CIE a* value from −0.1 to 0.2 and a CIE b* value from −0.2 to 0.1. In combination with the low transmittance (discussed below with reference to FIG. 6), the near-zero CIE a* and b* values appear black, which can be aesthetically pleasing. FIG. 6 schematically shows transmittance in % on the vertical axis 603 (e.g., y-axis) as a function of optical wavelength in nanometer (nm) on the horizontal axis 601 (e.g., x-axis) for an example cladding composition, namely Composition 235. For curve 605, Composition 235 was heat treated (1) at 620° C. for 4 hours followed by (2) at 675° C. for 4 hours, which developed a black color in the compositions, and then further heated (3) at 925° C. for 25 minutes. As shown, the maximum transmittance (through a sample having a thickness of 0.7 mm) over the measured optical wavelengths (e.g., from 370 nm to 750 nm, from 400 nm to 700 nm) is less than 5%, less than 1%, less than 0.5%, and less than 0.1%. Consequently, the average transmittance over optical wavelengths from 400 nm to 700 nm (or from 370 nm to 750 nm) is also within those ranges (e.g., 0.1%). Providing a cladding composition with very low (e.g., less than 5%, less than 1%, less than 0.5%, and less than 0.1%) average transmittance as a cladding material in a waveguide can prevent cross-talk between adjacent structures of the core material and/or block ambient light from reaching the core material through a side of the waveguide (e.g., a surface other than the major surfaces that the waveguide is configured to couple light in and/or out of the core material at).

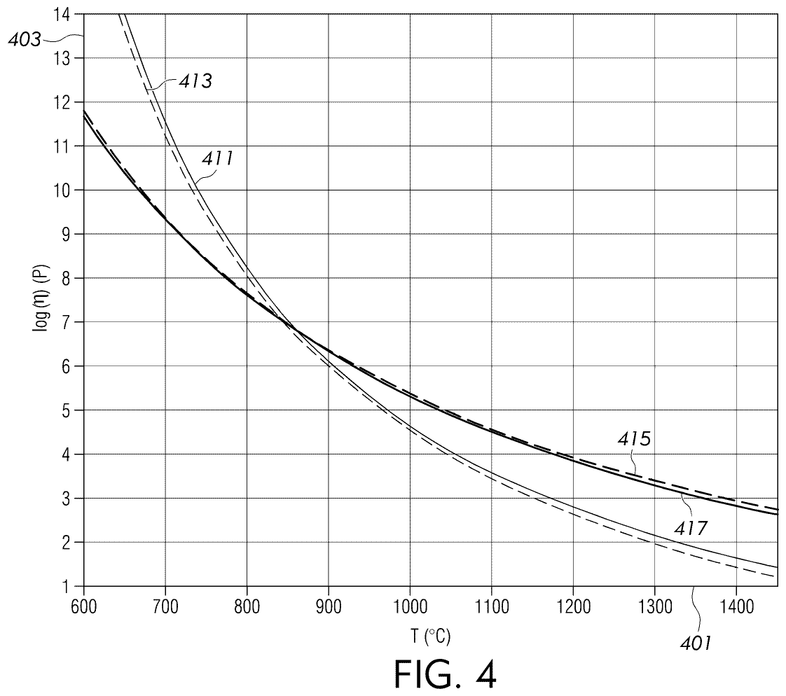

FIG. 4 schematically shows viscosity curves, where the logarithm of viscosity in poise (P) on the vertical axis 403 (e.g., y-axis) is presented as a function of temperature in ° C. on the horizontal axis 401 (e.g., x-axis) for exemplary pairs of glass compositions. In FIG. 4, curves 411 and 413 correspond to core compositions; specifically, curve 411 corresponds to Composition 1 (Table I) and curve 413 corresponds to Composition 2 (Table I). Curves 415 and 417 correspond to cladding compositions; specifically, curve 415 corresponds to Composition 202 (Table II) and curve 417 corresponds to Composition 201 (Table II). As shown, the curves 411 and 413 for these core compositions (Compositions 1-2) intersect the curves 415 and 417 for the cladding compositions (Compositions 201-202) at about 10⁷ Poise (10⁶ Pascal-seconds). Also, the viscosity curves for the core compositions are within a factor of 10 (in Poise or Pascal-seconds correspond to 1 log unit) from about 750° C. to about 1150° C.

Exemplary waveguides were formed using: (1) Composition 1 as the core composition and Composition 202 as the cladding composition and (2) Composition 2 as the core composition and Composition 201 as the cladding composition. An assembly having a rod of the core material (core composition) surrounded by the cladding material (cladding composition as a preform with two holes for two rods of the core material) was redrawn to a consolidated assembly with a maximum cross-sectional dimension of the core material greater than or equal to 1.0 mm and a maximum cross-sectional dimension of the cladding material (and overall consolidated assembly) greater than 10.0 mm and thermally conditioned to lower a temperature (and increase a viscosity) of the materials in the consolidated assembly to form the waveguide. Both of these exemplary waveguide were successfully formed and was able to couple light into and out of the core material. This unexpectedly demonstrates that that a close viscosity match (e.g., within a factor from 0.01 to 100 or from 0.1 to 10) in a range from 10⁵ Pascal-seconds to 10⁷ Pascal-seconds (e.g., when the clad composition has a viscosity of 10⁶ Pascal-seconds) is sufficient for the compositions to be redrawn and subsequently cooled together (regardless of a ratio between the viscosities at other points). Other combinations of materials as a core material and a cladding material (where the viscosity curves did not match in the range from 10⁵ Pascal-seconds to 10⁷ Pascal-seconds) were unable to be formed into waveguides because the consolidated assemblies shattered during the thermal conditioning process. When thermal conditioning was not used, the rods shattered during cooling. It is believed that the shattering was the result of large thermally-induced stresses that developed when the outside of the consolidated assembly cooled faster than the inside.

FIG. 7 schematically shows stress profiles with stress (a) in MegaPascals (MPa) on the vertical axis 703 (e.g., y-axis) versus position (x) along a thickness (e.g., diameter) in millimeters (mm) of the sample on the horizontal axis 701 (e.g., x-axis)) for samples that were chemically strengthened an a molten salt bath of 100 wt % NaNO₃ maintained at 390° C. for 16 hours. Composition 27-33 (Table 1) correspond to Articles C25-230 (Table III), and Articles C25-C28 have a thickness of about 0.7 mm wile Articles C29-C30 have a thickness of about 0.55 mm. Specifically, in FIG. 7, curve 711 corresponds to Composition 27, curve 713 corresponds to Composition 28, curve 715 corresponds to Composition 29, curve 717 corresponds to Composition 30, curve 719 corresponds to Composition 31, curve 721 corresponds to Composition 32, and curve 723 corresponds to Composition 33. As shown in FIG. 7, Compositions 27-33 (curves 711, 713, 715, 717, 719, 721, and 723) exhibit a maximum central tensile stress (central tension) greater than or equal to 100 MPa. Further, curves 711, 713, and 719 exhibit a central tension greater than or equal to 150 MPa with curves 711 and 713 having a central tension greater than or equal to 200 MPa.

Table III presents the chemical strengthening conditions and resulting properties of glass-based substrates having core compositions. Specifically, Table III presents Articles C1-C104 that correspond to glass-based substrates of Compositions 3-30, 32-71, and 81-125 (see Table I) with the thickness stated in Table III that were chemically strengthened using the conditions stated in Table III (immersed in the molten salt solution for the “IOX time”) in a molten salt solution of NaNO₃ to form glass-based articles with the central tension (CT) and depth of compression (DOC) reported in Table III. Also, the stress optical coefficient (SOC) is reported in Table III since this property is used to translate the measured signals into the reported properties. As discussed above, SOC is measured according to Procedure C (Glass Disc Method) described in ASTM standard C770-16. The time (“IOX time”) that the glass-based substrates were immersed in the molten salt solution (molten NaNO₃ maintained at 390° C.) ranged from 4 hours to 28 hours, as reported in Table III. The reported CT values (Table III) for the resulting glass-based articles ranged from 35 MPa to 293 MPa (e.g., from greater than or equal to 30 MPa to less than or equal to 300 MPa). The reported DOC values (Table III) for the resulting glass-based articles ranged from 86 μm to 372 μm.

TABLE III
Articles with Core Compositions Chemically Strengthened in
a 100 wt % NaNO₃ molten salt solution maintained at 390° C.

| Article | C1 | C2 | C3 | C4 | C5 | C6 | C7 | C8 |
|---|---|---|---|---|---|---|---|---|
| Composition | 3 | 4 | 5 | 6 | 7 | 8 | 9 | 10 |
| Thickness (mm) | 0.71 | 0.76 | 0.72 | 0.74 | 0.76 | 0.73 | 0.61 | 0.61 |
| IOX time (h) | 12 | 8 | 8 | 24 | 8 | 24 | 16 | 16 |
| SOC (nm/cm/MPa) | 35.9 | 35.4 | 36.7 | 25.8 | 35.5 | 32.6 | 33.7 | 34.8 |
| CT (MPa) | 181.4 | 158.5 | 148.0 | 95.8 | 174.3 | 134.4 | 172.7 | 123.7 |
| DOC (μm) | 165 | 185 | 173 | 96 | 198 | 101 | 169 | 164 |
| Article | C9 | C10 | C11 | C12 | C13 | C14 | C15 | C16 |
| Composition | 11 | 12 | 13 | 14 | 15 | 16 | 17 | 18 |
| Thickness (mm) | 0.61 | 0.61 | 0.61 | 0.61 | 0.70 | 0.70 | 0.69 | 0.75 |
| IOX time (h) | 16 | 16 | 8 | 8 | 16 | 16 | 16 | 16 |
| SOC (nm/cm/MPa) | 36.1 | 35.2 | 32.3 | 29.4 | 32.75 | 32.3 | 29.4 | 33.1 |
| CT (MPa) | 118.8 | 114.7 | 133.2 | 129.4 | 109.2 | 154.7 | 214.4 | 293.3 |
| DOC (μm) | 157 | 168 | 92 | 111 | 172 | 176 | 164 | 216 |
| Article | C17 | C18 | C19 | C20 | C21 | C22 | C23 | C24 |
| Composition | 19 | 20 | 21 | 22 | 23 | 24 | 25 | 26 |
| Thickness (mm) | 0.75 | 0.75 | 0.74 | 0.75 | 0.80 | 0.76 | 0.81 | 0.81 |
| IOX time (h) | 16 | 16 | 16 | 16 | 16 | 16 | 16 | 16 |
| SOC (nm/cm/MPa) | 34.1 | 34.9 | 36.1 | 36.6 | 33.6 | 34.0 | 33.7 | 31.3 |
| CT (MPa) | 229.7 | 212.7 | 179.6 | 166.6 | 292.3 | 290.1 | 172.7 | 195.0 |
| DOC (μm) | 204 | 194 | 196 | 198 | 224 | 220 | 188 | 196 |
| Article | C25 | C26 | C27 | C28 | C29 | C30 | C31 | C32 |
| Composition | 27 | 28 | 29 | 30 | 32 | 33 | 34 | 35 |
| Thickness (mm) | 0.68 | 0.69 | 0.73 | 0.71 | 0.55 | 0.57 | 0.64 | 0.73 |
| IOX time (h) | 16 | 16 | 16 | 16 | 8 | 8 | 8 | 8 |
| SOC (nm/cm/MPa) | 34.0 | 33.6 | 33.8 | 34.4 | 34.7 | 33.9 | 34.6 | 34.5 |
| CT (MPa) | 243.4 | 202.9 | 144.0 | 133.5 | 152.4 | 123.8 | 88.2 | 134.5 |
| DOC (μm) | 113 | 117 | 114 | 135 | 106 | 108 | 105 | 130 |
| Article | C33 | C34 | C35 | C36 | C37 | C38 | C39 | C40 |
| Composition | 36 | 37 | 38 | 39 | 40 | 41 | 42 | 43 |
| Thickness (mm) | 0.73 | 0.75 | 0.73 | 0.75 | 0.72 | 0.68 | 0.70 | 0.66 |
| IOX time (h) | 8 | 8 | 8 | 8 | 16 | 16 | 16 | 16 |
| SOC (nm/cm/MPa) | 32.6 | 33.9 | 34.5 | 33.9 | 34.0 | 34.5 | 34.5 | 35.1 |
| CT (MPa) | 116.7 | 135.9 | 127.4 | 152.3 | 137.7 | 116.3 | 140.4 | 110.6 |
| DOC (μm) | 112 | 130 | 112 | 128 | 115 | 111 | 128 | 104 |
| Article | C41 | C42 | C43 | C44 | C45 | C46 | C47 | C48 |
| Composition | 44 | 45 | 46 | 47 | 48 | 49 | 50 | 51 |
| Thickness (mm) | 0.66 | 0.66 | 0.69 | 0.69 | 0.67 | 0.65 | 0.64 | 0.66 |
| IOX time (h) | 16 | 16 | 16 | 16 | 16 | 16 | 16 | 16 |
| SOC (nm/cm/MPa) | 35.6 | 34.6 | 34.8 | 23.3 | 24.5 | 35.5 | 35.5 | 36.2 |
| CT (MPa) | 118.9 | 103.7 | 113.0 | | 35.1 | 149.4 | 138.8 | 120.3 |
| DOC (μm) | 116 | 118 | 125 | 87 | 372 | 117 | 101 | 117 |
| Article | C41 | C42 | C43 | C44 | C45 | C46 | C47 | C48 |
| Composition | 52 | 53 | 54 | 55 | 56 | 57 | 58 | 59 |
| Thickness (mm) | 0.65 | 0.64 | 0.66 | 0.67 | 0.64 | 0.61 | 0.70 | 0.71 |
| IOX time (h) | 16 | 16 | 16 | 16 | 16 | 16 | 16 | 12 |
| SOC (nm/cm/MPa) | 36.6 | 35.5 | 35.3 | 36.8 | 35.9 | 35.5 | 35.3 | 35.9 |
| CT (MPa) | 81.0 | 136.4 | 123.9 | 112.5 | 118.7 | 103.3 | 180.2 | 181.4 |
| DOC (μm) | 87 | 103 | 114 | 110 | 101 | 101 | 169 | 166 |
| Article | C49 | C50 | C51 | C52 | C53 | C54 | C55 | C56 |
| Composition | 60 | 61 | 62 | 63 | 64 | 65 | 66 | 67 |
| Thickness (mm) | 0.68 | 0.68 | 0.65 | 0.69 | 0.73 | 0.69 | 0.63 | 0.61 |
| IOX time (h) | 16 | 24 | 14 | 28 | 28 | 24 | 9 | 11 |
| SOC (nm/cm/MPa) | 35.5 | 36.3 | 36.8 | 33.5 | 33.6 | 33.6 | 35.9 | 35.2 |
| CT (MPa) | 182.3 | 192.3 | 204.8 | 162.9 | 173.5 | 157.9 | 187.1 | 169.3 |
| DOC (μm) | 184 | 165 | 163 | 172 | 176 | 155 | 135 | 119 |
| Article | C57 | C58 | C59 | C60 | C61 | C62 | C63 | C64 |
| Composition | 68 | 69 | 70 | 71 | 81 | 82 | 83 | 84 |
| Thickness (mm) | 0.67 | 0.64 | 0.67 | 0.65 | 0.69 | 0.69 | 0.72 | 0.70 |
| IOX time (h) | 9 | 24 | 17 | 18 | 16 | 16 | 16 | 8 |
| SOC (nm/cm/MPa) | 34.8 | 35.1 | 34.8 | 33.7 | 34.5 | 33.3 | 32.0 | 30.5 |
| CT (MPa) | 212.9 | 183.4 | 195.8 | 185.7 | 194.3 | 202.6 | 196.4 | 194.3 |
| DOC (μm) | 168 | 144 | 164 | 141 | 157 | 154 | 137 | 164 |
| Article | C65 | C66 | C67 | C68 | C69 | C70 | C71 | C72 |
| Composition | 85 | 86 | 87 | 88 | 89 | 90 | 91 | 92 |
| Thickness (mm) | 0.67 | 0.66 | 0.69 | 0.63 | 0.61 | 0.65 | 0.62 | 0.58 |
| IOX time (h) | 16 | 8 | 12 | 8 | 8 | 16 | 8 | 8 |
| SOC (nm/cm/MPa) | 35.8 | 37.5 | 35.3 | 36.3 | 30.5 | 32.8 | 33.3 | 34.0 |
| CT (MPa) | 201.9 | 177.2 | 188.3 | 173.4 | 197.8 | 197.8 | 199.4 | 180.9 |
| DOC (μm) | 148 | 145 | 160 | 156 | 153 | 129 | 155 | 137 |
| Article | C73 | C74 | C75 | C76 | C77 | C78 | C79 | C80 |
| Composition | 93 | 94 | 95 | 96 | 97 | 99 | 100 | 101 |
| Thickness (mm) | 0.59 | 0.66 | 0.64 | 0.61 | 0.60 | 0.57 | 0.55 | 0.56 |
| IOX time (h) | 8 | 4 | 8 | 8 | 8 | 8 | 8 | 8 |
| SOC (nm/cm/MPa) | 34.5 | 33.2 | 33.4 | 33.3 | 34.4 | 32.6 | 32.4 | 32.1 |
| CT (MPa) | 171.3 | 179.6 | 195.3 | 209.1 | 162.3 | 202.9 | 185.6 | 199.2 |
| DOC (μm) | 132 | 146 | 144 | 134 | 145 | 114 | 121 | 132 |
| Article | C81 | C82 | C83 | C84 | C85 | C86 | C87 | C88 |
| Composition | 102 | 103 | 104 | 105 | 106 | 107 | 108 | 109 |
| Thickness (mm) | 0.64 | 0.63 | 0.61 | 0.66 | 0.63 | 0.63 | 0.65 | 0.67 |
| IOX time (h) | 16 | 8 | 16 | 8 | 8 | 8 | 16 | 16 |
| SOC (nm/cm/MPa) | 31.4 | 31.7 | 31.8 | 32.7 | 32.6 | 32.6 | 34.6 | 34.6 |
| CT (MPa) | 209.4 | 189.3 | 176.4 | 203.8 | 221.0 | 179.8 | 193.2 | 196.2 |
| DOC (μm) | 146 | 135 | 123 | 135 | 132 | 139 | 118 | 135 |
| Article | C89 | C90 | C91 | C92 | C93 | C94 | C95 | C96 |
| Composition | 110 | 111 | 112 | 113 | 114 | 115 | 116 | 117 |
| Thickness (mm) | 0.65 | 0.66 | 0.66 | 0.62 | 0.63 | 0.63 | 0.66 | 0.67 |
| IOX time (h) | 16 | 16 | 16 | 16 | 16 | 16 | 16 | 16 |
| SOC (nm/cm/MPa) | 34.5 | 34.6 | 34.9 | 34.8 | 35.0 | 35.2 | 35.4 | 33.6 |
| CT (MPa) | 182.0 | 211.3 | 196.0 | 167.2 | 162.9 | 160.2 | 134.9 | 171.6 |
| DOC (μm) | 122 | 112 | 132 | 122 | 122 | 122 | 141 | 121 |
| Article | C97 | C98 | C99 | C100 | C101 | C102 | C103 | C104 |
| Composition | 118 | 119 | 120 | 121 | 122 | 123 | 124 | 125 |
| Thickness (mm) | 0.74 | 0.77 | 0.77 | 0.74 | 0.74 | 0.71 | 0.74 | 0.65 |
| IOX time (h) | 16 | 16 | 16 | 16 | 16 | 16 | 16 | 16 |
| SOC (nm/cm/MPa) | 32.1 | 31.8 | 31.1 | 30.7 | 32.3 | 32.3 | 31.7 | 31.0 |
| CT (MPa) | 180.8 | 177.8 | 180.9 | 172.7 | 171.9 | 184.9 | 193.2 | 195.9 |
| DOC (μm) | 150 | 144 | 153 | 152 | 154 | 146 | 148 | 124 |

Table IV presents the chemical strengthening conditions and resulting properties of glass-based substrates having cladding compositions. Specifically, Table IV presents Articles D1-D29 that correspond to glass-based substrates of Compositions 202-208 and 21-231 (see Table I) with the thickness stated in Table IV that were chemically strengthened using the conditions stated in Table III (immersed in the molten salt solution for the “IOX time”) in a molten salt solution of NaNO₃ to form glass-based articles with the central tension (CT) and depth of compression (DOC) reported in Table IV. Also, the stress optical coefficient (SOC) is reported in Table III since this property is used to translate the measured signals into the reported properties. As discussed above, SOC is measured according to Procedure C (Glass Disc Method) described in ASTM standard C770-16. The time (“IOX time”) that the glass-based substrates were immersed in the molten salt solution (molten NaNO₃ maintained at 390° C.) ranged from 4 hours to 24 hours, as reported in Table IV. The reported CT values (Table IV) for the resulting glass-based articles ranged from 35 MPa to 122 MPa (e.g., from greater than or equal to 30 MPa to less than or equal to 300 MPa, from 30 MPa to 230 MPa, or from 35 MPa to 125 MPa). The reported DOC values (Table IV) for the resulting glass-based articles ranged from 112 μm to 204 μm.

TABLE IV
Articles with Cladding Compositions Chemically Strengthened in
a 100 wt % NaNO₃ molten salt solution maintained at 390° C.

| Article | D1 | D2 | D3 | D4 | D5 | D6 | D7 | D8 |
|---|---|---|---|---|---|---|---|---|
| Composition | 202 | 203 | 204 | 205 | 206 | 207 | 208 | 210 |
| Thickness (mm) | 0.96 | 0.68 | 0.68 | 0.70 | 0.69 | 0.70 | 0.69 | 0.68 |
| IOX time (h) | 16 | 16 | 16 | 16 | 16 | 16 | 16 | 16 |
| SOC (nm/cm/MPa) | 32.8 | 30.6 | 30.85 | 30.8 | 3.7 | 60.65 | 31.1 | 30.05 |
| CT (MPa) | 86.0 | 98.4 | 88.5 | 56.0 | 105.8 | 96.2 | 34.5 | 105.5 |
| DOC (μm) | 185 | 149 | 151 | 136 | 162 | 155 | 122 | 132 |
| Article | D9 | D10 | D11 | D12 | D13 | D14 | D15 | D16 |
| Composition | 211 | 212 | 213 | 214 | 215 | 216 | 217 | 218 |
| Thickness (mm) | 0.68 | 0.70 | 0.70 | 0.70 | 0.71 | 0.71 | 0.73 | 0.67 |
| IOX time (h) | 16 | 16 | 16 | 16 | 16 | 16 | 16 | 16 |
| SOC (nm/cm/MPa) | 30.7 | 31.3 | 30.35 | 30.05 | 31.2 | 31.75 | 30.45 | 30.85 |
| CT (MPa) | 97.5 | 122.3 | 115.6 | 130.8 | 82.6 | 78.3 | 97.0 | 95.7 |
| DOC (μm) | 132 | 141 | 135 | 144 | 136 | 133 | 137 | 138 |
| Article | D17 | D18 | D19 | D20 | D21 | D22 | D23 | D24 |
| Composition | 219 | 220 | 221 | 222 | 223 | 224 | 225 | 226 |
| Thickness (mm) | 0.66 | 0.68 | 0.65 | 0.62 | 0.67 | 0.63 | 0.65 | 0.97 |
| IOX time (h) | 16 | 16 | 8 | 4 | 8 | 4 | 4 | 20 |
| SOC (nm/cm/MPa) | 31.2 | 31.4 | 32.5 | 32.3 | 31.55 | 32.1 | 31.35 | 32.1 |
| CT (MPa) | 88.8 | 76.3 | 92.5 | 91.2 | 83.9 | 83.0 | 88.1 | 96.1 |
| DOC (μm) | 128 | 112 | 144 | 131 | 138 | 121 | 139 | 204 |

| Article | D25 | D26 | D27 | D28 | D29 |
|---|---|---|---|---|---|
| Composition | 227 | 228 | 229 | 230 | 231 |
| Thickness (mm) | 0.94 | 0.96 | 1.01 | 0.97 | 0.94 |
| IOX time (h) | 20 | 20 | 17 | 17 | 24 |
| SOC (nm/cm/MPa) | 32.5 | 32.8 | 32.8 | 32.4 | 32.8 |
| CT (MPa) | 93.4 | 86.0 | 91.6 | 101.3 | 94.9 |
| 185 | 195 | 185 | 195 | 183 | 176 |

Additionally, an example waveguide was constructed using a polymer-containing material as the cladding material surrounding and attached to a glass-based core material. The core material was Composition 1 (Table I). The cladding material contains an epoxy resin formed by curing a precursor solution. The precursor solution for the polymer-containing material comprised: 29 wt % Nanopox C620 (available from Evonik), 43 wt % Lindride 5 (available from Lindau Chemicals), 23 wt % Celloxide 8010 (available from Daicel), 4 wt % Guardiant (available from Corning Incorporated), and 1 wt % Alumires (RC-3) black (available from Alumilite). Nanopox C620 comprises a cycloaliphatic resin (e.g., epoxy resin) and 40 parts by weight silica nanoparticles. Lindride 5 comprises linker compounds, namely methyltetrahydrophthalic anhydride and tetrahydrophthalic anhydride that can react with epoxy resins and monomers. Celloxide 8010 is an epoxy monomer. Guardiant is an antimicrobial, copper-containing glass-based material. The Alumires black is a colorant used to obtain a black color of the resulting polymer-containing material. A mold containing a rod of the core material was filled with the precursor solution and heated to cure the precursor solution to obtain the polymer-containing material cured around the core material that forms the waveguide. The polymer-containing material was visibly opaque and the transmittance was below detectable limits for optical wavelengths from 400 nm to 700 nm. Also, the antimicrobial nature of the polymer-containing material (e.g., cladding material described above in this paragraph—Example 1) was evaluated in the “EPA test” (defined above) using Staphylococcus bacteria relative to the epoxy resin without inclusion of Guradiant (Comparative Example AA). Comparative Example AA exhibited a logarithmic reduction of 1 while Example 1 exhibited a logarithmic reduction of 6. This demonstrates that the polymer-containing material is antimicrobial and can achieve a logarithmic reduction of at least 3, 4, 5, or 6.

The above observations can be combined to provide glass compositions that can be used in a waveguide (e.g., as part of an optical sensor). As discussed herein, the compositions are referred to as “core composition” and “cladding composition” for clarity without restricting the compositions to a particular function or application. The core composition can comprise one or more of: from greater than or equal to 1.5 mol % to less than or equal to 30 mol % Ta₂O₅ (e.g., in combination with from greater than or equal to 59 mol % to less than or equal to 80 mol % SiO₂, and/or non-zero amounts of Li₂O and/or Na₂O); a refractive index greater than or equal to 1.60; and/or a density greater than or equal to 3.0 g/cm³. The inventors of the present disclosure have unexpectedly found that Ta₂O₅ can be substituted for Al₂O₃ (e.g., relative to conventional ion-exchangeable glass-based compositions) while providing an increased refractive index (e.g., relative to using Al₂O₃). Unlike components typically used to increase refractive index (e.g., TiO₂, Nb₂O₅, ZrO₂), Ta₂O₅ can be included in relatively high amounts (e.g., greater than or equal to 1.5 mol %, greater than or equal to 7.0 mol %, or greater than or equal to 11.0 mol %) without destabilizing the glass-based composition (e.g., becoming prone to devitrification or phase separation). Further, compared to Al₂O₃, Ta₂O₅ can stabilize other high refractive index components. Ta₂O₅ can also enhance ion exchange. Also, Ta₂O₅ can increase a fracture toughness of the core composition. Providing a high transmittance (e.g., from 70% to 96%, from 80% to 96%, from 82% to 87%) core material (e.g., material having the core composition) can enable the transmission of signals therethrough, for example, when used a core of a waveguide. The cladding composition can comprise one or more of: from greater than or equal to 0.03 mol % to less than or equal to 5.0 mol % Fe₂O₃ (e.g., in combination with from greater than or equal to 4.5 mol % to less than or equal to 10 mol % Li₂O, and/or non-zero amounts of Li₂O and Na₂O); a refractive index less than or equal to 1.60; and/or a transmittance averaged over optical wavelength from 400 nm to 700 nm of less than or equal to 5%. Providing a low transmittance (e.g., 5% or less, less than 0.5%, less than 0.2%, less than 0.1%) of a cladding material (e.g., material formed from the cladding composition) can inhibit the transmission of signals therethrough, which can function to prevent cross-talk between signals in adjacent sections of core material separated by the cladding material (e.g., in a waveguide).

Waveguides in accordance with the present disclosure have a cladding material surrounding and attached to a core material, where the core material can be ion-exchangeable (e.g., chemically strengthened to have a central tension greater than or equal to 30 MPa, to less than or equal to 300 MPa, from greater than or equal to 50 MPa to less than or equal to 230 MPa, or from greater than or equal to 70 MPa to less than or equal to 180 MPa. The waveguide can have a high numerical aperture (e.g., greater than or equal to 0.5, from greater than or equal to 0.50 to less than or equal to 0.9, from greater than or equal to 0.60 to less than or equal to 0.85, or from greater than or equal to 0.65 to less than or equal to 0.80) with the core material having a higher refractive index than the cladding material and can enable the optical waveguide to receive (e.g., couple into an end) and transmit light due to the high acceptance angle, which can allow an end (e.g., major surface) of the waveguide to act as a lens refracting light to travel at a lower angle (e.g., relative to a longitudinal axis of the core)—thereby enabling the waveguide to collect more light and therefore more signal. Providing a sufficient distance (e.g., from 0.1 mm to 20 mm, from 0.2 mm to 15 mm, from 0.5 mm to 8 mm) between adjacent sections of the core material, cross-talk between signals traveling through the corresponding sections can be minimized, especially when the cladding material has low average transmittance (e.g., 5.0% or less, 0.5% or less). Additionally or alternatively, providing sufficient distance (e.g., 1.0 mm or more, from 1.0 mm to 20 mm, from 1.5 mm to 15 mm) between adjacent sections of the core material can enable the different core sections to convey significantly different information that may be collected through an end (e.g., major surface of the waveguide). In aspects, the cladding material can comprise a polymer-containing material that can in further aspects be antimicrobial and/or contain copper-containing glass-based material. Alternatively, in aspects, the cladding material can be a glass-based material that is ion-exchangeable (e.g., chemically strengthened to have a central tension greater than or equal to 30 MPa to less than or equal to 300 MPa, from greater than or equal to 50 MPa to less than or equal to 230 MPa, or from greater than or equal to 70 MPa to less than or equal to 180 MPa. In further aspects, both the core material and the cladding material can be chemically strengthened with respective central tensions greater than or equal to 30 MPa, from greater than or equal to 50 MPa to less than or equal to 300 MPa, from greater than or equal to 60 MPa to less than or equal to 230 MPa, or from greater than or equal to 70 MPa to less than or equal to 180 MPa. Providing a chemically strengthened cladding material can increase a scratch-resistance and/or other damage resistance of the waveguide.

Additionally, as discussed herein, the core composition and the cladding composition can have compatible viscosity profiles that allow both compositions to be redrawn together in a single assembly to form a consolidated assembly and/or a waveguide, where the cladding composition can circumferentially surround and be fused to the core composition, which can be formed as a rod. Unexpectedly, inventors of the present disclosure discovered that a close viscosity match (e.g., within a factor from 0.01 to 100 or from 0.1 to 10) in a range from 10⁵ Pascal-seconds to 10⁷ Pascal-seconds (e.g., when the clad composition has a viscosity of 10⁶ Pascal-seconds) is sufficient for the compositions to be redrawn and subsequently cooled together (regardless of a ratio between the viscosities at other points). Thermally conditioning the consolidated assembly can minimize a difference in thermally-induced stress in the consolidated assembly between the core material and the cladding material. Providing a low difference between coefficients of thermal expansion between the core material and the cladding material (e.g., an absolute value of the difference from 0×10⁻⁷° C.⁻¹ to 5×10⁻⁷° C.⁻¹, from 0×10⁻⁷° C.⁻¹ to 3×10⁻⁷° C.⁻¹, or from 1×10⁻⁷° C.⁻¹ to 2×10⁻⁷° C.⁻¹) can minimize an amount of thermal-induced stress in the waveguide, which can enable the waveguide to be reliably formed by redrawing, especially when the cladding material is a glass-based material and the maximum cross-sectional dimension of the waveguide is large (e.g., greater than or equal to 10.0 mm).

All compositional components, relationships, and ratios described in this specification are provided in mol % unless otherwise stated. All ranges disclosed in this specification include any and all ranges and subranges encompassed by the broadly disclosed ranges whether or not explicitly stated before or after a range is disclosed. Also, it is to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A waveguide comprising:
a core material comprising a glass-based material and a core refractive index; and
a cladding material comprising a glass-based material having a clad refractive index, the cladding material fused to and circumferentially surrounding the core material,
wherein the core refractive index is greater than the clad refractive index by from greater than or equal to 0.10 to less than or equal to 0.30, the core material is chemically strengthened and has a core compressive stress and a core central tension, the cladding material is chemically strengthened and has a clad compressive stress and a clad central tension, and the core central tension and the clad central tension are both from greater than or equal to 30 MPa to less than or equal to 300 MPa.

2. The waveguide of claim 1, wherein a transmittance of the cladding material averaged over optical wavelength from 400 nm to 700 nm is less than or equal to 5.0% for a thickness of 0.7 mm.

3. The waveguide of claim 1, wherein the cladding material comprises a polymer-containing material including an epoxy or an acrylic.

4. The waveguide of claim 1, wherein the cladding material comprises a glass-based material, and the cladding material is fused to the core material.

5. The waveguide of claim 4, wherein the cladding material is chemically strengthened and has a clad compressive stress and a clad central tension, and the core central tension and the clad central tension are both from greater than or equal to 30 MPa to less than or equal to 300 MPa.

6. The waveguide of claim 1, wherein the core refractive index is from greater than or equal to 1.60 and less than or equal to 1.80, and the clad refractive index is from greater than or equal to 1.45 to less than or equal to 1.55.

7. The waveguide of claim 1, wherein the waveguide exhibits a numerical aperture from greater than or equal to 0.55 to less than or equal to 0.90.

8. The waveguide of claim 1, wherein the core material and the cladding material are both free of arsenic, antimony, cadmium, mercury, selenium, and lead.

9. The waveguide of claim 1, wherein the core material has a core coefficient of thermal expansion, the cladding has a clad coefficient of thermal expansion, and an absolute value of a difference between the core coefficient of thermal expansion and the clad coefficient of thermal expansion is from greater than or equal to 0.0×10⁻⁷° C.⁻¹ to less than or equal to 5×10⁻⁷° C.⁻¹, wherein the clad coefficient of thermal expansion is from greater than or equal to 50×10⁻⁷° C.⁻¹ to less than or equal to 85×10⁻⁷° C.⁻¹.

10. The waveguide of claim 1, wherein the core material is formed as a rod, and a maximum cross-sectional dimension of the rod of the core material is from greater than or equal to 1.0 mm to less than or equal to 20 mm.

11. The waveguide of claim 1, wherein the core material is formed a plurality of rods separated from one another by the cladding material.

12. The waveguide of claim 11, wherein a minimum distance between an adjacent pair of rods of the plurality of rods is from greater than or equal to 1.0 mm to less than or equal to 20 mm.

13. The waveguide of any one of claim 1, wherein a maximum cross-sectional dimension of the waveguide is from greater than or equal to 10.0 mm to less than or equal to 100 mm.

14. The waveguide of claim 1, wherein the core material has a core density at 20° C., the cladding material has a clad density at 20° C., and the core density is greater than the clad density by from greater than or equal to 0.5 g/cm³ to less than or equal to 2.25 g/cm³.

15. The waveguide of claim 1, wherein the cladding material exhibits CIE color coordinates of:
a* from greater than or equal to −0.2 to less than or equal to 0.2; and
b* from greater than or equal to −0.3 to less than or equal to 0.1.

16. The waveguide of claim 1, wherein:
the cladding material is a boroaluminosilicate composition comprising from greater than or equal to 0.03 mol % to less than or equal to 5.0 mol % Fe₂O₃ based on 100 mol % of the boroaluminosilicate composition, and
the core material is a silicate glass comprising, based on 100 mol % of the core material:
from greater than or equal to 59 mol % to less than or equal to 80 mol % SiO₂; and
from greater than or equal to 1.5 mol % to less than or equal to 30 mol % Ta₂O₅.

17. A waveguide of claim 1, wherein the cladding material, based on 100 mol % of the cladding material, comprises:
from greater than or equal to 55 mol % to less than or equal to 80 mol % SiO₂;
from greater than or equal to 8.75 mol % to less than or equal to 18.0 mol % Al₂O₃;
from greater than or equal to 4.5 mol % to less than or equal to 10.0 mol % Li₂O;
from greater than or equal to 2.0 mol % to less than or equal to 14.0 mol % Na₂O; and
from greater than or equal to 0.5 mol % to less than or equal to 15.0 mol % B₂O₃.

18. The waveguide of claim 17, wherein the cladding material comprises:
from greater than or equal 11.0 mol % to less than or equal to 17.0 mol % R₂O, where R₂O is a total amount of Li₂O, Na₂O, K₂O, Cs₂O, and Rb₂O;
from greater than or equal to 0.0 mol % to less than or equal to 4.0 mol % RO, where RO is a total amount of MgO, CaO, SrO, and BaO; and
from greater than or equal to 0.03 to less than or equal to 3.0 mol % Fe₂O₃.

19. The waveguide of claim 1, wherein the core material comprises:
from greater than or equal to 59 mol % to less than or equal to 80 mol % SiO₂;
from greater than or equal to 1.5 mol % to less than or equal to 30 mol % Ta₂O₅;
from greater than or equal to 0.1 mol % to less than or equal to 30 mol % Li₂O;
from greater than or equal to 0.2 mol % to less than or equal to 30 mol % Na₂O;
from greater than or equal to 0 mol % to less than or equal to 3.75 mol % MgO;
from greater than or equal to 0.0 mol % to less than or equal to 0.13 mol % Ag₂O;
from greater than or equal to 0 mol % to less than or equal to 4.5 mol % ZrO₂; and
from greater than or equal to 0 mol % to less than or equal to 10 mol % Nb₂O₅.

20. The waveguide of claim 19, wherein the core material further comprises:
from greater than or equal to 0 mol % to less than or equal to 6.0 mol % B₂O₃;
from greater than or equal 0.3 mol % to less than or equal to 24 mol % R₂O, where R₂O is a total amount of Li₂O, Na₂O, K₂O, Cs₂O, and Rb₂O;
from greater than or equal 15.0 mol % to less than or equal to 23.5 mol % R₂O;
from greater than or equal to 7.0 mol % to less than or equal to 18.0 mol % Ta₂O₅;
from greater than or equal to 0.0 mol % to less than or equal to 0.09 mol % CuO;
from greater than or equal to 0.0 mol % to less than or equal to 0.3 mol % RO, where RO is a total amount of MgO, CaO, SrO, and BaO; and
from greater than or equal to 0.0 mol % to less than or equal to 8.0 mol % Al₂O₃, wherein the glass composition is free of TiO₂.
